(19) United States
(12) Patent Application Publication
(10) Pub. No.: US 2011/0030000 A1
(43) Pub. Date: Feb. 3, 2011

(54) OPERATION OBJECT DEVICE, PERMISSION INPUT DEVICE, OPERATION DEVICE, OPERATION OBJECT DATA PROVIDING DEVICE, REMOTE OPERATION SYSTEM, CONTROL METHOD, CONTROL PROGRAM, AND COMPUTER-READABLE STORAGE MEDIUM HOLDING THE CONTROL PROGRAM

(76) Inventor: Akira Tojima, Osaka (JP)

Correspondence Address: BIRCH STEWART KOLASCH & BIRCH, PO BOX 747, FALLS CHURCH, VA, 22040-0747, US

(21) Appl. No.: 12/672,847

(22) PCT Filed: Apr. 10, 2009
(86) PCT No.: PCT/JP2009/057364

§ 371 Date: Feb. 9, 2010

(30) Foreign Application Priority Data
Apr. 17, 2008 (JP) 2008-107960
Apr. 17, 2008 (JP) 2008-107961
Apr. 17, 2008 (JP) 2008-107962

(51) Int. Cl. H04N 7/16

(52) U.S. Cl. 725/28

(57) ABSTRACT

An operation object device (200) includes a permission obtaining section (7) for (i) transmitting to a permitter device (3002) a permission request for permission to allow an operator to carry out an operation that is restricted, which permitter device is used by a permitter that provides such permission, and (ii) receiving a permission result response transmitted from the permitter device (3002) as a response to the request. Moreover, the permitter device (3002) includes a permission request receiving processing section (24) for (i) receiving the permission request, (ii) accepting input of permission by the permitter in response to the permission request, and (iii) transmitting the permission result response to the apparatus from which the permission request is transmitted, in accordance with the input.

### TECHNICAL FIELD

The present invention relates to an operation object device, permission input device, operation device, operation object data providing device, remote operation system, control method, control program, and computer-readable storage medium in which such a program is stored, each of which is capable of carrying out restricted operations by obtaining permission from a permitter.

### BACKGROUND ART

The widespread of the Internet access network such as FTTH (Fiber To The Home) in the recent years has made VOD (Video On Demand) service available to households. The VOD service allows viewing of content such as video and audio that is provided from a server on the Internet, via a content display apparatus such as a television.

Such a VOD service in many cases provides not only content that is viewable by all users (i.e., has no viewing restrictions), but also provides content that is not freely viewable by a user such as an underage user (i.e., has viewing restrictions). Examples of content that have viewing restrictions encompass content that provide an age restriction to users being allowed to view the content (i.e., content having rating restrictions), and content that can only be viewed after purchasing the content by paying required fees (i.e., pay content).

Generally, the VOD service is provided with a mechanism so that a user such as the underage user cannot freely view view-restricted content. This mechanism is also called parental lock. More specifically, the mechanism asks a user to enter a predetermined password, pin number or the like when view-restricted content is to be viewed. Input of the password or pin number by a user such as a guardian releases the parental lock. Consequently, the user such as the underage user can view the view-restricted content by having the parental lock released by the user such as their guardian.

How to prohibit viewing of the view-restricted content is not limited to the foregoing parental lock. Another disclosed example is a method that provides a viewing authority in advance to a user or a terminal.

Patent Literature 1, for example, discloses a technique in which viewing is controlled on a user-basis by managing user ID-based view permitting conditions related to control operations of a television receiver. In this technique, the managed view permitting conditions are referred to in controlling an action to be carried out in response to an operation from the remote controller that is operated by a user identifiable by a user ID (for example, controlling viewing/non-viewing depending on an age of a user), so as to control the action based on the user ID transmitted from the remote controller.

Moreover, Patent Literature 2 discloses a technique in which a viewing license that is licensed to one broadcast receiving apparatus is transferred to a different broadcast receiving apparatus. This technique allows viewing of content that can only be viewed by a specific broadcast receiving apparatus (e.g., a broadcast receiving apparatus at home) to be viewable by a broadcast receiving apparatus to which the license is transferred (e.g., broadcast receiving apparatus outside home).

However, information described above such as the password to release the parental lock is generally only known by an authorized user such as the guardian. Furthermore, it is usual for the authorized user to not tell the predetermined password to an unauthorized user such as a child, in order to prevent the unauthorized user such as the child from freely purchasing any pay content. Therefore, whenever the unauthorized user wants to view view-restricted content or wants to purchase pay content, the unauthorized user needs to pass the operation of the remote controller to the authorized user every time, so that the authorized user can enter the predetermined password. Namely, the authorized user needs to operate the remote controller in front of a content display apparatus such as a television. Consequently, unless the authorized user is near the content display apparatus such as the television, the unauthorized user cannot view the view-restricted content.

Moreover, the method disclosed in Patent Literature 1 manages the view permitting conditions on a user ID-basis. Therefore, operations that are permitted and that are not permitted are determined based on the user. Accordingly, only a user that has permission for a relevant operation can carry out that operation, and a user that is not permitted to carry out the operation cannot carry out the operation. Hence, even if the technique disclosed in Patent Literature 1 is applied in viewing view-restricted pay content, unless a user that is permitted to view pay content carries out the entire viewing operation in front of the content display apparatus such as a television, a user that is not permitted to view pay content cannot view the content.

Moreover, although the method disclosed in Patent Literature 2 transfers a viewing license licensed to one broadcast receiving apparatus to another broadcast receiving apparatus, this is not a mechanism that transfers viewing authorities between users (or between apparatuses used by the users) so that viewing authority adapts to the user or apparatus thus transferred. Consequently, any content not permitted to be viewed by the original broadcast receiving apparatus from which the viewing license is transferred is still not viewable by the other broadcast receiving apparatus to which the viewing license is transferred.

### Citation List

Patent Literature 1

Japanese Patent Application Publication, Tokukai, No. 2006-279453 A (Publication Date: Oct. 12, 2006)

Patent Literature 2

Japanese Patent Application Publication, Tokukai, No. 2007-214667 A (Publication Date: Aug. 23, 2007)

### SUMMARY OF INVENTION

The present invention is accomplished in view of the above problem, and its object is to provide an operation object device, permission input device, operation device, operation object data providing device, remote operation system, control method, control program, and computer-readable storage medium for storing the program, each of which allows an operator that is restricted from carrying out a predetermined operation to carry out the operation thus restricted, by having a permitter provide permission to the operator through simple operation.

In order to attain the object, an operation object device in accordance with the present invention is an operation object device operating in accordance with a signal transmitted from an operation device, the operation object device being restricted in operation depending on an operator of the operation device, the operation object device including: permission request transmitting means for transmitting to a permission input device a request for permission to allow the operator to carry out the operation thus restricted, the permission input device being used by a permitter that provides the permission; and permission signal receiving means for receiving, as a response to the request, a permission signal transmitted from the permission input device, the operation object device operating in accordance with the operation thus restricted, in a case where the permission signal received by the permission signal receiving means indicates that permission is provided for carrying out the operation thus restricted.

Moreover, a method in accordance with the present invention for controlling an operation object device which operates in accordance with a signal transmitted from an operation device, the operation object device being restricted in operation depending on an operator of the operation device, is a method including the steps of: (a) transmitting to a permission input device a request for permission to allow the operator to carry out an operation thus restricted, the permission input device being used by a permitter that provides the permission; (b) receiving, as a response to the request, a permission signal transmitted from the permission input device; and (c) carrying out operation in accordance with the operation thus restricted, in a case where the permission signal received in step (b) indicates that permission is provided for carrying out the operation thus restricted.

According to the configuration, the operation object device transmits, to the permission input device used by the permitter, a request for permission to allow the operator to carry out the operation thus restricted. Further, the operation object device receives the permission signal transmitted from the permission input device, as a response to the request. Moreover, if the permission signal indicates that the operation is permitted, the operation object device carries out an operation corresponding to the operation thus restricted.

Thus, the operator that uses the operation device, in carrying out the operation thus restricted to the operation object device, can obtain a permission signal from the permission input device by exchanging the requests for permission and responses thereto between the operation object device and the permission input device.

Hence, the operator can carry out the operation thus restricted by obtaining permission from the permitter.

Furthermore, the operator can obtain the permission from the permitter just by operating the operation object device via the operation device used by the operator. This improves convenience for the operator.

No direct exchange is carried out between the operation device and the permission input device. Thus, even if the operation device is not capable of directly communicating with the permission input device (for example, if the operation device has no function for communicating with the permission input device), the operator can still obtain permission from the permitter.

Moreover, in order to attain the object, an operation object device in accordance with the present invention is an operation object device operating in accordance with a signal transmitted from an operation device, the operation object device being restricted in operation depending on an operator of the operation device, the operation object device including: permission request transmitting means for transmitting, to a permission input device via the operation device, a request for permission to allow the operator to carry out the operation thus restricted, the permission input device being used by a permitter that provides the permission; and permission signal receiving means for receiving, via the operation device, a permission signal transmitted from the permission input device as a response to the request, the operation object device operating in accordance with the operation thus restricted, in a case where the permission signal received by the permission signal receiving means indicates that permission is provided for carrying out the operation thus restricted.

Moreover, a method in accordance with the present invention for controlling an operation object device which operates in accordance with a signal transmitted from an operation device, the operation object device being restricted in operation depending on an operator of the operation device is a method including the steps of: (a) transmitting, to a permission input device via the operation device, a request for permission to allow the operator to carry out an operation thus restricted, the permission input device being used by a permitter that provides the permission; (b) receiving, via the operation device, a permission signal transmitted from the permission input device as a response to the request; and (c) carrying out operation in accordance with the operation thus restricted, in a case where the permission signal received in step (b) indicates that permission is provided for carrying out the operation thus restricted.

According to the configuration, the operation object device transmits, to the permission input device used by the permitter, a request for permission to allow the operator to carry out the operation thus restricted, via the operation device. Further, the operation object device receives the permission signal transmitted from the permission input device as a response to the request, via the operation device. Moreover, if the permission signal indicates that the operation is permitted, the operation object device carries out the operation corresponding to the operation thus restricted.

Thus, the operator that uses the operation device, in carrying out the operation thus restricted to the operation object device, can obtain a permission signal from the permission input device by exchanging the requests for permission and responses thereto between the operation object device and the permission input device, via the operation device.

Hence, the operator can carry out the operation thus restricted by obtaining permission from the permitter.

Furthermore, the operator can obtain the permission from the permitter just by operating the operation object device via the operation device used by the operator. This improves convenience for the operator.

No direct exchange is carried out between the operation object device and the permission input device, but communication is carried out between the operation device and the permission input device. Thus, even if the operation object device is not capable of directly communicating with the permission input device (for example, a case where the operator attempts to operate the operation object device at home while the permitter is at an outside location), the operator can still obtain permission from the permitter.

Moreover, in order to attain the object, an operation object device in accordance with the present invention is an operation object device that presents data in accordance with a signal transmitted from an operation device, the data being obtained from an operation object data providing device, the operation object device being restricted in operation depending on an operator of the operation device, the operation object device including: permission request transmitting means for transmitting, to a permission input device via the operation object data providing device, a request for permission to allow the operator to carry out an operation thus restricted, the permission input device being used by a permitter that provides the permission; and permission signal receiving means for receiving, via the operation object data providing device, a permission signal transmitted from the permission input device as a response to the request, the operation object device operating in accordance with the operation thus restricted, in a case where the permission signal received by the permission signal receiving means indicates that permission is provided for carrying out the operation thus restricted.

Furthermore, a method in accordance to the present invention for controlling an operation object device which presents data in accordance with a signal transmitted from an operation device, the data being obtained from an operation object data providing device, the operation object device being restricted in operation depending on an operator of the operation device, is a method including the steps of: (a) transmitting, to a permission input device via the operation object data providing device, a request for permission to allow the operator to carry out an operation thus restricted, the permission input device being used by a permitter that provides the permission; (b) receiving, via the operation object data providing device, a permission signal transmitted from the permission input device as a response to the request; and (c) carrying out operation in accordance with the operation thus restricted, in a case where the permission signal received in step (b) indicates that permission is provided for carrying out the operation thus restricted.

According to the configuration, the operation object device transmits, to the permission input device used by the permitter, a request for permission to allow the operator to carry out the operation thus restricted. Further, the operation object device receives the permission signal transmitted from the permission input device, as a response to the request. Moreover, if the permission signal indicates that the operation is permitted, the operation object device carries out the operation corresponding to the operation thus restricted.

Thus, the operator that uses the operation device, in carrying out the operation thus restricted to the operation object device, can obtain a permission signal from the permission input device by exchanging the requests for permission and responses thereto between the operation object device and the permission input device, via the operation object data providing device.

Hence, the operator can carry out the operation thus restricted by obtaining permission from the permitter.

Furthermore, the operator can obtain the permission from the permitter just by operating the operation object device via the operation device used by the operator. This improves convenience for the operator.

No direct exchange is carried out between the operation device and the permission input device. Thus, even if the operation device is not capable of directly communicating with the permission input device (for example, if the operation device has no function for communicating with the permission input device), the operator can still obtain permission from the permitter.

Further, no direct exchange is made between the operation object device and the permission input device, but communication is carried out between the operation object data providing device and the permission input device. Thus, even if the operation object device is not capable of directly communicating with the permission input device (for example, in a case where the operator attempts to operate the operation object device at home while the permitter is at an outside location), the operator can still obtain permission from the permitter.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram illustrating an essential configuration of an operation object device, a remote operation device, and a service providing device, each of which are included in a remote operation system in accordance with one embodiment of the present invention.

FIG. 2 is a block diagram illustrating how apparatuses are configured in a remote operation system in accordance with embodiments of the present invention.

FIG. 3 is a diagram illustrating one example of a screen that is displayed when a remote control application is activated on the remote operation device illustrated in FIG. 1.

FIG. 4 is a diagram illustrating one example of a screen for entering a user ID and password of an operator into the remote operation device illustrated in FIG. 1.

FIG. 5 is a diagram schematically illustrating one example of a screen displayed on an operation object device 200, upon switching the power of the operation object device illustrated in FIG. 10N.

FIG. 6 is a diagram schematically illustrating one example of how a menu is displayed on the operation object device illustrated in FIG. 1 in using a VOD service.

FIG. 7 is a diagram schematically illustrating one example of how a list of contents is displayed on the operation device illustrated in FIG. 1.

FIG. 8 is a diagram schematically illustrating one example of how attribute information of contents is displayed on the operation object device illustrated in FIG. 1.

FIG. 9 is a diagram schematically illustrating one example of a display of the operation object device illustrated in FIG. 1, which displays that the apparatus is currently obtaining a case-by-case permission from a permitter.

FIG. 10 is a diagram schematically illustrating one example of how view-restricted content is reproduced on the operation object device illustrated in FIG. 1.

FIG. 11 is a diagram schematically illustrating one example of how a detail of a requested case-by-case permission is displayed on a remote operation device (permitter device used by a permitter) illustrated in FIG. 1.

FIG. 12 is a diagram schematically illustrating one example of a display on a remote operation device (permitter device used by a permitter) illustrated in FIG. 1, which displays that content that is provided with the case-by-case permission is pay content.

FIG. 13 is a diagram schematically illustrating another example of how a menu is displayed on the operation object device illustrated in FIG. 1, in using a VOD service.

FIG. 14 is a diagram schematically illustrating one example of a display on the operation object device illustrated in FIG. 1, which displays that the apparatus is currently obtaining prior permission from a permitter.

FIG. 15 is a diagram schematically illustrating one example of how a detail of the prior permission provided by the permitter is displayed on the operation object device illustrated in FIG. 1.

FIG. 16 is a diagram schematically illustrating one example of a screen displayed on the remote operation device (permitter device used by the permitter) illustrated in FIG. 1, for entering details of prior permission to be provided.

FIG. 17 is a diagram schematically illustrating one example of a screen displayed on the remote operation device (permitter device used by the permitter) illustrated in FIG. 1, into which a name and age of a permitter and a name and age of an operator to whom the permitter provides permission are entered.

FIG. 18 is a diagram schematically illustrating one example of a screen displayed on the remote operation device (permitter device used by the permitter) illustrated in FIG. 1, into which contact information and credit card information of the permitter are entered.

FIG. 19 is a diagram schematically illustrating one example of a screen displayed on the remote operation device (permitter device used by the permitter) illustrated in FIG. 1, which displays that user registration has completed and a user ID and password has been issued for the user(s).

FIG. 20 is a diagram schematically illustrating an outline of a procedure of how an operator obtains viewing permission from a permitter, in a remote operation system according to one embodiment of the present invention.

FIG. 21 is a flow chart illustrating a procedure followed by the apparatuses in the remote operation system, when an operator uses a VOD service.

FIG. 22 is a flow chart illustrating a procedure of a permission obtaining process, in the remote operation system.

FIG. 23 is a flow chart illustrating a procedure of a permission entering process in the remote operation system according to each of embodiments of the present invention.

FIG. 24 is a flow chart illustrating a procedure of an authority verification process in the remote operation system according to each of embodiments of the present invention.

FIG. 25 is a flow chart illustrating a procedure of a content viewing verification process in the remote operation system according to each of embodiments of the present invention.

FIG. 26 is a flow chart illustrating a procedure of a command processing in the remote operation system according to each of embodiments of the present invention.

FIG. 27 is a flow chart illustrating a procedure of a user registration process in the remote operation system according to each of embodiments of the present invention.

FIG. 28 is a diagram schematically illustrating an outline of a procedure of how an operator obtains viewing permission from a permitter, in a remote operation system according to another embodiment of the present invention.

FIG. 29 is a block diagram illustrating an essential configuration of an operation object device, remote operation device, and service providing device, each of which are included in the remote operation system.

FIG. 30 is a flow chart illustrating a procedure of a permission obtaining process in the remote operation system.

FIG. 31 is a diagram schematically illustrating an outline of a procedure of how an operator obtains viewing permission from a permitter, in a remote operation system according to another embodiment of the present invention.

FIG. 32 is a block diagram illustrating an essential configuration of an operation object device, remote operation device, and service providing device, each of which are included in the remote operation system.

FIG. 33 is a flow chart illustrating a procedure of a permission obtaining process in the remote operation system.

### DESCRIPTION OF EMBODIMENTS

### Essential Configuration of System

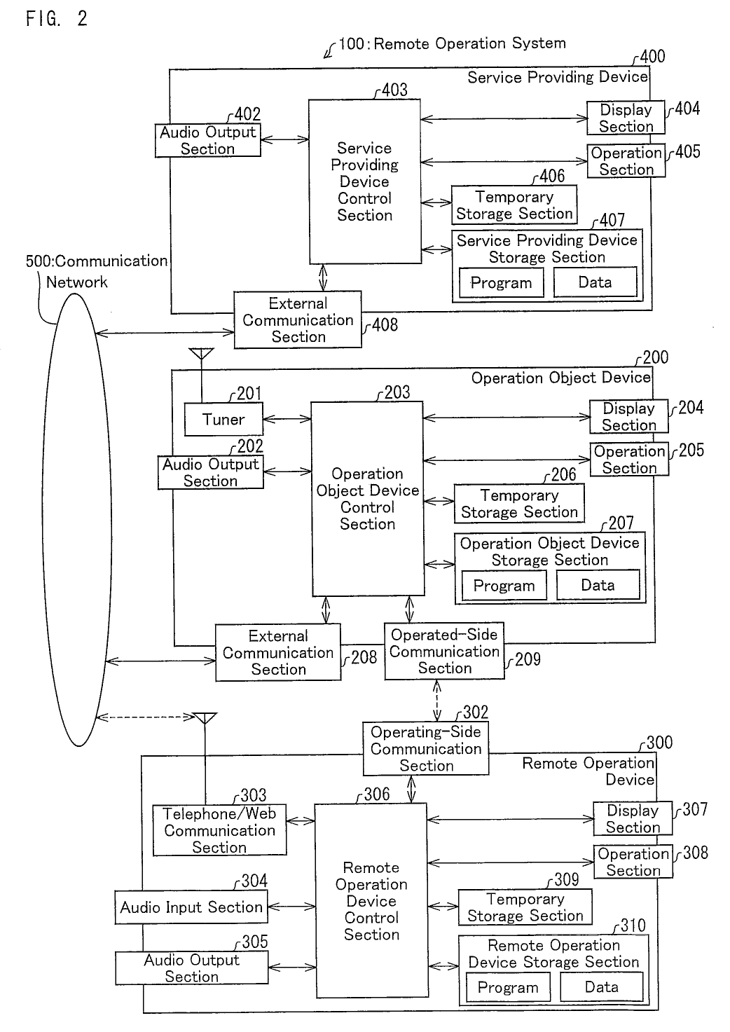

With reference to FIG. 2, the following description explains an essential configuration of a remote operation system 100 in accordance with each of embodiments. FIG. 2 is a block diagram illustrating an essential configuration of the remote operation system 100. As illustrated in FIG. 2, the remote operation system 100 includes an operation object device 200, remote operation device 300 (operation device, permission input device), and service providing device 400 (operation object data providing device). The remote operation system 100 is a system in which the operation object device 200 is operated by the remote operation device 300, in order to obtain various information from the service providing device 400 via a communication network 500. In each of the embodiments, the remote operation device 300 is assumed to be a mobile phone, the operation object device 200 is assumed to be a television receiver, and the service providing device 400 is assumed to be a contents distributing server that distributes content such as video and audio.

Namely, the remote operation system 100 in accordance with the embodiments is assumed to be a system that provides a VOD service allowing viewing of contents provided from the contents distributing server, by operating the television receiver that serves as the operation object device 200 with a mobile phone that serves as the remote operation device 300.

The remote operation system 100 is not limited to the foregoing example, as long as it is a system in which the operation object device 200 is operable with the remote operation device 300. For example, the remote operation device 300 may be an apparatus of any kind as long as the apparatus includes a function to operate the operation object device 200 by transmitting an operation signal; and may be a PDA (Personal Digital Assistance), PHS (Personal Handy Phone System), notebook-type personal computer, portable game device, or the like. Of course, the remote operation device 300 may be a remote controller dedicated for operating the operation object device 200. Moreover, the operation object device 200 may be any apparatus as long as the apparatus receives an operation signal transmitted from the remote operation device 300 and is controlled in operation based on the operation signal. Examples of the operation object device 200 encompass: a personal computer, recording device, music player, and air conditioner. Moreover, the service providing device 400 may be any apparatus as long as the apparatus is capable of distributing various information to the operation object device 200, and may be, for example, a news distributing server that distributes news reports.

Contents provided from the service providing device 400 may be in the form of text data, audio data, image data, video data, application, or a combination of such data, and is not limited to any specific format.

(Configuration of Operation Object Device)

As illustrated in FIG. 2, the operation object device 200 includes a tuner 201, an audio output section 202, an operation object device control section 203, a display section 204, an operation section 205, a temporary storage section 206, an operation object device storage section 207, an external communication section 208, and an operated-side communication section 209.

The tuner 201 selectively receives a broadcast wave of a channel specified by the operation object device control section 203, converts this broadcast wave to a predetermined signal, and outputs the predetermined signal. The operation object device 200 processes the signal, such as decoding the signal, so as to output video and audio of the received channel. The tuner 201 is sufficient as long as the tuner has a function to receive broadcast wave and convert the received broadcast wave to a predetermined signal, and conventional typical tuners such as a digital terrestrial tuner, BS, or CS tuner may be applied as appropriate.

The audio output section 202 outputs audio to outside the operation object device 200 based on output of the tuner 201 and instructions provided from the operation object device control section 203. The audio output section 202 may be constituted by a speaker, for example.

The operation object device control section 203 centrally controls operation of the operation object device 200, and may be constituted by a CPU (Central Processing Unit), for example. The operation object device control section 203 operates by having the temporary storage section 206 constituted by a RAM (Random Access Memory) or the like to serve as its working region. Processes carried out by the operation object device control section 203 are described later in detail.

The display section 204 is a display apparatus for displaying video, based on output of the tuner 201 and instructions provided from the operation object device 203. For example, an LC (Liquid Crystal) display panel, EL (Electro Luminescence) display panel, or CRT (cathode-ray tube) display apparatus is applicable as the display apparatus 204.

The operation section 205 allows a user to enter an operation to the operation object device 200. The operation section 205 is not particularly limited as long as the user can enter an operation as desired. Here, it is assumed that operation keys corresponding to various operation input are provided as the operation section 205. More specifically, it is assumed that operation keys are provided in the operation section 205 for each of the following operations: changing channels, increasing and reducing volume, switching ON/OFF of power of the operation object device 200, and other like operations.

As illustrated in FIG. 2, the operation object device storage section 207 stores programs and data. In the operation object device 200, a predetermined operation is carried out by the operation object device control section 203 by (i) reading out a program thus stored in the operation object device storage section 207 to the temporary storage section 206, and (ii) executing the program.

The external communication section 208 and the operated-side communication section 209 are provided so that the operation object device 200 can communicate with an external apparatus. The external communication section 208 is configured connectable to the communication network 500, and although not illustrated in FIG. 2, a configuration that is required for communication such as a LAN (Local Area Network) or a router is provided between the external communication section 208 and the communication network 500 as appropriate. The operated-side communication section 209 is configured communicable with the operating-side communication section 302 of the remote operation device 300. The operated-side communication section 209 are described later in detail.

As described above, the operation object device 200 is assumed to be a television receiver, so therefore the operation object device 200 is also assumed to have functions that are typically provided in a television receiver (such as changing channels, adjustment of volume, adjustment of screen brightness).

(Configuration of Remote Operation Device)

As illustrated in FIG. 2, the remote operation device 300 includes an operating-side communication section 302, a telephone/web communication section 303, an audio input section 304, an audio output section 305, a remote operation device control section 306, a display section 307, an operation section 308, a temporary storage section 309, and a remote operation device storage section 310.

The operating-side communication section 302 is provided so that the remote operation device 300 can communicate with an external device. The operating-side communication section 302 is configured communicable with the operated-side communication section 209 of the operation object device 200. The operating-side communication section 302 is described later in detail.

The telephone/web communication section 303 is provided for carrying out telephonic communication with another mobile phone or a fixed-line telephone via a mobile telephone network or the like, and also for carrying out communication via the Internet. In order to do so, the telephone/web communication section 303 is configured connectable to the communication network 500. Such functions are realized by a telephone network communication section and mobile line section (not illustrated).

The audio input section 304 is provided for inputting an audio signal to the remote operation device 300, for example during a telephone conversation, and the audio output section 305 is provided for outputting a sound in accordance with an audio signal or the like received by the telephone/web communication section 303 during a telephone conversation. The audio output section 305 also outputs a sound or the like that informs of a telephone call or a reception of an e-mail. The audio input section 304 and audio output section 305 may be of any form as long as input and output of audio is respectively possible, and components that are used in conventional mobile phones may be applied thereto.

The remote operation device control section 306 centrally controls operation of the remote operation device 300, and can be constituted by a CPU, for example. The remote operation device control section 306 operates by having the temporary storage section 309 constituted by a RAM or the like to serve as its working region. Processes carried out by the remote operation device control section 306 are described later in detail.

The display section 307 displays an image in accordance with an instruction provided from the remote operation device control section 306. Although not illustrated in FIG. 2, a configuration necessary for displaying an image, for example a VDP (Video Display Processor) or VRAM (Video RAM), is provided as appropriate between the remote operation device control section 306 and the display section 307. The display section 307 is constituted by, for example an LC display panel or an EL display panel.

The operation section 308 enables a user of the remote operation device 300 to enter an operation to the remote operation device 300. The operation section 308 is not particularly limited as long as the user can enter an operation as desired. Herein, it is assumed that the operation section 308 is operation keys provided on a front surface of a main body of the remote operation device 300. More specifically, it is assumed that the operation section 308 includes a plurality of operation keys which include: various menu keys that cause display of, for example, a menu screen related to e-mail or a menu screen related to Internet connection; a direction key of four directions (up, down, left, right) for selecting an item displayed on the display section 307; an enter key for determining an item thus selected; and character entering keys for entering numbers and letters.

The remote operation device storage section 310 stores programs and data, as illustrated in FIG. 2. In the remote operation device 300, a predetermined operation is carried out by the remote operation device control section 306, by (i) reading out a program that is stored in the remote operation device storage section 310 to the temporary storage section 309, and (ii) executing the program. Moreover, the remote operation device storage section 310 stores data such as data of e-mails received by the telephone/web communication section 303 and data of telephone numbers and e-mail addresses recorded by a user of the remote operation device 300.

(Configuration of Service Providing Device)

As illustrated in FIG. 2, the service providing device 400 includes an audio output section 402, a service providing device control section 403, a display section 404, an operation section 405, a temporary storage section 406, a service providing device storage section 407, and an external communication section 408.

The audio output section 402 outputs audio to outside the service providing device 400 based on an instruction provided from the service providing device control section 403. The audio output section 402 may be constituted by a speaker, for example.

The service providing device control section 403 centrally controls operation of the service providing device 400, and can be constituted by a CPU, for example. The service providing device control section 403 operates by having the temporary storage section 406 constituted by a RAM or the like to serve as its working region. Processes carried out by the service providing device control section 403 are described later in detail.

The display section 404 is a display section for displaying a setting screen of a service, which is displayed based on an instruction provided from the service providing device control section 403. For example, an LC display panel, an EL display panel, a CRT display apparatus or the like may be applied as the display section 404.

The operation section 405 allows a user to enter an operation to the service providing device 400. The operation section 405 is not particularly limited as long as the user can enter an operation as desired. Herein, the operation section 405 is assumed to be a keyboard for carrying out complex operations such as (i) setting various services that are provided from the service providing device 400 and (ii) maintenance of content.

The service providing device storage section 407 stores programs and data, as illustrated in FIG. 2. In the service providing device 400, a predetermined operation is carried out by the service providing device control section 403, by (i) reading out a program stored in the service providing device storage section 407 to the temporary storage section 406, and (ii) executing the program.

The external communication section 408 is provided so that the service providing device 400 can communicate with an external device. The external communication section 408 is configured connectable with the communication network 500, and although not illustrated, a configuration that is necessary for communication such as a LAN or router is provided as appropriate between the external communication section 408 and the communication network 500.

(Communication Between Operation Object Device 200 and Remote Operation Device 300)

As described above, the operating-side communication section 302 is configured communicable with the operated-side communication section 209. In other words, the remote operation device 300 and operation object device 200 are communicable via a communication path formed by the operating-side communication section 302 and the operated-side communication section 209.

The communication path formed by the operating-side communication section 302 and the operated-side communication section 209 is used for transmitting and receiving data between the remote operation device 300 and the operation object device 200. Herein, it is assumed that a Bluetooth (registered trademark) communication is applied as the communication path. That is to say, the operated-side communication section 209 and the operating-side communication section 302 are communication sections that can transmit and receive a signal via the Bluetooth communication.

The Bluetooth communication is an omnidirectional communication; thus, in a case where the Bluetooth communication is carried out between the operating-side communication section 302 and the operated-side communication section 209, a pairing process that registers a counter communication device of the Bluetooth communication in advance is necessarily carried out. This avoids an unintended device of a user to be operated by mistake. Pairing is a process in which the communication apparatuses of the pair register the address of its counter communication apparatus, so as to allow communication via omnidirectional communication means. By carrying out the pairing process, the counter addresses used for the Bluetooth communication between the operation object device 200 and the remote operation device 300 are respectively registered in the apparatuses; thus, operation of devices not intended to be operated by the user will not be operated by mistake. In the embodiments, it is assumed that the operation object device 200 and the remote operation device 300 have already been subjected to the foregoing pairing process; having the addresses for the Bluetooth communication registered therein.

The communication path may be of any form as long as data is transmittable and receivable, and wireless LAN such as IEEE 802.11 wireless or ZigBee (registered trademark) are also applicable as the communication path.

Moreover, in a case where just one-way communication is carried out from the remote operation device 300 to the operation object device 200, infrared communication or the like is applicable as the communication path.

(Communication Between Operation Object Device 200 and Service Providing Device 400)

Moreover, as described above, the external communication section 208 of the operation object device 200 is configured communicable with the communication network 500. Similarly, the external communication section 408 of the service providing device 400 is configured communicable with the communication network 500. Namely, the operation object device 200 and the service providing device 400 are communicable through a communication path formed via the communication network 500. In this case, the Internet, for example, is assumed to be applied as the communication network 500.

(Communication Between Remote Operation Device 300 and Service Providing Device 400)

Moreover, as described above, the telephone/web communication section 303 of the remote operation device 300 is communicable with the communication network 500. Namely, the remote operation device 300 and the service providing device 400 are communicable through the communication path formed via the communication network 500. In this case, as the communication network 500, it is assumed that the Internet or the mobile phone network for example is applied.

(Communication Between Remote Operation Devices 300)

Moreover, as described above, the telephone/web communication section 303 of the remote operation device 300 is configured communicable with the communication network 500. Namely, remote operation devices 300 are communicable with each other through the communication path formed via the communication network 500. In this case, it is assumed that the mobile phone network for example is applied as the communication network 500.

[Point of Invention]

As described above, it is assumed that the remote operation system 100 is a system that provides a VOD service, in which a user can view, on the display section 204 of the operation object device 200, contents provided from the service providing device 400, by operating the operation object device 200 with the remote operation device 300. Moreover, in many cases, as described in “Background Art”, the VOD service provides content (hereinafter referred to as view-restricted content) that are not freely viewable by users such as underage users. Examples of the view-restricted content encompass content that give restrictions in viewable ages (i.e., content having rating restrictions) and content that can only be viewed after purchasing the content by paying the required fees (i.e., pay content).

In each of the embodiments, a user that cannot freely view the view-restricted content (e.g., underage user) is referred to as an “operator”, whereas a user that provides viewing permission to the operator for viewing the view-restricted content (e.g., guardian) is referred to as a “permitter”. In a case where simply “user” is used in the description, both the operator and the permitter are denoted.

Moreover, whenever a remote operation device 300 that is used by an operator is distinctively described, the expression “operator device 3001” is referred to, and whenever a remote operation device 300 that is used by a permitter is distinctively described, the expression “permitter device 3002” is referred to.

A main feature of the present invention is that an operator operating the operation object device 200 via an operator device 3001 (operation device) can view a view-restricted content provided from the service providing device 400 by obtaining viewing permission from a permitter using a permitter device 3002 (permission input device).

There are two types of the viewing permission, as follows: (1) One is a type in which viewing permission of a view-restricted content is obtained from a permitter at a timing when an operator wishes to view the content. This type of viewing permission is referred to as “case-by-case permission”.

(2) The other type is a type in which viewing permission is obtained from a permitter in advance, which viewing permission specifies that an operator is permitted to view a view-restricted content within a predetermined range; and the operator views a view-restricted content within this permitted range. This type of viewing permission is referred to as “prior permission”.

(Screen Example of Obtaining Viewing Permission)

With reference to a screen example, the following description explains a procedure in which an operator views view-restricted content by obtaining viewing permission from a permitter. The following description explains an outline of the procedure, and processes therein will be described in detail later.

(Remote Control Application)

First described is an application program (hereinafter referred to as “remote control application”) for causing the remote operation device 300 to serve as a user interface, in order to operate the operation object device 200. Although the remote operation device 300 in accordance with the embodiments usually operates as a mobile phone, the remote operation device 300 becomes capable of remotely operating the operation object device 200 by activating the remote control application. Thus, by installing the remote control application to the remote operation device 300, various electronic devices are operable as the remote operation device 300.

Particularly, mobile phones that incorporate infrared communication means and Bluetooth communication means as transmitting and receiving means of data are broadly available. It is preferable to apply these communication means as the communication means for the remote operation in a case where such a mobile phone is applied as the remote operation device 300.

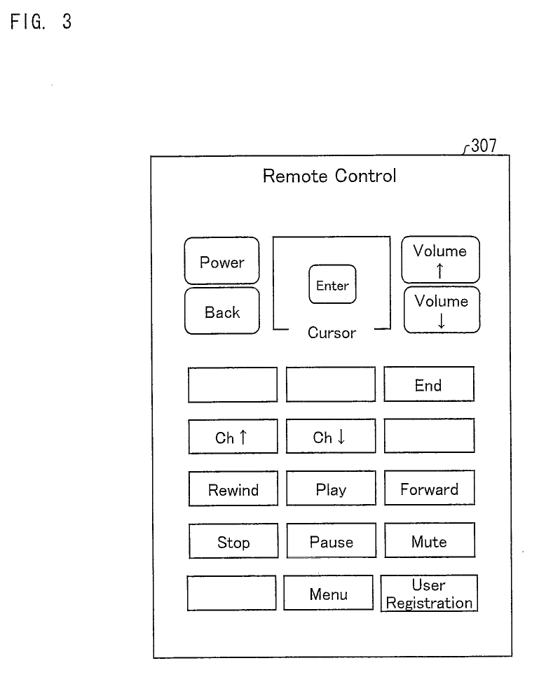

With reference to FIG. 3, the following description deals with an example of a display screen upon activation of the remote control application. FIG. 3 is a diagram illustrating one example of a screen displayed on a display section 307 of the remote operation device 300, upon activation of the remote control application. The illustrated image is called a software keyboard display (hereinafter, is referred to as software key display). The software key display displays positions of operation keys in the operation section 308 and respective functions that are allotted to the operation keys.

Namely, the operation section 308 has operation keys aligned at identical positions to the software key display in FIG. 3, and by pressing an operation key in the operation section 308 that corresponds to a key displayed on the display section 307, a process of a function displayed on the key of the corresponding pressed key is carried out. For example, by pressing a key in the operation section 308 that corresponds to the key displayed as “volume ⇑” in FIG. 3, the volume of the operation object device 200 increases.

As such, by carrying out software key display, remote control operation can be arbitrary allotted to the operation keys in the operation section 308. As a result, it is possible to operate the operation object device 200 by using the remote operation device 300 that has the functions of a mobile phone.

The remote operation device 300 may be of any form as long as remote operation can be entered, and is not limited to the above example. For example, the display section 307 and operation section 308 of the remote operation device 300 may be arranged as a touch panel. In this case, a screen having a remote operation effect is displayed on the display section 307, so as to accept input of the remote operation according to the displayed screen.

### Screen Example 1

### Screen Example for Obtaining Case-By-Case Permission

With reference to a screen example, the next description explains how an operator obtains a case-by-case permission from a permitter so as to view view-restricted content. In this description, assume that the operator has not obtained prior permission from the permitter. Further, assume that power of the operation object device 200 is initially OFF. Although the power of the operation object device 200 is OFF, the operation object device 200 is in a receptive state (i.e., in a standby state) that can receive just a remote control command including a command indicating that the power key is pressed (later described).

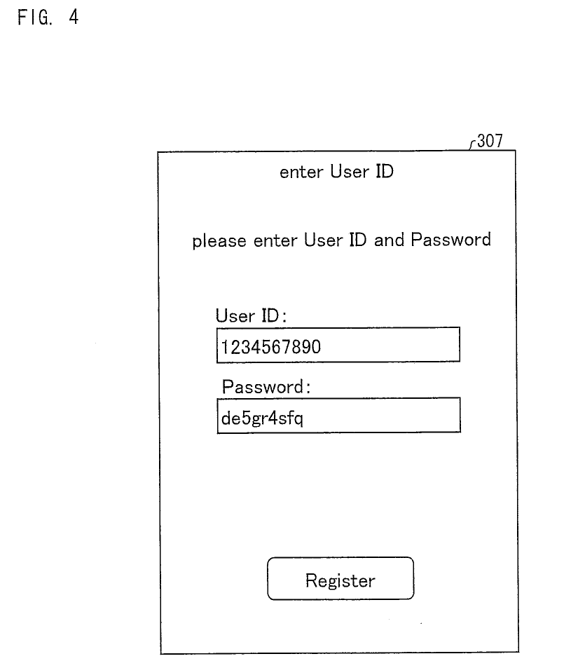

In order to use the VOD service provided by the service providing device 400, the operator first enters a user ID and password to the operator device 3001. If the operator presses a “user registration” key on the remote control application illustrated in FIG. 3, the screen displayed on the display section 307 transits to a screen illustrated in FIG. 4. FIG. 4 is a diagram schematically illustrating one example of a screen displayed on the operator device 3001, for entering a user ID and password of the operator. By entering the user ID and password into the display of FIG. 4 and then pressing a “register” button, the entered user ID and password becomes stored in the operator device 3001.

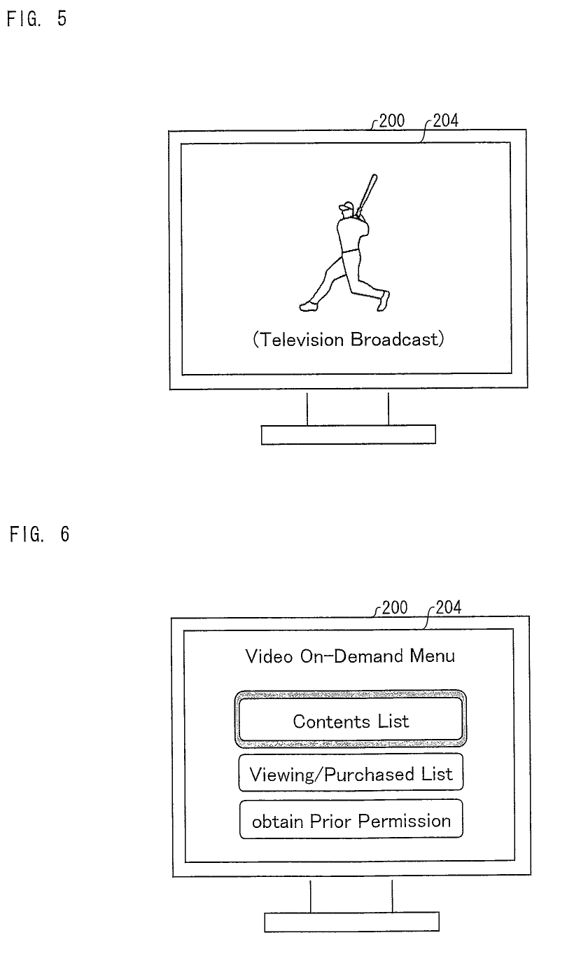

FIG. 5 illustrates a screen displayed on the display section 204 of the operation object device 200 immediately after the operator presses the “power” key in the remote control application illustrated in FIG. 3 to turn ON the power of the operation object device 200. FIG. 5 is a diagram schematically illustrating an example of a screen displayed on the display section 204 of the operation object device 200 upon switching the power of the operation object device 200 ON. In the present embodiment, the operation object device 200 is assumed to be a television receiver, so therefore television broadcast is displayed on the display section 204 immediately after the power is turned ON.

When the operator presses the “power” key, a remote control command that includes a command indicating that the power key is pressed is transmitted to the operation object device 200 from the remote operation device 300. The operation object device 200, being triggered by receiving the remote control command, turns its power ON.

Next, in order to use the VOD service, the operator presses the “menu” key on the remote control application illustrated in FIG. 3. This causes the screen that is displayed on the display section 204 of the operation object device 200 to transit to the screen illustrated in FIG. 6. FIG. 6 is a drawing schematically illustrating one example of how the menu is displayed on the display section 204 of the operation object device 200, in use of the VOD service. Here, three menus are displayed in using the VOD service; FIG. 6 illustrates a state in which focus is given on the menu “contents list” that is positioned on the top of the three menus.

When the operator presses the “menu” key, a predetermined remote control command is transmitted to the operation object device 200 from the remote operation device 300. The operation object device 200, being triggered by receiving the remote control command, transmits a log-in request later described to the service providing device 400. If the operation object device 200 successfully logs in, the screen illustrated in FIG. 6 is displayed on the display section 204.

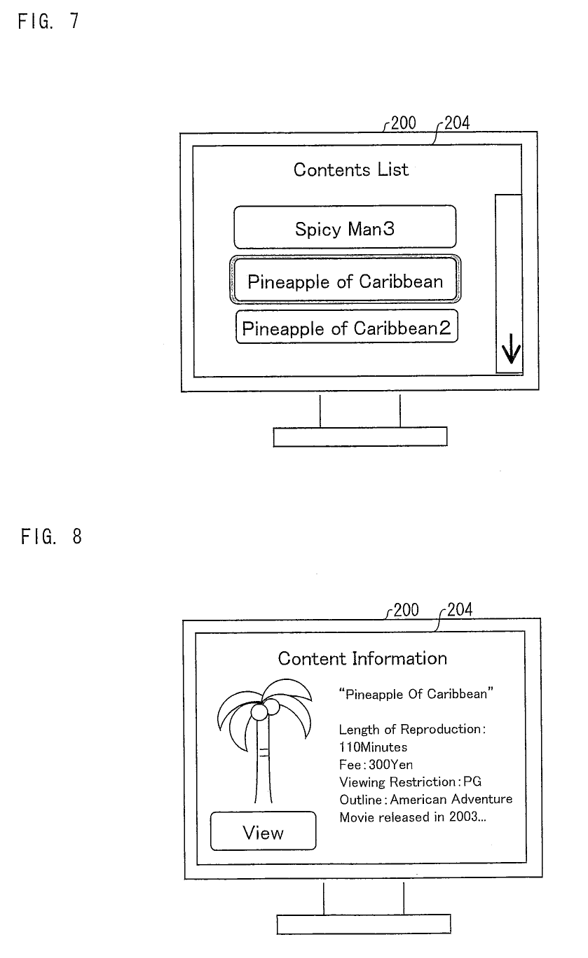

Thereafter, in order to display a list of contents currently available from the service providing device 400, the operator presses the “enter” key while focus is given on the “contents list” on the screen illustrated in FIG. 6. This causes the display displayed on the display section 204 of the operation object device 200 to transit to a screen illustrated in FIG. 7. FIG. 7 is a drawing schematically illustrating how a list of contents that are currently available is displayed on the display section 204 of the operation object device 200. In FIG. 7, three titles of contents are displayed as contents available from the service providing device 400. FIG. 7 illustrates a state in which content with a title “Pineapple of Caribbean” is given focus to.

If the operator presses the “enter” key, the remote operation device 300 transmits a predetermined remote control command to the operation object device 200. The operation object device 200, being triggered by receiving the remote control command, obtains a contents list from the service providing device 400, and displays the obtained contents list on the display section 204.

In order to display attribute information of the content, the operator presses the “enter” key while the focus is given to the desired content in the screen illustrated in FIG. 7. This causes the screen displayed on the display section 204 of the operation object device 200 to transit to a screen illustrated in FIG. 8. FIG. 8 is a drawing schematically illustrating one example of how attribute information of content is displayed on the display section 204 of the operation object device 200. In this example, title of the content, length of reproduction of the content, fee, viewing restriction details, and summary of the content are displayed as attribute information of the content of “Pineapple of Caribbean”. As illustrated, this content is charged (300 yen) and has a viewing restriction (PG: parental guidance). Therefore, the content is a view-restricted content, and viewing permission from the permitter is necessary in order for an operator to view the content.

When the operator presses the “enter” key, the remote operation device 300 transmits a predetermined remote control command to the operation object device 200. The operation object device 200, being triggered by receiving the remote control command, obtains the attribute information of the content from the service providing device 400, and displays the screen illustrated in FIG. 8 on the display section 204.

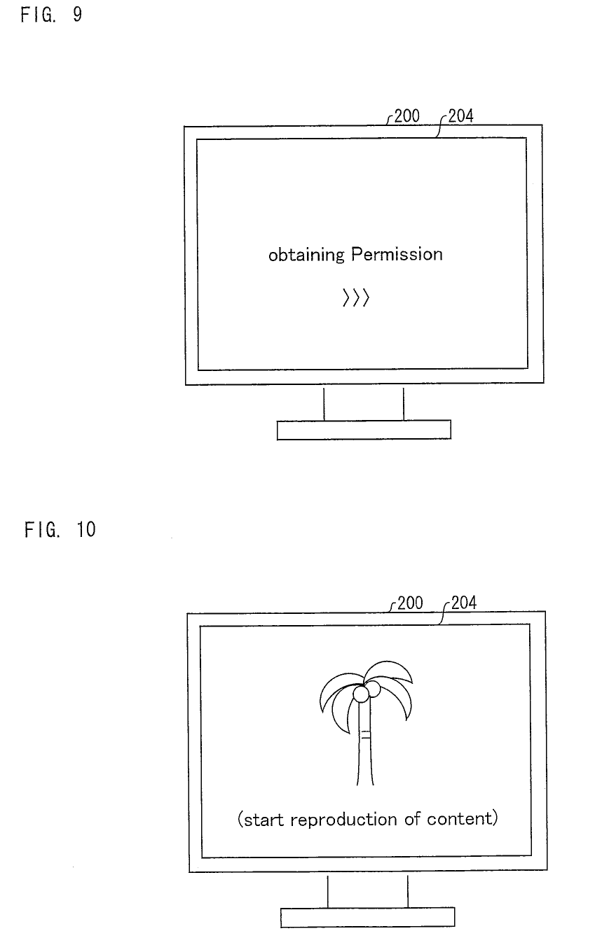

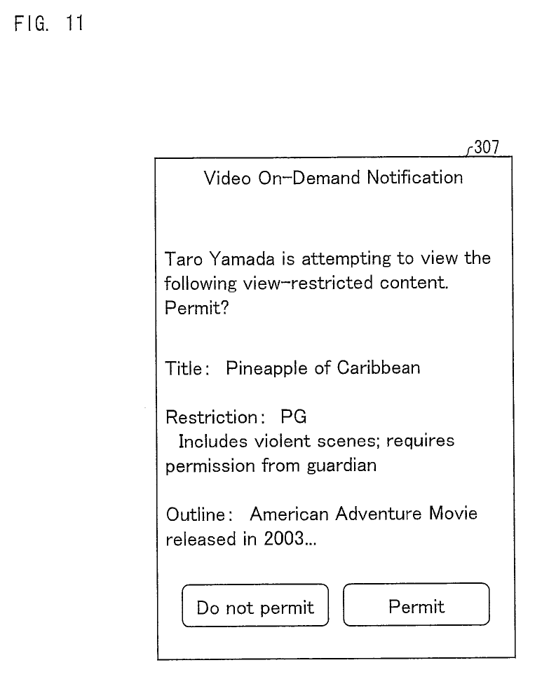

Next, when the operator operates the “view” button on the screen illustrated in FIG. 8 so as to view the content, the screen displayed on the display section 204 of the operation object device 200 transits to a screen illustrated in FIG. 9. FIG. 9 is a drawing schematically illustrating a screen displayed on the display section 204 of the operation object device 200, which displays that a case-by-case permission is being obtained from the permitter.

If the operator presses the “view” button, the remote operation device 300 transmits a predetermined remote control command to the operation object device 200. The operation object device 200, being triggered by receiving the remote control command, confirms whether or not permission from the permitter is necessary. Thereafter, since the content of “Pineapple of Caribbean” is a view-restricted content as described above, a request for a case-by-case permission is transmitted to the permitter device 3002. While the operation object device 200 is waiting for a response from the permitter, the operation object device 200 displays the screen illustrated in FIG. 9 on the display section 204.

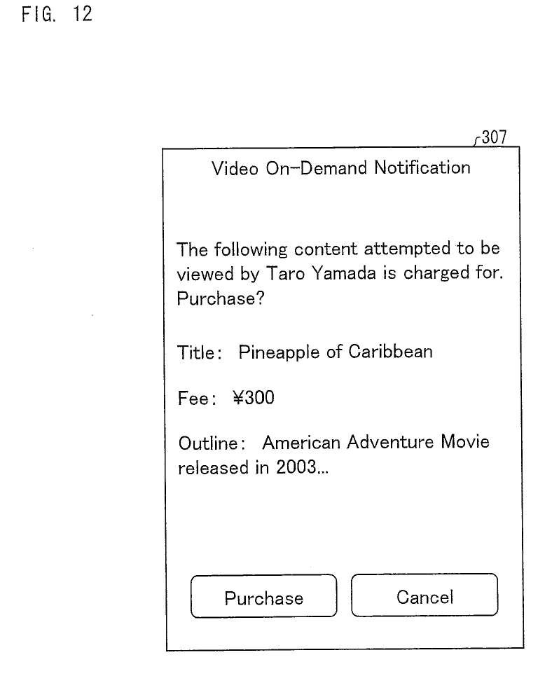

In response to the request, the permitter enters whether or not to provide the case-by-case permission, into the permitter device 3002 that receives the request for the case-by-case permission. An example of a screen that is displayed on the display section 204 of the permitter device 3002 is later described. In a case where the permitter provides the case-by-case permission, the operation object device 200 obtains content data from the service providing device 400, and displays a screen as illustrated in FIG. 10 on the display section 204.

FIG. 10 is a diagram schematically illustrating one example of how the view-restricted content is reproduced on the display section 204. That is to say, since the operator has obtained the case-by-case permission from the permitter, the drawing illustrates a state in which the operator can view the view-restricted content.

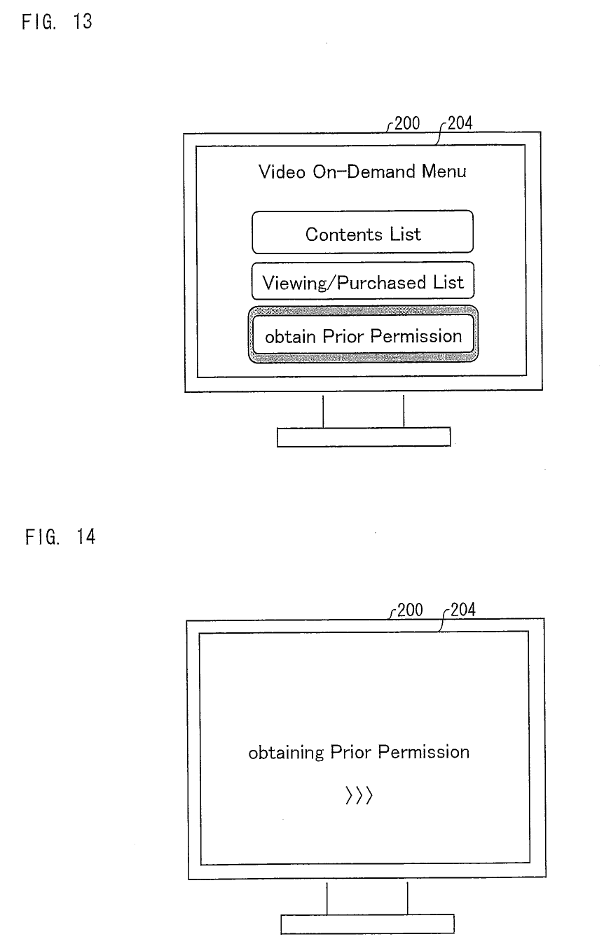

FIG. 11 illustrates an example of a screen displayed on the display section 307 of the permitter device 3002 upon receiving the case-by-case permission request. FIG. 11 is a diagram schematically illustrating one example of how a detail of a requested case-by-case permission is displayed on the display section 307 of the permitter device 3002. Here, the display shows from which operator the case-by-case permission is requested, for what content of what detail. Moreover, the buttons provided in a lower part of the screen allow entering of whether or not the case-by-case permission is provided.

To inform the permitter that a case-by-case request is received, not only a screen illustrated in FIG. 11 is displayed on the display section 204 of the permitter device 3002, but a predetermined audio may also be outputted from the audio output section 305 of the permitter device 3003, or alternatively, a vibrator not illustrated may be activated to vibrate the permitter device 3002.

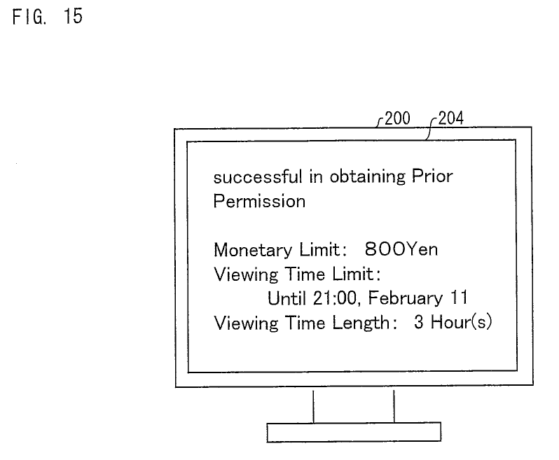

If the permitter presses the “permit” button to provide the case-by-case permission, the screen displayed on the display section 307 of the permitter device 3002 transits to a screen illustrated in FIG. 12. FIG. 12 is a diagram schematically illustrating one example of a display on the display section 307 of the permitter device 3002, which displays that content provided with the case-by-case permission is pay content. Here, the screen displays that the content provided with the case-by-case permission is pay content, and has buttons provided on a lower part of the screen which allow entering of whether or not to purchase the content. Here, if the permitter operates the “purchase” button, the permitter device 3002 transmits a response informing that permission is provided. As a result, reproduction of the view-restricted content starts on the display section 204 of the operation object device 200 (see FIG. 10).

The foregoing description is based on an example in which the view-restricted content is pay content. Therefore, when the permitter operates the “permit” button in FIG. 11, the screen transits to the screen illustrated in FIG. 12. However, when the view-restricted content is free of charge, after the “permit” button is pressed by the permitter, the screen does not transit to the screen in FIG. 12, and instead a response is immediately transmitted informing that permission is provided.

### Screen Example 2

### Screen Example of Obtaining Prior Permission

The following description deals with an operator obtaining prior permission from the permitter, with reference to screen examples.

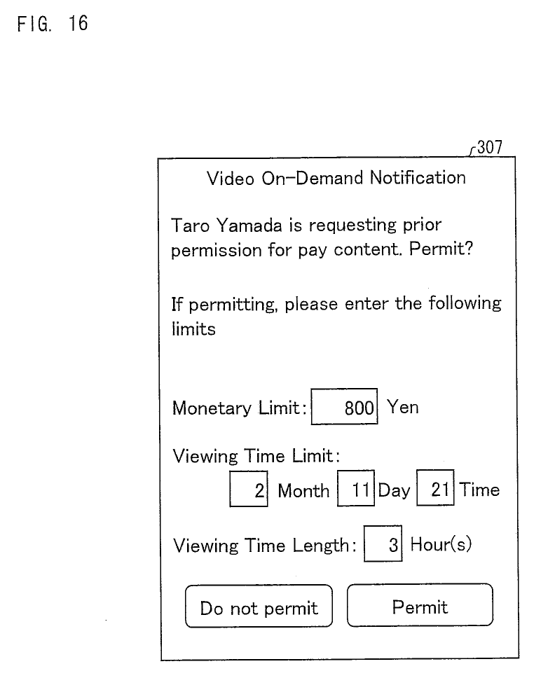

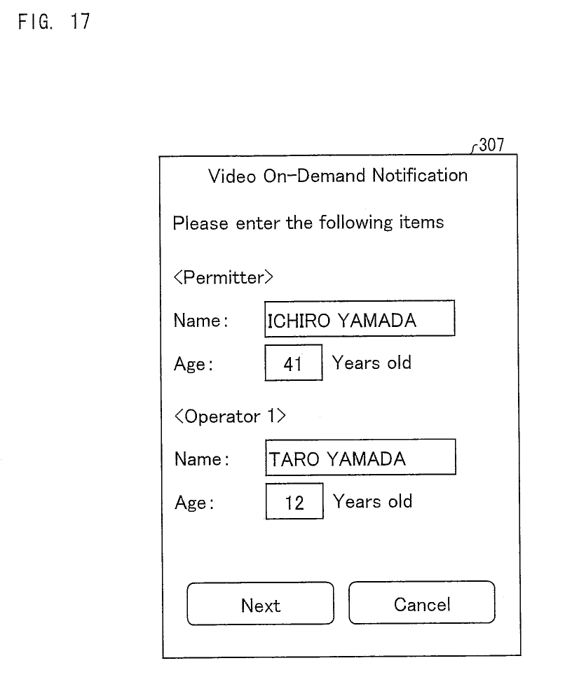

When the “enter” key is pressed by the operator to request for prior permission to a permitter at a state in which focus is given on “obtain prior permission” in the menu screen as illustrated in FIG. 13, the screen displayed on the display section 204 of the operation object device 200 transits to a screen illustrated in FIG. 14. FIG. 14 is a diagram schematically illustrating the display screen 204 displaying that the apparatus is currently obtaining prior permission from a permitter.

If the operator presses the “enter” key, the remote operation device 300 transmits a predetermined remote control command to the operation object device 200. Thereafter, a request for obtaining prior permission is transmitted to the permitter device 3002. While the operation object device 200 waits for a response from the permitter, the display section 204 displays a screen illustrated in FIG. 14.

In response to the request, the permitter enters details of the prior permission into the permitter device 3002 which receives the request for obtaining the prior permission. A screen example that is displayed on the display section 204 of the permitter device 3002 is later described.

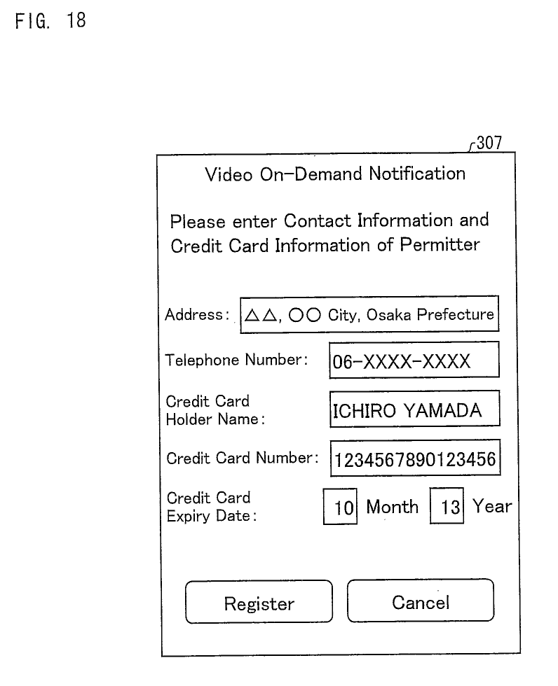

If the prior permission is provided from the permitter, the permitter device 3002 transmits a response informing that the prior permission is provided. Once the prior permission is provided by the permitter, the screen displayed on the display section 204 of the operation object device 200 transits to a screen illustrated in FIG. 15. FIG. 15 is a diagram schematically illustrating one example of how a detail of the prior permission provided by the permitter is displayed on the display section 204 of the operation object device 200. This example shows that a prior permission is provided which allows: viewing content up to a monetary viewing limit (monetary purchasing limit) of 800 yen; viewing content up to a viewing time limit of content (reproducing time limit) of until 21:00 of February 11; and a viewing time length of content (maximum reproduction time length) of 3 hours. Therefore, the operator can freely view the view-restricted content within the range of the provided prior permission. In other words, the operator can freely view the view-restricted content as long as (i) the total fees of the viewing content is not more than 800 yen, (ii) the view-restricted content is seen within a time limit of until 21:00 of February 11, and (iii) the total viewing time is not more than 3 hours. However, in order to view content that has an age restriction, it is necessary to separately obtain a case-by-case permission from the permitter.

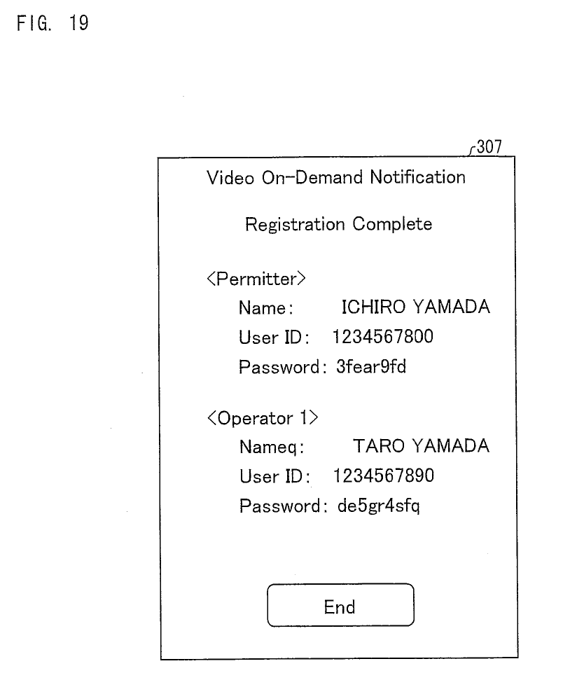

FIG. 16 illustrates an example of a screen displayed on the display section 307 of the permitter device 3002 immediately after the permitter device 3002 receives a prior permission request. FIG. 16 is a diagram schematically illustrating one example of a screen displayed on the display section 307 of the permitting apparatus 3002, for entering details required for providing the prior permission. Here, the permitter can enter, as the details for providing prior permission, the monetary limit (monetary purchasing limit), a viewing time limit (reproducing time limit), and a viewing time length (maximum reproduction time length).

Further, if the permitter presses a “permit” button, the permitter device 3002 transmits a response informing that prior permission is provided with the entered details. On the other hand, if the permitter presses the “not permitted” button, the permitter device 3002 transmits a response informing that no permission is provided.

(User Registration Screen Example)

In order to enable the permitter and operator to use the VOD service in the remote operation system 100, the permitter needs to carry out user registration in advance. The following description explains a procedure for user registration, with reference to a screen example.

When the permitter presses the “user registration” key on the remote control application illustrated in FIG. 3, the screen displayed on the display section 307 transits to a screen shown in FIG. 17. FIG. 17 is a diagram schematically illustrating one example of a screen of the permitter device 3002, in which a name and age of a permitter and a name and age of an operator to whom the permitter gives permission are entered. The name and age of the operator is repetitively entered for the number of operators that are to be registered.

Next, if the operator presses a “next” button on the screen illustrated in FIG. 17, the screen displayed on the display section 307 transits to a screen as illustrated in FIG. 18. FIG. 18 is a diagram schematically illustrating one example of a screen of the permitter device 3002 in which contact information (address and telephone number) and credit card information (credit card holder name, credit card number, and credit card expiry date) of the permitter are entered. The credit card information is used for a billing process when a pay content is purchased.

If the operator operates a “register” button at the screen illustrated in FIG. 18, the screen displayed on the display section 307 transits to a screen illustrated in FIG. 19. FIG. 19 is a diagram schematically illustrating a screen of the permitter device 3002 informing that user registration has completed and a user ID and password has been issued for the user(s). The user(s) enters this user ID and password in the screen illustrated in FIG. 4.

### First Embodiment

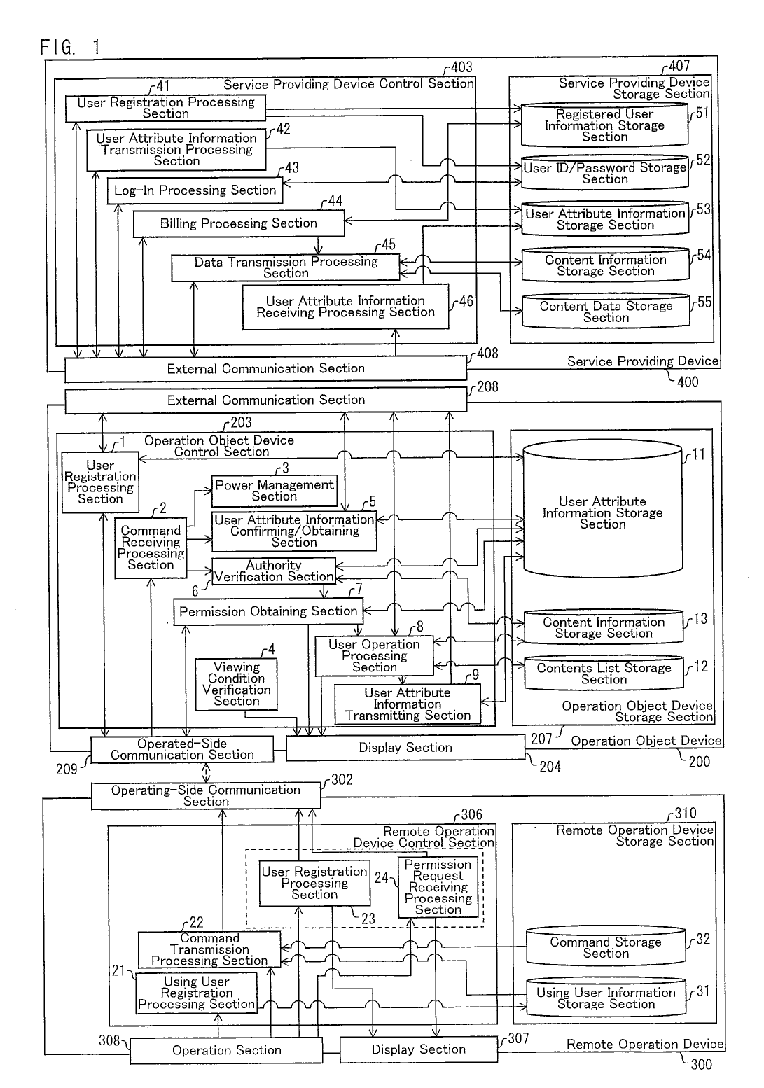

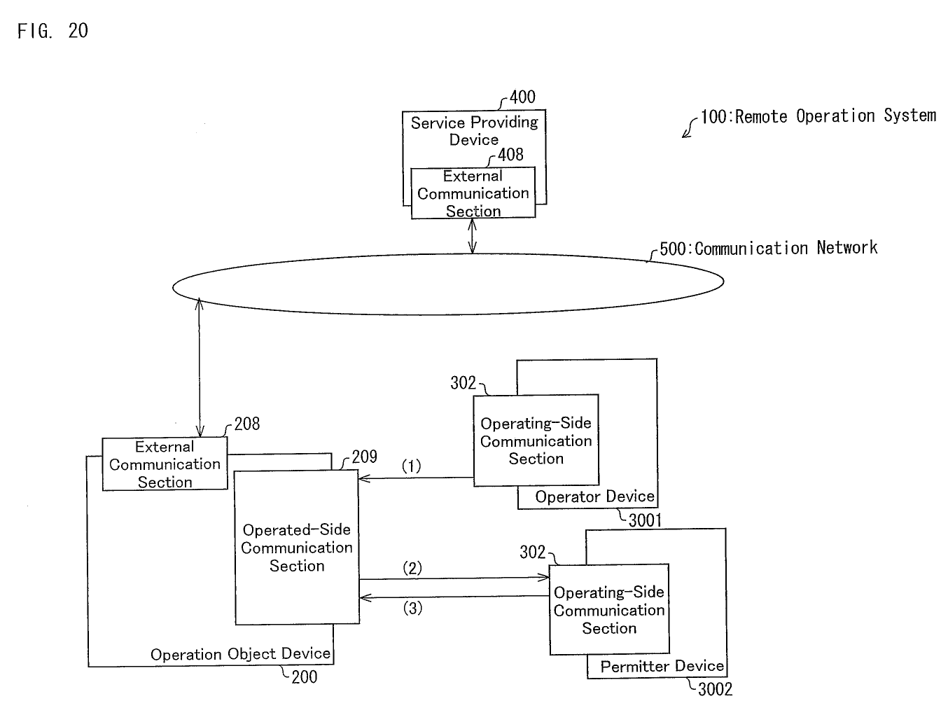

The following describes one embodiment of the present invention with reference to FIG. 1, and FIGS. 20 through 27.

Outline of Procedure for Obtaining Viewing Permission

With reference to FIG. 20, the following description outlines a procedure in accordance with the present embodiment for obtaining viewing permission from a permitter. FIG. 20 is a diagram schematically illustrating an outline of a procedure of how an operator obtains viewing permission from a permitter, in a remote operation system 100 in accordance with the present embodiment.

(Procedure for Obtaining Case-by-Case Permission)

First described is a procedure of how an operator obtains a case-by-case permission from a permitter. When the operator attempts to view view-restricted content by operating the operation object device 200 via the operator device 3001, a predetermined remote control command is transmitted to the operated-side communication section 209 of the operation object device 200 from the operating-side communication section 302 of the operator device 3001 (process (1) in FIG. 20). The operation object device 200 which receives the remote control command confirms whether or not the operator can view the view-restricted content freely. If it is determined that the operator cannot view the view-restricted content freely, the operation object device 200 specifies its permitting apparatus 3002, and transmits a request for a case-by-case permission to the operating-side communication section 302 of the specified permitter device 3002 from the operated-side communication section 209 (process (2) in FIG. 20).

After the permitter enters into the permitter device 3002 whether or not to permit viewing of the content in response to the request, the permitter device 3002 transmits a response from the operating-side communication section 302 to the operated-side communication section 209 of the operation object device 200 (process (3) in FIG. 20). At this time, if the permitter enters that the case-by-case permission is provided, the operator becomes possible to view the view-restricted content that the operator attempts to view.

According to the configuration, when the operator attempts to view a view-restricted content by using the operator device 3001, a request for a case-by-case permission is transmitted from the operation object device 200 to the permitter device 3002. After the permitter enters into the permitter device 3002 that the case-by-case permission is provided, the permitter device 3002 transmits a response to the operation object device 200 informing that the case-by-case permission is provided. This allows the operator to view the view-restricted content. Alternatively, if the permitter enters that the case-by-case permission is not provided, the permitter device 3002 transmits a response to the operation object device 200 informing that the case-by-case permission is not provided, and therefore the operator cannot view the view-restricted content.

(Procedure for Obtaining Prior Permission)

Next described is a procedure of how an operator obtains prior permission from a permitter. The procedure for obtaining the prior permission is substantially the same as the foregoing procedure for obtaining the case-by-case permission.

First, when the operator carries out operation for obtaining prior permission via the operator device 3001, a predetermined remote control command is transmitted to the operated-side communication section 209 of the operation object device 200 from the operating-side communication section 302 of the operator device 3001 (process (1) in FIG. 20). Thereafter, the operation object device 200 that receives the remote control command specifies its permitter device 3002, and transmits a request for prior permission to the operating-side communication section 302 of the specified permitter device 3002 from the operated-side communication section 209 (process (2) in FIG. 20).

After the permitter enters into the permitter device 3002 whether or not to provide the prior permission in response to the request, the permitter device 3002 transmits a response from the operating-side communication section 302 to the operated-side communication section 209 of the operation object device 200 (process (3) in FIG. 20). At this time, if the permitter enters that the prior permission is provided, the operator can view the view-restricted content that the operator attempts to view within the permitted range.

According to the configuration, when the operator carries out an operation for obtaining prior permission via the operator device 3001, a request for prior permission is transmitted from the operation object device 200 to the permitter device 3002. After the permitter enters into the permitter device 3002 that the prior permission is provided, the permitter device 3002 transmits a response to the operation object device 200 informing that the prior permission is provided. This allows the operator to view the view-restricted content within the range of the prior permission. Alternatively, if the permitter enters that prior permission is not provided, the permitter device 3002 transmits a response to the operation object device 200 informing that the prior permission is not provided, and therefore the operator cannot obtain the prior permission.

Furthermore, according to the configuration, in obtaining the case-by-case permission and prior permission from the permitter, the operator just requires operating the operation object device 200 via the operator device 3001 used by the operator. Moreover, the permitter also just requires entering whether or not to provide permission, into the permitter device 3002 used by the permitter, in response to the permission request, and there is no need for the permitter to directly operate the operation object device 200.

Furthermore, according to the configuration, the operation object device 200 and the permitter device 3002 directly exchange requests for the case-by-case permission and prior permission and responses thereto. Hence, even if at least one of the operator device 3001 and the permitter device 3002 does not include a telephone/web communication section 303 (that is to say, cannot communicate with the communication network 500 that serves as the mobile phone network), the operator can still attain the case-by-case permission and prior permission from the permitter.

Specific Configuration of Each Apparatus

With reference to FIG. 1, the following description explains more specifically of configurations of the operation object device 200, remote operation device 300, and service providing device 400, each in accordance with the present embodiment. FIG. 1 is a block diagram illustrating essential configurations of the operation object device 200, remote operation device 300, and service providing device 400, each in accordance with the present embodiment.

(Specific Configuration of Operation Object Device)

The first description more specifically describes the configuration of the operation object device 200. As illustrated in FIG. 1, the operation object device storage section 207 includes a user attribute information storage section 11 (storage section), a contents list storage section 12, and a content information storage section 13. Further, the operation object device control section 203 includes a user registration processing section 1, a command receiving processing section 2, a power management section 3, a viewing condition verification section 4, a user attribute information confirming/obtaining section 5 (user attribute information storage means), an authority verification section 6, a permission obtaining section 7 (permission request transmitting means, permission signal receiving means), a user operation processing section 8, and a user attribute information transmitting section 9.

The user attribute information storage section 11 stores, in a readable state, attribute information of a user (operator and permitter) who uses the remote operation system 100. The user attribute information storage section 11 may have a data configuration as shown in Table 1 below, for example. Table 1 is a table showing one example of a data configuration of the user attribute information storage section 11. As shown in Table 1, the user attribute information storage section 11 stores, as attribute information of a user, a set of “user ID”, “name”, “age”, “purchasing authority”, “permitter device address”, “permitter device telephone number”, “permitter ID”, “monetary limit”, “viewing time limit”, and “viewing time length”, for each user.

The “user ID” is an ID that enables unique identification of a user in the VOD service. In the example of Table 1, a value of “1234567890” is stored as a user ID. The “name” is a name of the user that is identified by the user ID. In the example of Table 1, a value of “Taro Yamada” is stored as the name. The “age” is the age of the user identified by the user ID. In the example of Table 1, a value of “12 years old” is stored as the age.

The “purchasing authority” indicates whether or not the user identified by the user ID has the authority to view pay content. Thus, a value of the purchasing authority is generally “No” if the user identified by the user ID is an operator and “Yes” if the user identified by the user ID is a permitter.

The “permitter device address” is an address of a permitter device 3002 for carrying out Bluetooth communication by the operating-side communication section 302 of the permitter device 3002. In the example of Table 1, a value of “00:11:22:33:44:AA” is stored as the permitter device address.

The “permitter device telephone number” is a telephone number of a permitter device 3002 for communicating with the telephone/web communication section 303 of the permitter device 3002 via the communication network 500 that serves as a mobile phone network. In the example of Table 1, a value of “090-1234-5678” is stored as the permitter device telephone number.

The “permitter ID”, in a case where the user identified by the user ID is an operator, is a user ID of a permitter who registered the user information of the operator. In the example of Table 1, a value of “1234567800” is stored as the permitter ID.

The “monetary limit”, in a case where the user identified by the user ID is an operator, is a monetary limit of the view-restricted content that the operator can purchase. In the example of Table 1, a value of “800 yen” is stored as the monetary limit. The monetary limit is provided from the permitter via the prior permission.

The “viewing time limit”, in a case where the user identified by the user ID is an operator, is a time limit (reproducing time limit) which indicates until when the operator can view the view-restricted content. In the example of Table 1, a value of “21:00, Feb. 11, 2008” is stored as the viewing time limit. The viewing time limit is provided from the permitter via the prior permission.

The “viewing time length”, in a case where the user identified by the user ID is an operator, is a total time of which the operator can view the view-restricted content (maximum reproduction time length). In the example of Table 1, a value of “3 hours” is stored as the viewing time length. The viewing time length is provided from the permitter by providing the prior permission.

When a prior permission is not provided from the permitter in advance for the monetary limit, viewing time limit, and viewing time length, these values are stored in the user attribute information storage section 11 as no value (NULL value). Moreover, with a record in which the purchasing authority is “Yes”, the permitter ID, monetary limit, viewing time limit, and viewing time length are stored in the user attribute information storage section 11 as no value (NULL value).

TABLE 1

| Column Name | Data Example | Definition |
|---|---|---|
| User ID | 1234567890 | Unique ID of user in the |
| | | service |
| Name | Taro Yamada | Name of user |
| Age | 12 years old | Age of user |
| Purchasing | No | Whether or not user has |
| Authority | | authority to purchase pay |
| | | content |
| Permitter | 00:11:22:33:44:AA | Address of permitter device |
| device Address | | for Bluetooth communication |
| Permitter | 090-1234-5678 | Telephone number of |
| device | | permitter device |
| telephone | | |
| number | | |
| Permitter ID | 1234567800 | User ID of permitter |
| Monetary limit | 800 yen | Upper limit value (provided |
| | | by permitter) of monetary |
| | | amount for purchasing |
| | | view-restricted content |
| Viewing time | 21:00, February | Time limit (provided by |
| limit | 11, 2008 | permitter) for viewing |
| | | view-restricted content |
| Viewing time | 3 hours | Total time (provided by |
| length | | permitter) for viewing |
| | | view-restricted content |

Next described is the contents list storage section 12 that stores, in a readable state, a list of contents obtained from the service providing device 400 by the user operation processing section 8 later described. The contents list storage section 12 may have a data configuration as shown in Table 2 below, for example. Table 2 is a table showing one example of a data configuration of the contents list storage section 12. As shown in Table 2, the contents list storage section 12 stores a set of “content ID” and “title”, for each content.

The “content ID” is an ID that allows unique identification of the content in the VOD service. The example in Table 2 stores a value of “111122223333” as the content ID.

The “title” is a title of the content identified by the content ID. In the example in Table 2, a value of “Pineapple of Caribbean” is stored as the title.

TABLE 2

| Column name | Data example | Definition |
|---|---|---|
| Content ID | 111122223333 | Unique ID of content in |
| | | the service |
| Title | Pineapple of Caribbean | Title of content |

Next described is the content information storage section 13 that stores, in a readable state, attribute information of content obtained from the service providing device 400 by the user operation processing section 8. The content information storage section 13 may have a data configuration as shown in Table 3, for example. Table 3 is a table showing one example of a data configuration of the content information storage section 13. As shown in Table 3, the content information storage section 13 stores a set of a “content ID”, “title”, “length of reproduction”, “fee”, “viewing restriction”, and “outline”, for each content.

The “content ID” and “title” are identical to those of the foregoing description.

The “length of reproduction” is the length of reproduction of the content identified by the content ID. In the example of Table 3, a value of “110 minutes” is stored as the length of reproduction.

The “fee” is an amount of money that a user needs to pay when the content identified by the content ID is viewed. Therefore, content that have a fee value set are pay content. In the example of Table 3, a value of “300 yen” is set as the fee.

The “viewing restriction detail” indicates a detail of the viewing restriction of the content identified by the content ID. In the example of Table 3, an explanation of “requires permission from adult (has rating restriction)” is stored as the viewing restriction detail.

The “outline” is an outline (summary) of the content identified by the content ID. In the example of Table 3, “American adventure movie released in 2003” is stored as the outline.

The content which has a value set for “fee” is pay content. Moreover, the content that has a value set for “fee” or “viewing restriction details” is view-restricted content.

TABLE 3

| Column name | Data example | Definition |
|---|---|---|
| Content ID | 111122223333 | Unique ID of content in |
| | | the service |
| Title | Pineapple of Caribbean | Title of content |
| Length of | 110 minutes | Length of Reproduction |
| Reproduction | | of content |
| Fee | 300 yen | Fee of content |
| Viewing | Requires permission | Detail of viewing |
| content detail | from adult | restriction of content |
| | (has rating restriction) | |
| Outline | American adventure | Outline of content |
| | movie released in 2003 | |

Next described is the user registration processing section 1. The user registration processing section 1 carries out processes that are carried out by the operation object device 200, among the series of processes carried out when a permitter registers attribute information of a user (permitter and operator), which user is a user of the remote operation system 100. As later described, in the remote operation system 100, only the permitter is eligible to register (hereinafter referred to as user registration) attribute information of a user (permitter and operator).

More specifically, first, the user registration processing section 1 receives, via the operated-side communication section 209, “first registered user information” that is transmitted from the permitter device 3002 as a result of the permitter carrying out the user registration. The “first registered user information is data including attribute information of a permitter and attribute information of one or a plurality of operators to which the permitter provides permission. An ID of the operation object device 200 is added to the received first registered user information, whereby “second registered user information” is generated, and the user registration processing section 1 transmits the “second registered user information” to the service providing device 400 via the external communication section 208.

The first registered user information may have a data configuration as shown in Table 4 below, for example. Table 4 is a table showing an example of a data configuration of the first registered user information. As shown in Table 4, the first registered user information includes “permitter name”, “permitter age”, “permitter address”, “permitter telephone number”, “permitter card holder name”, “permitter card number”, “permitter card expiry date”, “permitter device address”, “permitter device telephone number”, “operator name”, and “operator age”.

The “permitter name” is the name of a permitter. In the example of Table 4, a value of “Ichiro Yamada” is set as the permitter name. The “permitter age” is an age of the permitter. In the example of Table 4, a value of “41 years old” is set as the permitter age.

The “permitter address” is an address of the permitter. In the example of Table 4, a value of “ΔΔ, OO City, Osaka Prefecture” is set as the permitter address. The “permitter telephone number” is a telephone number of contact information of the permitter. In the example of Table 4, a value of “06-XXXX-XXXX” is set as the permitter telephone number.

The “permitter card holder name” is the name of the holder of the credit card of the permitter. In the example of Table 4, a value of “ICHIRO YAMADA” is set as the permitter card holder name. The “permitter card number” is the card number of the credit card of the permitter. In the example of Table 4, a value of “1234567890123450” is set as the permitter card number. The “permitter card expiry date” is an expiry date of the credit card of the permitter. In the example of Table 4, a value of “October, 2013” is set as the permitter card expiry date. The information related to the credit card is included in the attribute information of the permitter so as to allow carrying out of a billing process later described upon purchase of pay content.

The “permitter device address” is an address of the permitter device 3002, which is used in carrying out the Bluetooth communication at the operating-side communication section 302 of the permitter device 3002. In the example of Table 4, a value of “00:11:22:33:44:AA” is set as the permitter device address. The “permitter device telephone number” is a telephone number of the permitter device 3002 used in communicating with the telephone/web communication section 303 of the permitter device 3002 via the communication network 500 that serves as the mobile phone network. In the example of Table 4, a value of “090-1234-5678” is set as the permitter device telephone number.

The “operator name” is a name of an operator to which the permitter represented by the permitter name provides permission. In the example of Table 4, a value of “Taro Yamada” is set as the operator name. The “operator age” is the age of the operator. In the example of Table 4, a value of “12 years old” is set as the age of the operator. The set of the operator name and operator age are data that are repeated for the number of operators to which the permitter gives permission, however in the example of FIG. 4, just one operator is included.

TABLE 4

| Data items | Data example | Definition |
|---|---|---|
| Permitter | Ichiro Yamada | Name of permitter |
| name | | |
| Permitter age | 41 years old | Age of permitter |
| Permitter | ΔΔ, ◯◯ City, Osaka | Address of permitter |
| address | Prefecture | |
| Permitter | 06-XXXX-XXXX | Contact telephone number |
| telephone | | of permitter |
| number | | |
| Permitter card | ICHIRO YAMADA | Holder name of credit card |
| holder name | | of permitter |
| Permitter card | 1234567890123450 | Credit card number of |
| number | | permitter |
| Permitter card | October, 2013 | Expiry date of credit card |
| expiry date | | of permitter |
| Permitter | 00:11:22:33:44:AA | Address of permitter |
| device address | | device for Bluetooth |
| | | communication |
| Permitter | 090-1234-5678 | Telephone number of |
| device | | permitter device |
| telephone | | |
| number | | |
| Operator name | Taro Yamada | Name of operator |
| Operator age | 12 years old | Age of operator |

The second registered user information may have a data configuration as shown in Table 5 below, for example. As illustrated in Table 5, the second registered user information includes an “operation object device ID”, in addition to the data items included in the first registered user information. The operation object device ID is an ID that allows unique identification of the operation object device 200 in the VOD service. In the example of Table 5, a value of “9912345678” is set as the operation object device ID.

TABLE 5

| Data items | Data example | Definition |
|---|---|---|
| Permitter name | Ichiro Yamada | Name of permitter |
| Permitter age | 41 years old | Age of permitter |
| Permitter | ΔΔ, ◯◯ City, Osaka | Address of permitter |
| address | Prefecture | |
| Permitter | 06-XXXX-XXXX | Contact telephone |
| telephone | | number of permitter |
| number | | |
| Permitter card | ICHIRO YAMADA | Holder name of credit |
| holder name | | card of permitter |
| Permitter card | 1234567890123450 | Credit card number of |
| number | | permitter |
| Permitter card | October, 2013 | Expiry date of credit |
| expiry date | | card of permitter |
| Permitter device | 00:11:22:33:44:AA | Address for Bluetooth |
| address | | communication of |
| | | permitter device |
| Permitter device | 090-1234-5678 | Telephone number of |
| telephone | | permitter device |
| number | | |
| Operator name | Taro Yamada | Name of operator |
| Operator age | 12 years old | Age of operator |
| Operation object | 9912345678 | Unique ID of operation |
| device ID | | object device in the |
| | | service |

Transmission of the second registered user information to the service providing device 400 informs the service providing device 400 of users (permitter and operator) that use the remote operation system 100, and also informs the service providing device 400 that the operation object device 200 identified by the operation object device ID is an apparatus used by a registered user of the remote operation system 100.

Moreover, in the service providing device 400, the user registration processing section 41 later described carries out user registration process in the service providing device 400 based on the received second registered user information.

After the user registration processing section 1 transmits the second registered user information to the service providing device 400, the user registration processing section 1 receives, via the external communication section 208, “user registration result information” that is transmitted from the service providing device 400 as a response to the second registered user information. The “user registration result information” is data issued by the service providing device 400, which data includes the user ID and password of each user.

The user registration result information may have a data configuration as shown in Table 6 below, for example. Table 6 shows one example of a data configuration of the user registration result information. As shown in Table 6, the user registration result information includes “permitter name”, “permitter ID”, “permitter password”, “operator name”, “operator ID”, and “operator password”.

The “permitter name” and “operator name” are identical to those included in the second registered user information.

The “permitter ID” is a user ID of the permitter indicated by the permitter name, and is issued by the service providing device 400. In the example of Table 6, a value of “01234567800” is set as the permitter ID. The “permitter password” is a password for the permitter identified by the permitter ID. In the example of Table 6, a value of “9fear9fd” is set as the permitter password.

The “operator ID” is a user ID of the operator indicated by the operator name, and is issued by the service providing device 400. In the example of Table 6, a value of “01234567890” is set as the operator ID. The “operator password” is a password for the operator that is identified by the operator ID, and is issued by the service providing device 400. In the example of Table 6, a value of “de5gr4sfq” is set as the operator password.

A set of the permitter name, permitter ID, and permitter password is data that is repeatedly included for the number of operators, however the example in Table 6 just includes one operator.

TABLE 6

| Data items | Data example | Definitions |
|---|---|---|
| Permitter name | Ichiro Yamada | Name of permitter |
| Permitter ID | 1234567800 | User ID of permitter |
| Permitter | 3fear9fd | Password for permitter |
| password | | |
| Operator name | Taro Yamada | Name of operator |
| Operator ID | 1234567890 | User ID of permitter |
| Operator | de5gr4sfq | Password for operator |
| password | | |

Following this, the user registration processing section 1 generates a record in the user attribute information storage section 11 based on information included in the first registered user information and user registration result information, so as to cause the user attribute information storage section 11 to store attribute information of a user registered as a user.

More specifically, based on the “permitter ID” and “permitter name” included in the user registration result information, and further the “age” included in the first registered user information, a record of the permitter is generated in the user attribute information storage section 11. At this time, the “purchasing authority” in the record is set as “Yes”. Further, the “permitter ID”, “monetary limit”, “viewing restriction”, and “viewing time length” are set with no value (NULL value).

Moreover, a record of the operator is generated in the user attribute information storage section 11, based on the “operator ID” and “operator name” included in the user registration result information and the “age” included in the first registered user information. At this time, the “purchasing authority” in the record is set as “No”. Further, the “permitter ID” is set with the permitter ID included in the user registration result information. The “monetary limit”, “viewing restriction”, and “viewing time length” are set with no value (NULL value).

Finally, the user registration processing section 1 transfers the received user registration result information to the permitter device 3002, via the operated-side communicating section 209, as a response to the permitter device 3002 that transmitted the first registered user information. This thus allows the permitter that uses the permitter device 3002 to know the ID and password for all users that the permitter has registered to the service providing device 400.

Next described is the command receiving processing section 2. The command receiving processing section 2 receives a “remote control command” that is transmitted from the remote operation device 300 via the operated-side communication section 209. Thereafter, the command receiving processing section 2 provides instructions to each of sections in the operation object device control section 203, which instructions are provided in accordance with command names that are included in the received remote control command.

The remote control command may have a data configuration as shown in Table 7 below, for example. Table 7 shows one example of a data configuration of a remote control command. As shown in Table 7, the remote command includes a “user ID”, “password”, and “command name”.

The “user ID” is a user ID of a user that uses the remote operation device 300 from which the remote control command is transmitted. The “password” is a password for the user, and is issued by the service providing device 400.

The “command name” indicates operation details on the remote control application to be taken by the user. There are as many types of command names as the number of key operations provided on the remote control application, and a value in accordance with the key operation is set. In Table 7, an example is given of a value “0xAAAA 8888 2201” which denotes a remote control command including a command (hereinafter referred to as power command) that indicates that the power key is pressed.

TABLE 7

| Data item | Data example | Definition |
|---|---|---|
| User ID | 1234567890 | User ID |
| Password | de5gr4sfq | Password for user |
| Command name | 0xAAAA 8888 2201 | Pressing power key |

The following description describes the power management section 3. The power management section 3 switches between whether to supply electricity to each of sections in the operation object device 200 (i.e., turn ON the main power) or to not supply electricity thereto (i.e., caused to be in a standby state), in accordance with an instruction from the command receiving processing section 2 that receives the power command. Namely, when a power command is received during a standby state, the power management section switches the main power ON, whereas when the power command is received while the main power is ON, the power management section 3 switches into the standby state.

Even during the standby state, the operation object device 200 is receptive to at least the power command. Moreover, while the main switch is ON, the operation object device 200 is receptive to all of the remote control commands.

The next description explains the viewing condition verification section 4. In a case where the operator is viewing the view-restricted content by obtaining prior permission from the permitter, the viewing condition verification section 4 verifies whether or not the operator is viewing the view-restricted content within the viewing time limit or viewing time length provided by the prior permission (hereinafter referred to as content viewing verification process).

More specifically, the viewing condition verification section 4 first retrieves from the user attribute information storage section 11 a record that has a user ID of the user who is viewing the content, and obtains a “viewing time limit” and “viewing time length”. Thereafter, the viewing condition verification section 4 verifies whether or not a current system time of the operation object device 200 has elapsed the obtained viewing time limit. Additionally, the viewing condition verification section 4 verifies whether or not the total length of reproduction of the content exceeds the obtained viewing time length. The total length of reproduction of the content is stored in the operation object device storage section 207, per user.

If a result of the verification shows that the viewing time limit or the viewing time length provided by the permitter is elapsed or exceeded, the viewing condition verifying section 4 displays on the display section 204 that an error has occurred and stops reproduction of the view-restricted content. If the operator wants to continuously view the view-restricted content, a new prior permission is to be obtained from the permitter.

The content viewing verification process is repetitively carried out per predetermined timing (for example every 1 minute), during standby for receiving the remote control command. A procedure of the content viewing verification process is later described with reference to a flow chart.

The following description explains the user attribute information confirming/obtaining section 5. The user attribute information confirming/obtaining section 5, upon receiving a remote control command, refers to a user ID included in the received remote control command to check whether or not a record that has the user ID is stored in the user attribute information storage section 11 (i.e., checks whether or not the user is a user that is registered in the operation object device 200). If the record that includes the user ID is not stored in the user attribute information storage 11 (i.e., if the user is not a user registered in the operation object device 200), the user attribute information confirming/obtaining section 5 transmits a “user information request” to the service providing device 400 via the external communication section 208, to request for obtainment of attribute information of the user identified by the user ID. The user information request may have a data configuration as shown in Table 8 below, for example. As shown in Table 8, the user information request includes a “user ID”. In the example of Table 8, a value of “REQUEST_USER_DATA” is set as the user information request. The “user ID” is identical to the data stored in the user attribute information storage section 11 shown in Table 1.

TABLE 8

| Data item | Data example | Definition |
|---|---|---|
| User | REQUEST_USER_DATA | Request for transmission |
| information | | of user attribute |
| request | | information |
| User ID | 1234567890 | Unique ID of user in the |
| | | service |

After transmitting the user information request, the user attribute information confirming/obtaining section 5 receives “user attribute information” that is transmitted from the service providing device 400 via the external communication section 208, as a response to the user information request. The user attribute information confirming/obtaining section 5 then stores the data included in the received user attribute information to the user attribute information storage section 11.

The user attribute information may have a data configuration as shown in Table 9 below, for example. Table 9 shows one example of a data configuration of the user attribute information. As shown in Table 9, the user attribute information includes a “user ID”, “name”, “age”, “purchasing authority”, “permitter device address”, “permitter device telephone number”, “permitter ID”, “monetary limit”, “viewing time limit”, and “viewing time length”. Each of the data is identical to the data stored in the user attribute information storage section 11, as shown in Table 1.

TABLE 9

| Column Name | Data Example | Definition |
|---|---|---|
| User ID | 1234567890 | Unique ID of user in the |
| | | service |
| Name | Taro Yamada | Name of user |
| Age | 12 years old | Age of user |
| Purchasing | No | Whether or not user has |
| authority | | authority to purchase pay |
| | | content |
| Permitter | 00:11:22:33:44:AA | Address of permitter |
| device Address | | device for Bluetooth |
| | | connection |
| Permitter | 090-1234-5678 | Telephone number of |
| device | | permitter device |
| telephone | | |
| number | | |
| Permitter ID | 1234567800 | User ID of permitter |
| Monetary limit | 800 yen | Upper limit value |
| | | (provided by permitter) of |
| | | monetary amount for |
| | | purchasing view-restricted |
| | | content |
| Viewing time | 21:00, February 11, | Expiry date (provided by |
| limit | 2008 | permitter) for viewing |
| | | view-restricted content |
| Viewing time | 3 hours | Total time (provided by |
| length | | permitter) for viewing |
| | | view-restricted content |

The following description explains why the foregoing process by the user attribute information confirming/obtaining section 5 is carried out. For example, consider a case where an operator uses an operation object device 200 different from a regularly used operation object device 200 (for example, an operation object device 200 at an outside location). In this case, if the permitter has carried out the user registration, the regularly used operation object device 200 has a record that corresponds to the operator stored in the user attribute information storage section 11, which record is stored by the user registration processing section 1. However, the other operation object device 200 that is not regularly used has no record stored in its user attribute information storage section 11, which corresponds to the operator. Consequently, the other operation object device 200 cannot obtain the “age” and “monetary limit” of the operator in the authority verification process later described, and as a result, the operator cannot view the view-restricted content with the other operation object device 200. The purpose of carrying out the process by the user attribute information confirming/obtaining section 5, in the case where the other operation object device 200 is to be used for viewing the content, is to allow the operator to view the view-restricted contents with use of the other operation object device 200 by obtaining the user attribute information stored in the service providing device 400.

The record generated in the user attribute information storage section 11 by the user attribute information confirming/obtaining section 5 may be deleted from the user attribute information storage section 11 at a timing in which the operation object device switches to a standby state. This is because, in many cases, use of the other operation object device 200 (for example, operation object device 200 at an outside location) is only temporary.

Next describes the authority verification section 6. The authority verification section 6 analyses details of the remote command received from the operator device 3001, and determines whether or not the operation to be carried out by the operator requires a case-by-case permission or prior permission from the permitter (hereinafter referred to as authority verification process).

The following description describes in what cases does the authority verification section 6 determine that a case-by-case permission or prior permission is required. First, in a case where the operation taken by the operator is an “operation to view content”, the authority verification section 6 determines that the case-by-case permission is required when (1) an operator of an age not satisfying an age restriction of a viewing content attempts to view the viewing content, and/or (2) an operator who has not been set with a monetary limit by prior permission attempts to view pay content. The “operation to view content” more specifically indicates a pressing operation of a “view” button on the screen illustrated in FIG. 8.

The following description explains the foregoing (1) more specifically. First, a record is retrieved from the user attribute information storage section 11, which record thus retrieved has the user ID that is included in the remote control command received from an operator device 3001. This record is retrieved so as to obtain the “age” of the user identified by the user ID. Thereafter, a “viewing restriction” included in the attribute information of the content that the operator attempts to view is obtained from the content information storage section 13. The obtained age and the obtained viewing restriction are compared with each other, and in a case where the obtained age does not satisfy the obtained viewing restriction, the authority verification section 6 determines that the case-by-case permission is necessary.

For example, if the age of the user is 15, and the viewing restriction of the content is “requires permission from adult”, the age of the user does not satisfy the viewing restriction of the content, and therefore the authority verification section 6 determines that the case-by-case permission is necessary.

Next describes the foregoing (2) more specifically. First, a record is retrieved from the user attribute information storage section 11, which record has the user ID that is included in the remote control command received from an operator device 3001. This record is retrieved so as to obtain the “monetary limit”. Next, the “fee” of the content that is to be viewed is obtained from the content information storage section 13. In a case where the obtained monetary limit is not set (NULL value), and the obtained fee is set with a value (other than NULL value), the authority verification section determines that the case-by-case permission is necessary.

The authority verification section 6 determines that the case-by-case permission is unnecessary in a case where a content attempted to be viewed by the operator (1) has either no age restriction or has an age restriction satisfiable by the age of the operator, and (2) is either free of charge or is pay content that is charged by an amount that does not exceed the monetary limit provided in the prior permission when the amount is totaled to a purchased amount of viewed (purchased) pay contents. The total purchase fee of contents is stored in the operation object device storage section 207, per user.

The authority verification section 6 also determines that the case-by-case permission is unnecessary, in a case where a user that has purchasing authority is to view the pay content.

On the other hand, the authority verification section 6 determines that prior permission is necessary in a case where the operation detail from the operator is “operation for obtaining prior permission”. More specifically, the authority verification section 6 determines that prior permission is necessary in a case where the prior permission obtaining menu is operated on the screen illustrated in FIG. 13.

In a case where the operator provided with a monetary limit by the prior permission attempts to view pay content of a fee that causes a total purchase amount of pay content to exceed the provided monetary limit, the authority verification section 6 determines this as an error, and displays an error message on the display section 204. In this case, the operator needs to obtain a new prior permission from the permitter, in order for the operator to view the pay content.

The procedure for the foregoing authority verification process will be described later with reference to a flow chart.

The following description explains the permission obtaining section 7. If the authority verification section 6 determines that it is necessary to obtain a case-by-case permission or prior permission from the permitter, the permission obtaining section 7 requests to the permitter device 3002 so that a case-by-case permission or prior permission is provided from the permitter.

More specifically, the permission obtaining section 7 first specifies the permitter device 3002 used by the permitter. In order to do so, the permission obtaining section 7 obtains a “permitter device address” which is included in a record stored in the user attribute information storage section 11. The record is stored as attribute information of the permitter of an operator, which operator is identified by a user ID included in the remote control command received from the operator device 3001.

Thereafter, the permission obtaining section 7 requests for the case-by-case permission or prior permission to a permitter device 3002 of the obtained permitter device address. More specifically, the permission obtaining section 7 transmits a “permission request” via the operated-side communication section 209. The permission request may have a data configuration as shown in Table 10 below, for example. Table 10 shows one example of a data configuration of the permission request. As shown in Table 10, the permission request includes “permitter user information”, “operator user information”, “content detail”, “content information”, “first permission request detail”, and “second permission request detail”.

The “permitter user information” is the entire data included in the record stored in the user attribute information storage section 11 as attribute information of the permitter of the operator, which operator is identified by the user ID included in the remote command. This data is used to specify a permitter to whom the permission request is transmitted.

The “operator user information” is the entire data included in a record stored in the user attribute information storage section 11, which record is stored as attribute information of the operator identified by the user ID included in the remote control command. The data informs to the permitter what kind of operator the permission request is transmitted from.

The “operation detail” is either the “operation for viewing content” or “operation for obtaining prior permission” carried out by the operator. The operation detail is the “operation for viewing content” if the “view” button is pressed while the screen illustrated in FIG. 8 is displayed; alternatively, the operation detail is the “operation for obtaining prior permission” if the “prior permission obtainment” menu is operated while the screen illustrated in FIG. 13 is displayed. Therefore, it is possible to distinguish whether the permission request is for a case-by-case permission or for a prior permission, depending on the value of the operation detail. In the example of Table 10, the “operation for viewing content” is set.

The “content information”, in the case where the operation detail is the “operation for viewing content”, is attribute information of the content. More specifically, the “content information” is the entire data (content ID, title, length of reproduction, fee, viewing restriction detail, and outline) in the record of the content retrieved from the content information storage section 13. The data informs to the permitter what kind of content the permission request is transmitted for.

The “first permission request detail” is a detail (first detail) of the permission that is requested to the permitter, in a case where the operation detail is “operation for viewing content”. In the example of FIG. 10, permission is requested for viewing content with a rating restriction.

The “second permission request detail” is a detail (second detail) of the permission that is requested to the permitter, in the case where the operation detail is the “operation for viewing content”. In the example of FIG. 10, permission is requested for viewing pay content.

In the case where the operation detail is “operation for obtaining prior permission”, no values are set for the content information, first permission request detail, and second permission request detail (are a NULL value).

TABLE 10

| Data item | Data example | Definition |
|---|---|---|
| Permitter user | (data managed in | Attribute information of |
| information | user attribute | permitter |
| | information storage | |
| | section 11 as | |
| | attribute information | |
| | of permitter) | |
| Operator user | (data managed in | Attribute information of |
| information | user attribute | operator |
| | information storage | |
| | section 11 as | |
| | attribute information | |
| | of operator) | |
| Operation | Operation for viewing | Operation detail by |
| content | content | operator (one of operation |
| | | for viewing content and |
| | | operation for obtaining |
| | | prior permission) |
| Content | (data managed in | Attribute information of |
| information | content information | content |
| | storage section 13) | |
| First | To view content | Detail (first) for which |
| permission | having rating | permission is requested |
| request detail | restriction | |
| Second | To view pay content | Details (second) for which |
| permission | | permission is requested |
| request detail | | |

The permission obtaining section 7, after transmitting the permission request to the permitter device 3002, then receives a “permission result response” transmitted from the permitter device 3002 as a response to the permission request, via the operated-side communication section 209. The permission result response (permission signal) is data including a result of whether or not the permitter provided the viewing permission.

The permission result response may have a data configuration as shown in Table 11 below, for example. Table shows one example of a data configuration of the permission result response. As shown in Table 11, the permission result response includes “permitter ID”, “operator user information”, “operation detail”, “content information”, “first permission detail”, “second permission detail”, and “third permission detail”.

The “permitter ID” is a user ID of the permitter, and is data which indicates the permitter who provided the permission.

The “operator user information” is data identical to the “operator user information” included in the permission request. The “operation detail” is data identical to the operation detail included in the permission request. The content information is data identical to the content information included in the permission request. The data indicates which permission request the permission result response is responding to.

The “first permission detail”, in the case where (1) the operation detail is “operation for viewing content”, is a detail of a case-by-case permission provided in response to the first permission request detail included in the permission request. If the permitter provides no case-by-case permission thereto, no value is set (the value is set as NULL). Moreover, in a case where (2) the operation detail is “operation for obtaining prior permission”, a “monetary limit” provided in the prior permission by the permitter is set. If the permitter provides no prior permission regarding the monetary limit, no value is set (the value is set as NULL). The example of Table 11 is set so that content having a rating restriction is viewable.

The “second permission detail”, in the case where (1) the operation detail is “operation for viewing content”, is a detail of a case-by-case permission provided in response to the second permission request detail included in the permission request. If the permitter provides no case-by-case permission thereto, no value is set (the value is set as NULL). Moreover, in the case where (2) the operation detail is “operation obtaining prior permission”, a “viewing time limit” provided in the prior permission by the permitter is set. If the permitter provides no prior permission regarding the viewing time limit, no value is set (the value is set as NULL). The example of Table 11 is set so that pay content is viewable.

The “third permission detail” is a data item only provided in a case where the operation detail is the “operation for obtaining prior permission”, and the “viewing time length” provided in the prior permission by the permitter is set. If the permitter provides no prior permission regarding the viewing time length, no value is set (the value is set as NULL).

TABLE 11

| Data item | Data example | Definition |
|---|---|---|
| Permitter ID | 1234567890 | User ID of permitter |
| Operator user | (identical to operator | Attribute information of |
| information | user information in | operator |
| | permission request) | |
| Operation | (identical to operation | Operation detail of |
| detail | detail in permission | operator |
| | request) | |
| Content | (identical to content | Attribute information of |
| information | information in | content |
| | permission request) | |
| First | May view content | Detail (1) for which |
| permission | with rating restriction | permission is provided by |
| detail | | permitter |
| Second | May view pay content | Detail (2) for which |
| permission | | permission is provided by |
| detail | | permitter |
| Third | (omitted) | Detail (3) for which |
| permission | | permission is provided by |
| detail | | permitter |

If the permission obtaining section 7 receives any one of the following (A) through (C) permission result responses (hereinafter referred to as non-permission response), the permission obtaining section 7 regards this as an error, and displays an error message on the display section 204. The non-permission result responses of (A) through (C) are: (A) the operation detail is “operation for viewing content”, and although a detail is set for requesting permission to the first permission request detail of the corresponding permission request, no value is set in the first permission detail of the permission result response; (B) the operation detail is “operation for viewing content”, and although a detail is set for requesting permission to the second permission request detail of the corresponding permission request, no value is set in the second permission detail of the permission result response; and (C) the operation detail is “operation for obtaining prior permission”, and no value is set in any of the first permission detail, second permission detail, and third permission detail of the permission result response.

If a permission result response is not received after elapse of a predetermined time (for example, 3 minutes) since the transmission of the permission request, such a case is also treated as an error and thus an error message is displayed on the display section 204.

On the other hand, if the permission obtaining section 7 receives any one of the permission result response (hereinafter referred to as permission response) of the following (D) and (E), the viewing permission is provided from the permitter. Accordingly, the permission obtaining section 7 causes the user operation processing section 8 to carry out subsequent processes. The permission result response of (D) and (E) specifically are: the permission result responses in which (D) the operation detail is “operation for viewing content”, and the first permission detail or second permission detail of the permission result response that respectively correspond to the permission requested in the first permission request detail or second permission request detail of the corresponding permission request is set, and (E) the operation detail is “operation for obtaining prior permission”, and at least one of the first permission detail, second permission detail, and third permission detail of the permission result response is set with a value.

The procedure of the process carried out by the permission obtaining section 7 (hereinafter referred to as permission obtaining process) is described later with reference to a flow chart.

The following description explains the user operation processing section 8. The user operation processing section 8 carries out processes in accordance with instruction details from the remote operation device 300 of the user. The instruction details encompass: (1) instructions to display a menu, (2) instructions to display a contents list, (3) instructions to display content information, (4) instructions to reproduce content (instructions to view content), and (5) operation instructions for functions generally provided in the operation object device 200 serving as a television receiver (e.g., changing channels, adjustment of volume, adjustment of screen brightness).

The foregoing (1) is a process in which the operator presses the “menu” key on the remote control application; the foregoing (2) is a process in which the operator presses the “enter” key on the remote control application while focus is on the “contents list” in the screen illustrated in FIG. 6; the foregoing (3) is a process in which the operator presses the “enter” key on the remote control application while the focus is on the content in the screen illustrated in FIG. 7; and the foregoing (4) is a process in which the operator presses the “enter” key on the remote control application while focus is on the “view” button in the screen illustrated in FIG. 8. Therefore, it is possible to determine the instruction details based on the display state of the current screen on the display section 204 and the command names included in the remote control commands transmitted from the operator device 3001.

The following description explains a process carried out by the user operation processing section 8 in a case where the instruction detail is the foregoing (1) through (4). The instruction detail of the foregoing (5) only cause changing of channels, adjustment of volume, adjustment of brightness of the screen or the like, and therefore such descriptions are omitted here.

If the instruction detail is the foregoing (1), the user operation processing section 8 first transmits a “log-in request” to the service providing device 400. The log-in request is transmitted for logging into the service providing device 400, so that the operator can enjoy the VOD service.

The log-in request may have a data configuration as shown in Table 12 below, for example. Table 12 shows one example of a data configuration of a log-in request. As shown in Table 12, the log-in request includes a “user ID” and “password”. The user ID and password included in the log-in request are respectively identical to the user ID and password included in the remote control command received by the command receiving processing section 2.

TABLE 12

| Data item | Data example | Definition |
|---|---|---|
| User ID | 1234567890 | Unique ID of operator in |
| | | the service |
| Password | de5gr4sfq | Password |

The user operation processing section 8, after transmitting the log-in request, receives a “log-in notification” that is transmitted from the service providing device 400 as a response to the log-in request. The log-in notification indicates whether or not the operator is successfully logged in.

The log-in notification may have a data configuration as shown in Table 13 below, for example. Table 13 shows one example of a data configuration of the log-in notification. As shown in Table 13, the log-in notification includes a “user ID” and “log-in result”. The “user ID” is used to indicate to which log-in request the log-in notification is transmitted in response. The “log-in result” indicates whether the operator has successfully logged in or was unsuccessful in logging in. In the example of Table 13, the log-in result is set as successful.

The user operation processing section 8 refers to the log-in result included in the log-in notification, and once the user operation processing section 8 recognizes that the operator is successfully logged in, the user operation processing section 8 displays on the display section 204 the menu screen similar to the menu screen illustrated in FIG. 6. On the other hand, if the operator was unsuccessful in logging in, this is dealt with as an error, and an error message is displayed on the display section 204.

TABLE 13

| Data item | Data example | Definition |
|---|---|---|
| User ID | 1234567890 | Unique ID of operator in |
| | | the service |
| Log-in result | Successful | Successful/Unsuccessful |
| | | in log-in |

If the instruction detail is the foregoing (2), the user operation processing section 8 first transmits a “contents list request” to the service providing device 400. The contents list request may have a data configuration as shown in Table 14 below, for example. Table 14 shows one example of a data configuration of the contents list request.

TABLE 14

| Data item | Data example | Definition |
|---|---|---|
| Contents list | REQUEST_CONT_LIST | Request to transmit a |
| request | | contents list |

The user operation processing section 8, after transmitting the contents list request, receives a “contents list” transmitted from the service providing device 400 as a response to the contents list request.

The contents list may have a data configuration as shown in Table 15 below, for example. Table 15 shows one example of a data configuration of the contents list. As shown in Table 15, the contents list includes “number of contents”, “contents ID”, and “title”. The “number of contents” indicate the number of pairs of the contents ID and titles that are included in the contents list. The pairs of the contents ID and titles are data that are repeated for the number of contents included; however in this example, just one pair is shown.

Thereafter, the user operation processing section 8 displays on the display section 204 a screen similar to the screen illustrated in FIG. 7, based on the received contents list. Further, the user operation processing section 8 stores in the contents list storage section 12 the pairs of contents ID and titles included in the received contents list.

TABLE 15

| Data item | Data example | Definition |
|---|---|---|
| Number of | 30 | Number of contents |
| Contents | | |
| Content ID | 111122223333 | Unique ID of content in |
| | | the service |
| Title | Pineapple of | Title of content |
| | Caribbean | |

If the instruction detail is the foregoing (3), the user operation processing section 8 transmits a “content information request” to the service providing device 400. The content information request may have a data configuration as shown in Table 16 below, for example. Table 16 shows one example of a data configuration of the content information request. In the example of Table 16, a value of “REQUEST_CONT_DETAIL” is set as the content information request.

TABLE 16

| Data item | Data example | Definition |
|---|---|---|
| Content | REQUEST_CONT_DETAIL | Request to transmit |
| information | | content information |
| request | | |

The user operation processing section 8, after transmitting the content information request, receives “content information” transmitted from the service providing device 400 as a response to the content information request. The content information may have a data configuration as shown in Table 17 below, for example. Table 17 shows one example of a data configuration of the content information. As shown in Table 17, the content information includes data that is identical to the data stored in the content information storage section 13 shown in Table 3.

Thereafter, the user operation processing section 8 displays on the display section 204 a screen similar to the screen illustrated in FIG. 8, based on the received content information. Further, the received content information is stored in the content information storage section 13.

TABLE 17

| Data item | Data example | Definition |
|---|---|---|
| Content ID | 111122223333 | Unique ID of content in |
| | | the service |
| Title | Pineapple of Caribbean | Title of content |
| Length of | 110 minutes | Length of reproduction |
| reproduction | | of content |
| Fee | 300 yen | Fee of content |
| Viewing | Requires permission | Details of viewing |
| restriction | from adult | restriction of content |
| | (rating restriction) | |
| Outline | American adventure | Outline of content |
| | movie released in 2003 | |

If the instruction detail is the foregoing (4), the user operation processing section 8 transmits, to the service providing device 400, “billing information” including information of the fee of the contents and “content data request”. The billing information and content data request may have a data configuration as respectively shown in Tables 18 and 19 below, for example.

Table 18 shows one example of a data configuration of the billing information. As shown in Table 18, the billing information includes a “content ID”, “fee”, and “permitter ID”. The “fee” is the amount of money necessary for the user to pay upon viewing the contents identified by the content ID. In the example of Table 18, a value of “300 yen” is set as the fee. The “permitter ID” is a user ID of a permitter of an operator who is to view the content identified by the content ID.

Table 19 shows one example of a data configuration of the content data request. In the example of Table 19, a value of “REQUEST_CONT_DATA” is set as the content data request. Moreover, as shown in Table 19, the content data request includes a “permitter ID” and “operation object device ID”. By including the operation object device ID, it is possible to confirm in the service providing device 400 that the content data request is transmitted from an operation object device 200 used by an authorized user.

TABLE 18

| Data item | Data example | Definition |
|---|---|---|
| Content ID | 111122223333 | Unique ID of content in |
| | | the service |
| Fee | 300 yen | Fee of contents to be |
| | | viewed |
| Permitter ID | 1234567800 | User ID of permitter |

TABLE 19

| Data item | Data example | Definition |
|---|---|---|
| Content data | REQUEST_CONT_DATA | Request for |
| request | | transmission of content |
| | | data |
| Permitter ID | 1234567800 | User ID of permitter |
| Operation | 99123445678 | Unique ID of operation |
| object device | | object device over |
| ID | | service |

After the user operation processing section 8 transmits the billing information, the user operation processing section 8 receives a “billing notification” that is transmitted from the service providing device 400 as a response to the billing information. The billing notification may have a data configuration as shown in Table 20 below, for example. As shown in Table 20, the billing notification includes “content ID”, “fee”, “permitter ID”, and “billing result”.

The “content ID”, “fee”, and “permitter ID” are data respectively identical to the content ID, fee, and permitter ID included in the corresponding content data request. The “billing result” indicates whether a billing process by the service providing device 400 was successfully carried out or was unsuccessfully carried out. In the example of Table 20, the billing result is set as successful.

TABLE 20

| Data item | Data example | Definition |
|---|---|---|
| Content ID | 111122223333 | Unique ID of contents in |
| | | the service |
| Fee | 300 yen | Fee of content to be |
| | | viewed |
| Permitter ID | 1234567800 | User ID of permitter |
| Billing result | Successful | Successful/Unsuccessful |
| | | in billing |

The user operation processing section 8 refers to the billing result included in the received billing notification, and once it is recognized that the billing was successful, the user operation processing section 8 subsequently receives “content data” transmitted from the service providing device 400. Thereafter, the user operation processing section 8 displays on the display section 204 a screen similar to the screen illustrated in FIG. 10, based on the received content data.

If it is recognized that the billing was unsuccessful, this is dealt with as an error, and an error message is displayed on the display section 204.

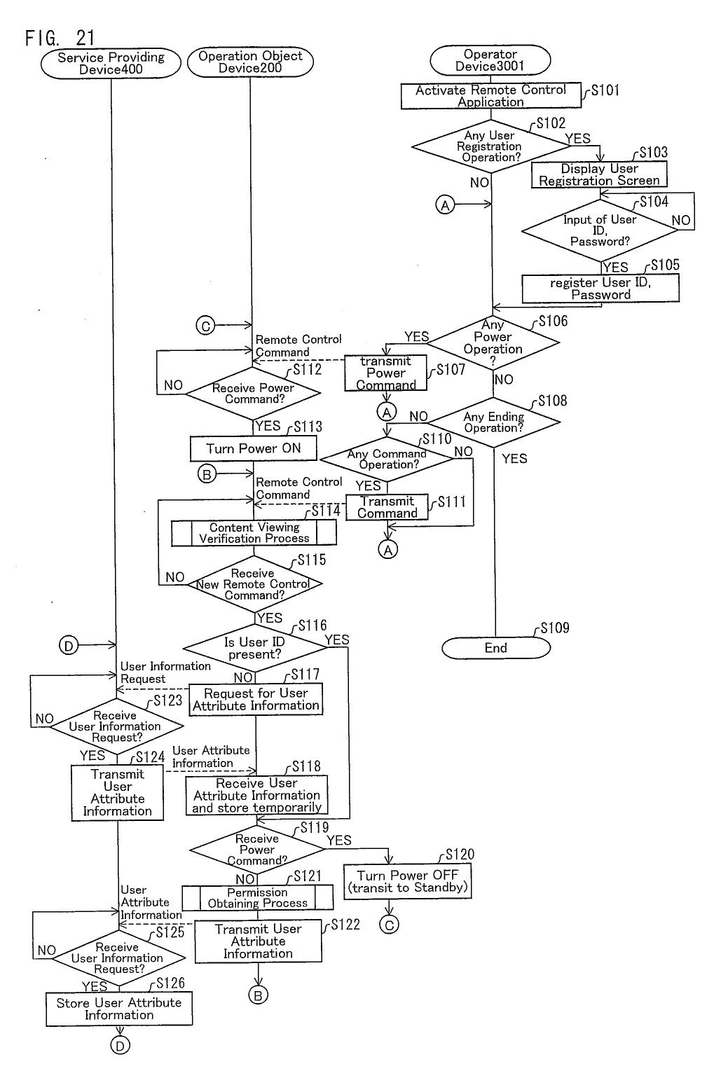

The content data may have a data configuration as shown in Table 21 below, for example. Table 21 shows one example of a data configuration of the content data. As shown in FIG. 21, the content data includes “data size” and “data body”. The “data size” is the number of bytes of the content data. The “data body” is the substance (binary) of the content data.

TABLE 21

| Data item | Data example | Definition |
|---|---|---|
| Data size | 4096000000 | Number of bytes in |
| | | content data |
| Data body | (omitted) | Substance (binary) of |
| | | content data |

The following description deals with the user attribute information transmitting section 9. The user attribute information transmitting section 9 transmits, to the service providing device 400, “user attribute information” of the user carrying out the command operation. The user attribute information may have a data configuration as shown in Table 9, for example. As shown in Table 9, the user attribute information is the entire data that is included in the record stored in the user attribute information storage section 11.

The following description explains why the user attribute information transmitting section 9 transmits the user attribute information to the service providing device 400. As described above, there are cases where an operator uses an operation object device 200 different from the regularly used operation object device 200 (e.g., an operation object device 200 at an outside location). In this case, as described above, a user attribute information confirming/obtaining section 5 of the different operation object device 200 obtains the user attribute information stored in the service providing device 400. Thus, in order that the user attribute information confirming/obtaining section 5 of the different operation object device 200 can obtain the user attribute information from the service providing device 400, the user attribute information transmitting section 9 of the regularly used operation object device 200 transmits the user attribute information to the service providing device 400 in advance.

(Specific Configuration of Remote Operation Device)

The following description more specifically describes the configuration of the remote operation device 300. As illustrated in FIG. 1, the remote operation device storage section 310 includes: a using user attribute information storage section 31 and a command storage section 32. Further, the remote operation device control section 306 includes a using user registration processing section 21, a command transmission processing section 22, a user registration processing section 23, and a permission request receiving processing section 24 (permission request receiving means, permission entering means, permission signal transmitting means). The user registration processing section 23 and permission request receiving processing section 24 that are illustrated inside the dotted frame operates only when the remote operation device 300 serves as the permitter device 3002.

The using user attribute information storage section 31 stores, in a readable state, a user ID and password of a user that uses the remote operation device 300. The user ID and password stored in the using user attribute information storage section 31 is used by the command transmission processing section 22 as data to include in the remote control command.

The command storage section 32 stores, in a readable state, a command name corresponding to a key operation carried out to the remote control application. The command name stored in the command storage section 32 is used by the command transmission processing section 22 as data to include in the remote control command.

The following description explains the using user registration processing section 21. The using user registration processing section 21 accepts input of a user ID and password from a user, and stores the accepted user ID and password in the using user attribute information storage section 31.

The using user registration processing section 21 accepts the input of the user ID and password from a user to identify the user that is using the remote operation device 300. Thus, in a case where the user that uses the remote operation system 100 is limited to one person, the mechanism of accepting the input of the user ID and password from the user can be omitted by storing the user ID and password of the user in the using user attribute information storage section 31 in advance.

The input of the user ID and password from the user is accepted via a screen described in FIG. 4. At this point, the user ID and password thus entered is only stored in the using user attribute information storage section 31, and is not transmitted to the operation object device 200.

The following description explains the command transmission processing section 22. The command transmission processing section 22 generates a remote control command in accordance with a key operation carried out to the remote control application by a user. As described above, the remote control command may have a data configuration as shown in Table 7, for example. Thereafter, the generated remote control command is transmitted to the operation object device 200 via the operating-side communication section 302.

The command transmission processing section 22 generates a remote control command based on (i) the user ID and password stored in the using user attribute information storage section 31 and (ii) the command name stored in the command storage section 32 which command name corresponds to the key operation in the remote control application.

The following description explains the user registration processing section 23. The user registration processing section 23 carries out processes that are carried out by the remote operation device 300, among the series of processes carried out when a permitter registers attribute information of a user (permitter and operator), which user is a user of the remote operation system 100.

More specifically, first, the user registration processing section 23 accepts input of attribute information of a user (permitter and operator) from a permitter, and generates “first registered user information” based on the accepted attribute information of the user. As described above, the first registered user information may have a data configuration as shown in Table 4, for example. Thereafter, the generated first registered user information is transmitted to the operation object device 200 via the operating-side communication section 302.

The input of user attribute information from a permitter is accepted via the screen described in FIGS. 17 and 18. Namely, the screen accepts the input of the name of the permitter, age of the permitter, address of the permitter, telephone number of contact information of the permitter, holder name of credit card of the permitter, credit card number of the permitter, expiry date of the credit card of the permitter, name of the operator, and age of the operator. The “permitter device address” and “permitter device telephone number” that are included in the first registered user information are stored in the permitter device 3002 in advance.

The user registration processing section 23, after transmitting the first registered user information to the operation object device 200, receives “user registration result information” transmitted from the operation object device 200 as a response to the first registered user information. Thereafter, the user registration processing section 23 displays on the display section 307 the permitter name, permitter ID, permitter password, operator name, operator-ID, and operator password (see FIG. 19), each of which are included in the received user registration result information.

The following description explains the permission request receiving processing section 24. The permission request receiving processing section 24 receives a permission request transmitted from the operation object device 200. The permission request receiving processing section 24 refers to the “operation detail” included in the received permission request, and checks whether the permission detail thus requested is a case-by-case permission or a prior permission. More specifically, if the operation detail is the “operation for viewing content”, the operation detail is determined as the case-by-case permission, and if the operation detail is the “operation for obtaining prior permission”, the operation detail is determined as the prior permission.

If the requested permission detail is the case-by-case permission, the permission request receiving processing section 24 further checks what detail the permission is requested for. More specifically, the permission request receiving processing section 24 refers to the “first permission request detail” and “second permission request detail” that are included in the received permission request.

As a result of referring to the first permission request detail and second permission request detail, for example if it is found that permission for “viewing content with a rating restriction” is requested as the first permission request detail, the permission request receiving processing section 24 displays on the display section 307 a screen in which the permitter can enter whether or not the permission is provided (see FIG. 11). Further, for example, if it is found that permission for “viewing pay content” is requested as the second permission request detail, the permission request receiving processing section 24 displays on the display section 307 a screen in which a permitter can enter whether or not to purchase the pay content (see FIG. 12).

Thereafter, the permission request receiving processing section 24 generates a permission result response (permission response or non-permission response) based on the result of input from the permitter, and returns the generated permission result response to the operation object device 200. As described above, the permission result response may have a data configuration as shown in Table 11, for example.

More specifically, for example, if the first permission request detail included in the permission request is “to view content with rating restriction”, and the permitter enters that no permission is provided to view the content having the rating restriction, a non-permission response that sets no value (has a NULL value) in the first permission detail of the permission result response is returned to the operation object device 200.

Moreover, for example, if the second permission request detail included in the permission request is “to view pay content” and the permitter enters that no permission is provided to purchase the pay content, a non-permission response that sets no value (has a NULL value) in the second permission detail of the permission result response is returned to the operation object device 200.

Further, for example, if the first permission request detail included in the permission request is “to view content having rating restriction” and the second permission request detail is “to view pay content”, and the permitter enters that (i) viewing of pay content that has the rating restriction is permitted and (ii) purchasing of the pay content is permitted, the permission request receiving processing section 24 returns a permission response to the operation object device 200, which permission response has the first permission detail and second permission detail of the permission result response set to permit the viewing and purchasing of pay content.

Moreover, for example, if the first permitting request detail included in the permission request is “to view content having rating restriction” and the second permission request detail is not set (has a NULL value) (in other words, in a case where the content is free of charge), and the permitter enters that viewing of the content having the rating restriction is permitted, a permission response in which just the first permission detail is set to permit is returned to the operation object device 200.

Next described is a case where the requested permission detail is the prior permission. In this case, the permission request receiving processing section 24 displays on the display section 307 a screen in which the “monetary limit”, “viewing time limit”, and “viewing time length” can be entered by a permitter (see FIG. 16).

The permission request receiving processing section 24 generates a permission response or non-permission response based on the result of input by the permitter, and returns the generated permission response or non-permission response to the operation object device 200.

More specifically, the permission request receiving processing section 24 returns a permission response including the values of: the monetary limit in the first permission detail, the viewing time limit in the second permission detail, and the viewing time length in the third permission detail, each of which are entered by the permitter. If there is no input by the permitter, no value is set (the value is NULL). If there are no entries by the permitter for any of the monetary limit, viewing time limit, and viewing time length, the non-permission response is returned to the operation object device 200.

The processes carried out by the permission request receiving processing section 24 are described later with reference to a flow chart.

(Specific Configuration of Service Providing Device)

The following description more specifically explains the configuration of the service providing device 400. As illustrated in FIG. 1, the service providing device storage section 407 includes a registered user information storage section 51, a user ID/password storage section 52, a user attribute information storage section 53, a content information storage section 54, and a content data storage section 55. Moreover, the service providing device control section 403 includes a user registration processing section 41, a user attribute information transmission processing section 42, a log-in processing section 43, billing processing section 44, a data transmission processing section 45, and a user attribute information receiving processing section 46.

The registered user information storage section 51 stores, in a readable state, second registered user information received by the user registration processing section 41. The registered user information storage section 51 may have a data configuration as shown in Table 22 below, for example. Table 22 shows one example of a data configuration of the registered user information storage section 51.

As shown in Table 22, the registered user information storage section 51 stores sets of “permitter name”, “permitter age”, “permitter address”, “permitter telephone number”, “permitter card holder name”, “permitter card number”, “permitter card expiry date”, “permitter device telephone number”, “operator name”, “operator age”, and “operation object device ID”. Each of these data is identical to the data included in the second registered user information shown in FIG. 5. The set of operator name and operator age is data that is repeated for the number of operators to which the permitter provides permission, however in the example of Table 22, just one is included.

TABLE 22

| Column name | Data example | Definition |
|---|---|---|
| Permitter name | Ichiro Yamada | Name of permitter |
| Permitter age | 41 years old | Age of permitter |
| Permitter | ΔΔ, ◯◯ City, Osaka | Address of permitter |
| address | Prefecture | |
| Permitter | 06-XXXX-XXXX | Contact telephone number |
| telephone | | of permitter |
| number | | |
| Permitter card | ICHIRO YAMADA | Credit card holder name of |
| holder name | | permitter |
| Permitter card | 1234567890123450 | Credit card number of |
| number | | permitter |
| Permitter card | October, 2013 | Expiry date of credit card |
| expiry date | | of permitter |
| Permitter device | 00:11:22:33:44:AA | Address for Bluetooth |
| address | | communication of |
| | | permitter device |
| Permitter device | 090-1234-5678 | Telephone number of |
| telephone | | permitter device |
| number | | |
| Operator name | Taro Yamada | Name of operator |
| Operator age | 12 years old | Age of operator |
| Operation object | 9912345678 | Unique ID of operation |
| device ID | | object device in the |
| | | service |

The user ID/password storage section 52 stores, in a readable state, sets of the user ID and password per user that are issued by the user registration processing section 41.

The user ID/password storage section 52 may have a data configuration as shown in Table 23 below, for example. As shown in Table 23, the user ID/password storage section 52 stores “permitter name”, “permitter ID”, “permitter password”, “operator name”, “operator ID”, and “operator password”. Each of the data is identical to the data included in the user registration result information shown in Table 6. The set of operator name, operator ID, and operator password is data that is repeated for the number of operators included therein, however the example in Table 23 includes just one operator.

TABLE 23

| Column name | Data example | Definitions |
|---|---|---|
| Permitter | Ichiro Yamada | Name of permitter |
| name | | |
| Permitter ID | 1234567800 | User ID of permitter |
| Permitter | 3fear9fd | Password of permitter |
| password | | |
| Operator name | Taro Yamada | Name of operator |
| Operator ID | 1234567890 | User ID of permitter |
| Operator | de5gr4sfq | Password of operator |
| password | | |

The content information storage section 54 stores, in a readable state, attribute information of content that is transmitted to the operation object device 300 by the data transmission processing section 45. The content information storage section 54 may have a data configuration identical to the foregoing Table 3, for example.

The content data storage section 55 stores, in a readable state, content that is transmitted to the operation object device 200 by the data transmission processing section 45.

The user attribute information storage section 53 stores, in a readable state, user information attribute information received by the user attribute information receiving processing section 46. The user attribute information storage section 53 may have a data configuration identical to the foregoing Table 1, for example.

Next described is the user registration processing section 41. The user registration processing section 41 carries out processes carried out in the service providing device 400 among the series of processes carried out when a permitter registers attribute information of a user (permitter and operator) of the remote operation system 100.

More specifically, the user registration processing section 41 receives the “second registered user information” transmitted from the operation object device 200, and stores, in the registered user information storage section 51, attribute information of the permitter and operator that are included in the received second registered user information.

Furthermore, the user registration processing section 41 issues a set of user ID and password for each of the permitter and the operator that are included in the received second registered user information, and further stores the issued sets of user ID and password in the user ID/password storage section 52 per user.

The user registration processing section 41 generates “user registration result information” based on the issued user ID and password as a response to the received second registered user information, and transmits the generated user registration result information to the operation object device 200. As described above, the user registration result information may have a data configuration as shown in Table 6, for example.

The following description explains the user attribute information transmission processing section 42. The user attribute information transmission processing section 42 receives a user information request transmitted from the operation object device 200. Thereafter, as a response to the user information request, information stored in the user attribute information storage section 53 is obtained and is transmitted to the operation object device 200 as “user attribute information”. As described above, the user attribute information may have a data configuration as shown in Table 9, for example.

Next described is the log-in processing section 43. The log-in processing section 43 receives a “log-in request” transmitted from the operation object device 200, and checks whether or not the set of user ID and password included in the log-in request is one of an authorized user.

More specifically, the log-in processing section 43 checks whether or not the set of the “user ID” and “password” included in the received log-in request is present in the sets of “user ID” and “password” stored in the user ID/password storage section 52. If the set is present, the log-in processing section 43 determines that the log-in request is from an authorized user, and generates a “log-in notification” in which a log-in result value is set as “successful”. On the other hand, if the set is absent, the log-in processing section 41 determines the log-in request as a request from an unauthorized user, and generates a “log-in notification” in which a log-in result value is set as “unsuccessful”. Thereafter, the log-in processing section 43 transmits the generated log-in notification to the operation object device 200. As described above, the log-in notification may have a data configuration as shown in Table 13, for example.

The following description explains the billing processing section 44. The billing processing section 44 receives “billing information” transmitted from the operation object device 200, so as to carry out a billing process by debiting an amount shown by the item “fee” included in the received billing information from an account of the credit card of the permitter identified by the “permitter ID” included in the received billing information. The billing process is carried out based on the “permitter card holder name”, “permitter card number”, and “permitter card expiry date”, each of which is stored in the registered user information storage section 51 as attribute information of the permitter identified by the “permitter ID”. A well known method is used for the billing process, so therefore explanation thereof is omitted here.

After the billing process is properly completed, the billing processing section 44 generates a “billing notification” in which a billing result value is set as “successful”. On the other hand, if the billing process is not properly completed, a “billing notification” in which a billing result value is set as “unsuccessful” is generated. Thereafter, the billing processing section 44 transmits the generated billing notification to the operation object device 200. As described above, the billing notification may have a data configuration as shown in Table 20, for example.

The following description explains the data transmission processing section 45. The data transmission processing section 45, after receiving the “contents list request” transmitted from the operation object device 200, obtains all sets of content ID and title that are stored in the content information storage section 54, and generates a “contents list” based on the obtained sets of content ID and title. Thereafter, the data transmission processing section 45 transmits the generated contents list to the operation object device 200. As described above, the contents list may have a data configuration as shown in Table 15, for example.

Moreover, the data transmission processing section 45, after receiving the “content information request” transmitted from the operation object device 200, obtains all the information stored in the content information storage section and transmits this as “content information” to the operation object device 200. As described above, the content information may have a data configuration as shown in Table 17, for example.

Further, the data transmission processing section 45, after receiving a “content data request” transmitted from the operation object device 200, obtains all of the content data stored in the content data storage section 55, and transmits this to the operation object device 200. As described above, the content data may have a data configuration as shown in Table 21, for example. If the requested content is charged for, the content data is transmitted to the operation object device 200 only after the billing process is properly completed by the billing processing section 44.

The following description explains the user attribute information receiving processing section 46. The user attribute information receiving processing section 46, after receiving the “user attribute information” transmitted from the operation object device 200, stores the data included in the received user attribute information in the user attribute information storage section 53. If the user attribute information storage section 53 already stores a record corresponding to the user, the record is updated by the data included in the received user attribute information.

Procedure of Processes in Remote Operation System 100

The following description explains a procedure of processes followed by the apparatuses in the remote operation system 100, when the VOD service is used by the operator. FIG. 21 is a flow chart illustrating a procedure of processes followed by the apparatuses in the remote operation system 100, when the VOD service is used by the operator. It is assumed in the description that the user registration process has already been completed by the permitter. In addition, the power of the operation object device 200 is initially turned OFF (is in standby).

First described is processes followed in the operator device 3001. First, the operator activates the remote control application on the operator device 3001, in order to use the VOD service (step S101).

After the remote control application is activated, the operator operates the “user registration” key on the remote control application (YES in step S102), whereby the using user registration processing section 21 displays a screen (see FIG. 4) on the display section 307 (step S103). The screen thus displayed allows accepting input of the user ID and password of the operator. Once the operation to register the user ID and password is accepted from the operator (YES in step S104), the using user registration processing section 21 stores the entered user ID and password in the using user attribute information storage section 31 (step S105).

If it is possible to limit an operator of the operator device 3001 to one person, steps S102 to S105 can be omitted by storing the user ID and password of the operator in the using user attribute information storage section 31 in advance.

Next, if the “power” key in the remote control application is pressed by the operator (YES in step S106), the command transmission processing section 22 transmits a power command to the operation object device 200 (step S107).

If the operator carries out operation to shut down the remote control application (YES in step S108), the operator device 3001 shuts down the remote control application without transmitting any remote commands to the operation object device 200 (step S109).

If the operator does not carry out the operation to shut down the remote control application (NO in step S108) but carries out a predetermined operation that causes transmission of a remote control command (YES in step S110), the command transmission processing section 22 transmits to the operation object device 200 a remote control command based on the operation (step S111).

The following description explains processes carried out in the operation object device 200. After the operation object device 200 receives the power command from the operator device 3001 (YES in step S112), the power management section 3 supplies electricity to each of sections provided in the operation object device 200 (step S113).

Thereafter, while the operation object device 200 standbys to receive a remote control command, a viewing condition verification section 4 carries out a content viewing verification process (step S114). The content viewing verification process is described later with reference to a detailed flow chart.

Following this, after the operation object device 200 newly receives a remote control command from the operator device 3001 (YES in step S115), the user attribute information confirming/obtaining section 5 first checks whether or not the user ID included in the received remote control command is stored in the user attribute information storage section 11 (step S116). If the user ID included in the received remote control command is not stored in the user attribute information storage section 11 (NO in step S116), the user attribute information confirming/obtaining section 5 transmits a user information request to the service providing device 400, to obtain attribute information of the user identified by the user ID included in the received remote control command (step S117). Thereafter, the user attribute information confirming/obtaining section 5 receives user attribute information from the service providing device 400, and stores this data included in the received user attribute information in the user attribute information storage section 11 (step S118).

If the user ID included in the received remote control command is stored in the user attribute information storage section 11 (YES in step S116), no user information request is transmitted to the service providing device 400.

Thereafter, the operation object device 200 checks whether or not the remote control command received in step S115 is a power command (step S119). If the command is the power command (YES in step S119), the power management section 3 stops the supply of electricity to the functions provided in the operation object device 200 (switches to standby state) (step S120).

On the other hand, if the command is not the power command (NO in step S119), a permission obtaining process is carried out for obtaining viewing permission from the permitter (step S121). The permission obtaining process is described later with reference to a detailed flow chart. Thereafter, the user attribute information transmission section 9 transmits user attribute information to the service providing device 400 (step S122).

Next described are processes carried out in the service providing device 400. After the user attribute information transmission processing section 42 receives a user information request from the operation object device 200 (YES in step S123), the user attribute information transmission processing section 42 obtains user attribute information from the user attribute information storage section 53, and transmits the obtained user attribute information to the operation object device 200 (step S124).

Moreover, the user attribute information receiving processing section 46, after receiving the user attribute information from the operation object device 200 (YES in step S125), stores the received user attribute information in the user attribute information storage section 53 (step S126).

(Procedure of Permission Obtaining Process)

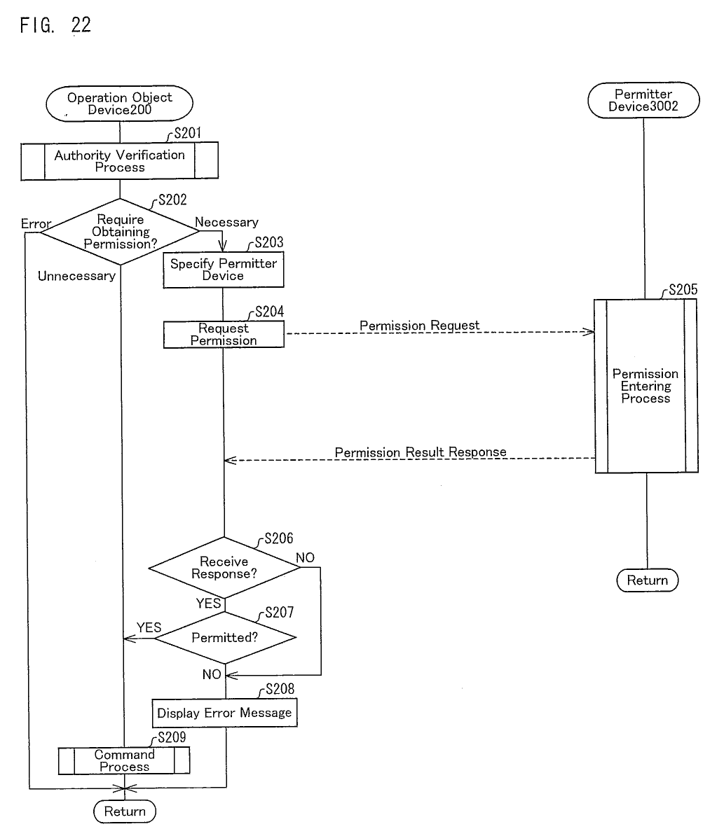

The following description deals with an outline of a procedure carried out in the permission obtaining process, with reference to FIG. 22.

First, the authority verification section 6 of the operation object device 200 carries out an authority verification process which determines whether or not the operator requires viewing permission from the permitter for operating an attempted operation (step S201). The authority verification process is described later with reference to a detailed flow chart.

As a result of the authority verification process, if the operation to be carried out by the operator requires viewing permission (“necessary” in step S202), the permission obtaining section 7 specifies its permitter device 3002 (step S203), and transmits a permission request to the permitter device 3002 (step S204).

The permitter enters into the permitter device 3002 whether or not to provide permission, in response to the permission request. Thereafter, as a result of the input, a permission result response is transmitted to the operation object device 200 (hereinafter referred to as permission input process) (step S205). The permission input process is described later with reference to a detailed flow chart.

The permission obtaining section 7, after receiving the permission result response from the permitter device 3002 (YES in step S206), analyzes a detail included in the permission result response. If the permission is provided (i.e., if the response is a permission response) (YES in step S207), command processing is subsequently carried out (step S209). The command processing is described later with reference to a detailed flow chart.

On the other hand, if no permission is provided (i.e., if the response is a non-permission response) (NO in step S207), the permission obtaining section 7 accepts the permission result response as an error, and displays an error message on the display section 204 (step S208). At this time, no command processing is carried out.

As a result of the authority verification process, if the operation attempted by the operator requires no viewing permission (“unnecessary” in step S202), the command processing is subsequently carried out without obtaining permission from the permitter (step S209).

Moreover, if the operation attempted by the operator is determined as an error in the authority verification process (“error” in step S202), no command processing is carried out.

(Procedure of Permission Input Process)

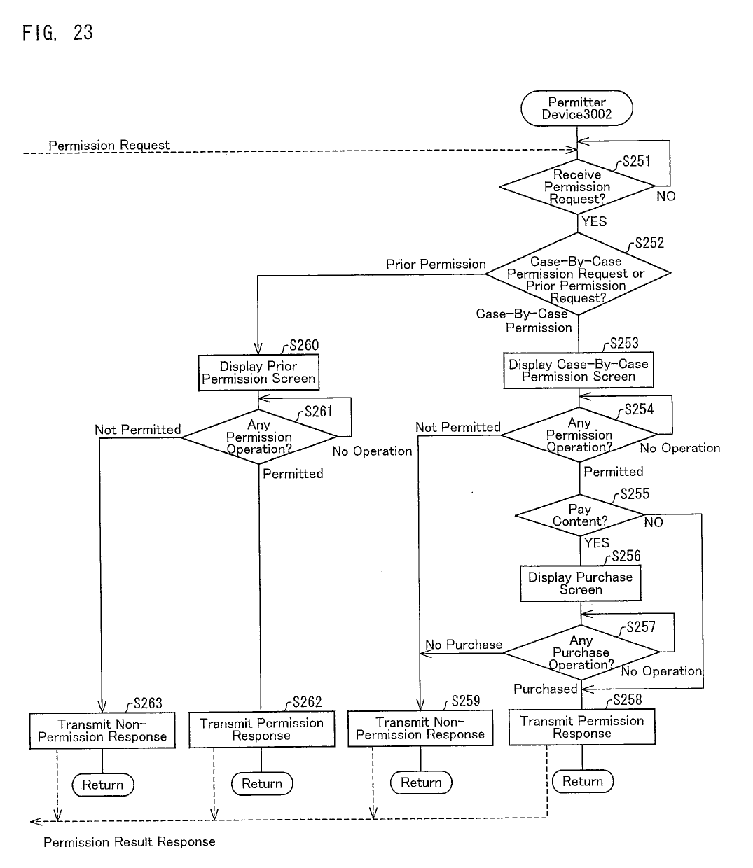

With reference to FIG. 23, the following description deals with a permission input process of the permitter device 3002. FIG. 23 is a flow chart showing a procedure of the permission input process.

When the permitter device 3002 receives the permission request from the operation object device 200 (step S251), the permission request receiving processing section 24 analyzes a detail of the received permission request signal, so as to check whether the requested permission detail is a case-by-case permission or prior permission (step S252).

If the requested permission detail is the case-by-case permission (“case-by-case permission” in step S252), a screen is displayed, which screen allows the permitter to enter whether or not to provide a case-by-case permission (see FIG. 11) (step S253). If the permitter enters to provide the case-by-case permission (“permit” in step S254), a further check is carried out as to whether or not the content that is provided with the case-by-case permission is pay content (step S255). If the content is pay content (YES in S255), the permission request receiving processing section 24 causes display of a screen which allows the permitter to enter whether or not to purchase the pay content (see FIG. 12) (step S256).

If the content is free of charge (NO in step S255) or if the permitter enters to purchase the pay content (“purchase” in step S257), the permission request receiving processing section 24 transmits a permission response to the apparatus from which the permission request was sent, which permission response informs that permission is provided (S258).

On the other hand, in a case where the permitter enters that no permission is provided (“not permitted”) or enters that the pay content is not purchased (“not purchased” in step S257), the permission request receiving processing section 24 transmits a non-permission response informing that no permission is provided to the apparatus from which the permission request was transmitted (S259).

If the requested permission detail is a prior permission (“prior permission” in step S252), a screen is displayed that allows the permitter to enter whether or not the prior permission is provided (see FIG. 16) (step S260).

If the permitter enters that the prior permission is provided (“permit” in step S261), the permission request receiving processing section 24 transmits a permission response informing that the permission is provided to the apparatus from which the permission request is transmitted (S262). On the other hand, if the permitter enters that no prior permission is provided (“non-permitted” in step S261), the permission request receiving processing section 24 transmits a non-permission response informing that no permission is provided to the apparatus from which the permission request is transmitted (S263).

(Procedure in Authority Verification Process)

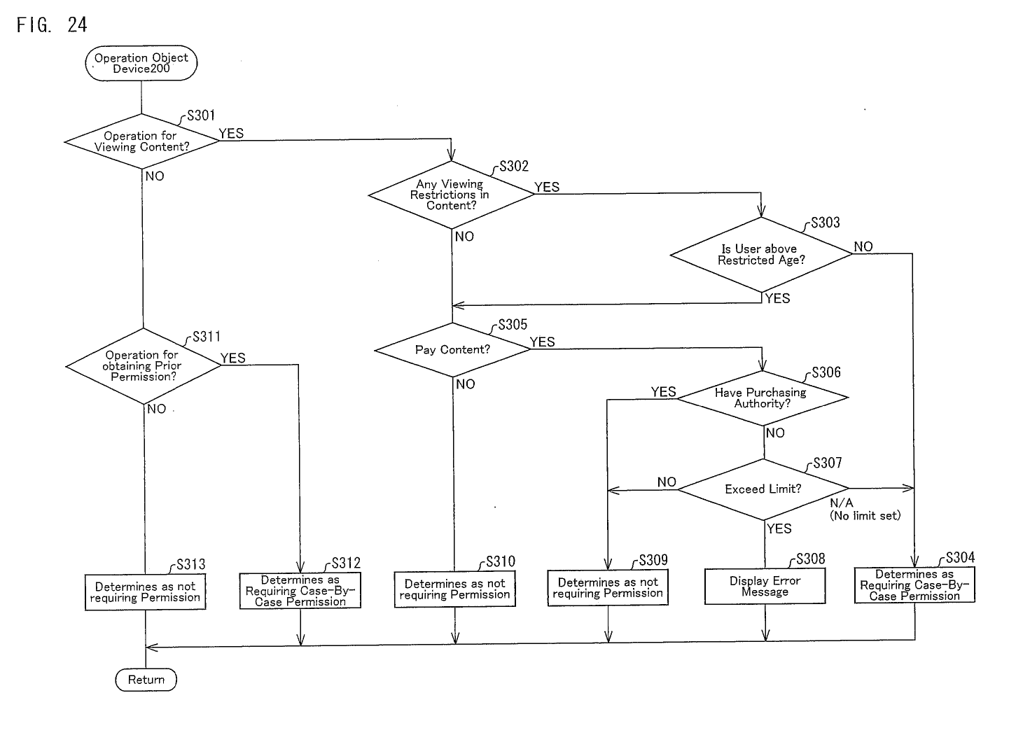

The following description explains an outline of a procedure in the authority verification process, with reference to FIG. 24. FIG. 24 is a flow chart showing a procedure in the authority verification process.

First, if the operation detail of the user is an “operation for viewing content” (YES in step S301), the authority verification section 6 checks whether or not the content has any viewing restrictions (step S302). More specifically, the authority verification section 6 retrieves the attribute information of the content to be viewed from the content information storage section 13, and obtains a “viewing restriction” that is set to the content. If a value is set in the “viewing restriction” (YES in step S302), the authority verification section 6 checks whether the age of the user satisfies the restriction (step S303). More specifically, a record having the user ID included in the remote command received from the operator device 3001 is retrieved from the user attribute information storage section 11, so as to obtain the “age” of the user identified by the user ID. Thereafter, the obtained age is compared with the obtained viewing restriction. If the age of the user does not satisfy the restriction (NO in step S303), the authority verification 6 determines that a case-by-case permission from a permitter is necessary (step S304).

On the other hand, if the age of the user satisfies the restriction (YES in step S303), the authority verification section 6 further checks whether or not the content to be viewed is charged for (step S305). If the content is free of charge (NO in step S305), the authority verification section 6 determines that no permission is required from the permitter (step S310).

On the other hand, if the content is charged for (YES in step S305), the authority verification section 6 further checks whether or not the user has authority to purchase the content (step S306). More specifically, a record having the user ID that is included in the remote control command received from the operator device 3001 is retrieved from the user attribute information storage section 11. From the record, a “purchasing authority” of a user identified by the user ID is obtained, so as to check its value. If the user has the purchasing authority (YES in step S306), the authority verification section 6 determines that no permission from the permitter is necessary (step S309). On the other hand, if the user has no purchasing authority (NO in step S306), the authority verification section 6 further checks whether or not a total purchase amount after addition of the pay content goes beyond a monetary limit that is set to the user (step S307).

More specifically, first, a record with the user ID included in the remote control command received from the operator device 3001 is retrieved from the user attribute information storage section 11, so as to obtain the “monetary limit”. Thereafter, a “fee” of the content attempted to be viewed is obtained from the content information storage section 13. If the obtained monetary limit is not set (NULL value) and a value is set for the obtained fee (other than NULL value) (“N/A” in step S307), the authority verification section 6 determines that a case-by-case permission is necessary (step S304).

On the other hand, if the obtained monetary limit is set, the authority verification section 6 checks whether or not a total purchase amount of pay content purchased by the user until a current point of time exceeds the obtained monetary limit. If the added amount exceeds the monetary limit (YES in step S307), the added amount goes beyond the range of the prior permission; thus, the authority verification section 6 determines this as an error and displays an error message that the monetary limit is exceeded on the display section 307 (step S308). On the other hand, if the added amount does not exceed the monetary limit value (NO in step S307), the added amount is within the prior permission range; thus, the authority verification section 6 determines that permission from the permitter is unnecessary (step S309).

If no monetary limit is set to the user (“N/A” in step S307), this means that no prior permission has been obtained by the user. Thus, the authority verification section 6 determines that permission from the permitter is necessary (step S304).

If the operation detail of the user is not an “operation for viewing content” (NO in step S301), but is an “operation for obtaining prior permission” (YES in step S311), the authority verification section 6 determines that permission is necessary from the permitter (step S312). On the other hand, if the operation detail of the user is not the “operation for obtaining prior permission” (NO in step 311), the authority verification section 6 determines that permission from the permitter is unnecessary (step S313).

(Procedure in Content Viewing Verification Process)

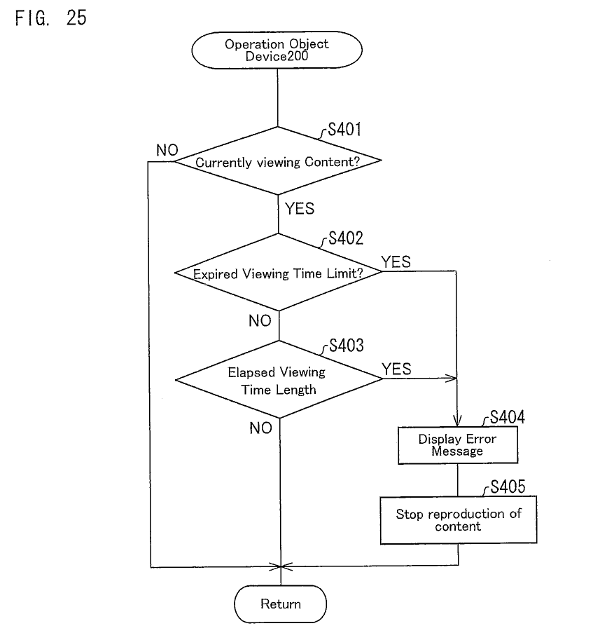

The following description explains an outline of a procedure in the content viewing verification process, with reference to FIG. 25. FIG. 25 is a flow chart showing a procedure in the content viewing verification process.

In a case where the user is viewing view-restricted content (YES in step S401), the viewing condition verification section 4 checks whether or not a “viewing time limit” provided by a prior permission from the permitter has elapsed in time (step S402). More specifically, the viewing condition verification section 4 obtains a “viewing time limit” stored in the user attribute information storage section 11. Thereafter, the viewing condition verification step 4 checks whether or not the current time indicated on the system clock shows a time later than the obtained viewing time limit. If the time indicated on the system clock shows a time later than the viewing time limit (YES in step S402), the viewing condition verification section 4 displays an error message on the display section 204 (step S404), and stops reproduction of the content (step S405).

If the viewing time limit has not yet elapsed (NO in step S402), the viewing condition verification section 4 further checks whether or not a “viewing time length” provided in the prior permission from the permitter has elapsed (step S402). More specifically, the viewing condition verification section 4 obtains the “viewing time length” stored in the user attribute information storage section 11, so as to verify whether or not a total length of content reproduction exceeds the obtained viewing time length. If the total length of content reproduction exceeds the viewing time length (YES in step S402), the viewing condition verification section 4 displays an error message on the display section 204 (step S404), and stops the reproduction of the content (step S405).

(Procedure of Command Processing)

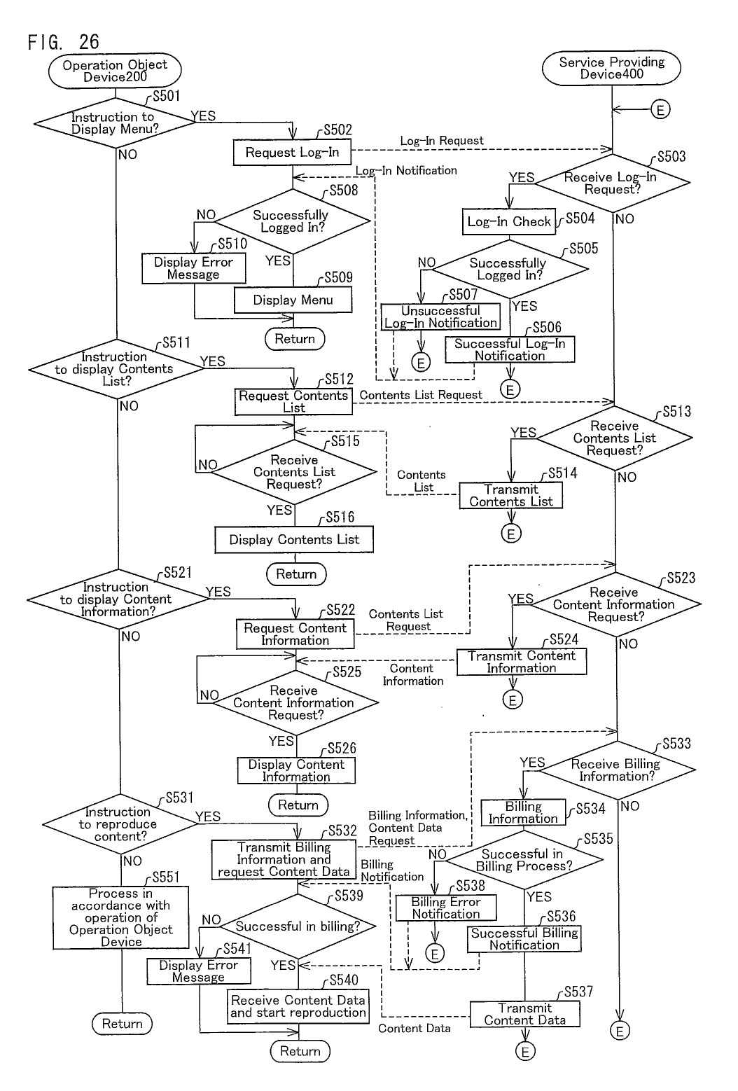

Next described is an outline of a procedure in command processing, with reference to FIG. 26. FIG. 26 is a flow chart showing a procedure in the command processing.

When the instruction detail from the user is to display a menu (YES in step S501), the user operation processing section 8 of the operation object device 200 transmits a “log-in request” to the service providing device 400 (step S502).

After the service providing device 400 receives the log-in request (YES in S503), the log-in processing section 43 confirms whether or not the user is an authorized user (step S504). Once the log-in process section 43 recognizes the user as an authorized user, the user is recognized as successfully logged in (YES in step S505), and the log-in processing section 43 transmits to the operation object device 200 a “log-in notification” which informs that the log-in has successfully completed (step S506). On the other hand, once the log-in processing section 43 recognizes that the user is not an authorized user, the log-in processing section 43 regards this as unsuccessful log-in (NO in step S505), and transmits a “log-in notification” to the operation object device which informs that the log-in was unsuccessful (step S507).

Thereafter, the user operation processing section 8 of the operation object device 200, after receiving the log-in notification from the service providing device 400, analyzes a detail of the log-in notification, and checks whether or not the user has successfully logged in (step S508). Once it is recognized that the user has successfully logged in (YES in step S508), a menu for using the VOD service is displayed on the display section 204 (see FIG. 6) (step S509). On the other hand, if it is recognized that the log-in was unsuccessful (NO in step S508), an error message is displayed on the display section 204 (step S510).

If the instruction detail from the user is not an instruction to display the menu (NO in step S501) but is an instruction to display a contents list (YES in step S511), the user operation processing section 8 transmits a “contents list request” to the service providing device 400 (step S512).

In the service providing device 400, upon receiving the contents list request (YES in step S513), the data transmission processing section 45 generates a “contents list” that lists contents that are currently provided from the service providing device 400, based on attribute information of content stored in the content information storage section 54. The generated contents list is then transmitted to the operation object device 200 (step S514).

Subsequently, the user operation processing section 8 of the operation object device 200 that receives the contents list from the service providing device 400 (YES in step S515) displays the received contents list on the display section 204 (see FIG. 7) (step S516).

If the instruction detail from the user is not an instruction to display the contents list (NO in step S511) but is an instruction to display content information (YES in step S521), the user operation processing section 8 transmits a “content information request” to the service providing device 400 (step S522).

In the service providing device 400, upon receiving the content information request (YES in step S523), the data transmission processing section 45 obtains attribute information of the content from the content information storage section 54, and transmits the obtained information as “content information” to the operation object device 200 (step S524).

The user operation processing section 8 of the operation object device 200, after receiving the content information (YES in step S525), displays the received content information on the display section 204 (see FIG. 8) (step S526).

If the instruction detail from the user is not an instruction to display the content information (NO in step S521) but is an instruction to reproduce content (viewing instruction) (YES in step S531), the user operation processing section 8 transmits “billing information” and “content data request” to the service providing device 400 (step S532).

In the service providing device 400, upon receiving the billing information and content data (YES in step S533), first, the billing processing section 44 carries out a generally-used billing process (step S534). Once the billing process is properly completed (YES in step S535), the billing process section 44 transmits a “billing notification” to the operation object device 200, so as to inform the operation object device 200 that the billing has successfully completed (step S536). Subsequently, the data transmission processing section 45 transmits the “content data” stored in the content data storage section 55 to the operation object device 200 (step S537).

On the other hand, if the billing process is not properly completed (NO in step S535), the billing processing section 44 transmits to the operation object device 200 a “billing notification” notifying that the billing was unsuccessful (step S538).

The user operation processing section 8 of the operation object device 200, which receives a billing notification from the service providing device 400 notifying that the billing was successful (YES in step S539), subsequently receives content data from the service providing device 400. This received content data is then displayed on the display section 204 (see FIG. 10) (step S540). On the other hand, if a billing notification indicating that the billing was unsuccessful is received from the service providing device 400 (NO in step S539), the user operation processing section 8 displays an error on the display section 204 (step S540).

Furthermore, if the instruction detail from the user is not an instruction to reproduce the content (NO in step S531), the instruction detail from the user is an operation instruction of a generally used function of the operation object device 200. In such case, a process in accordance with the instruction detail is carried out (step S551).

(Procedure in User Registration Process)

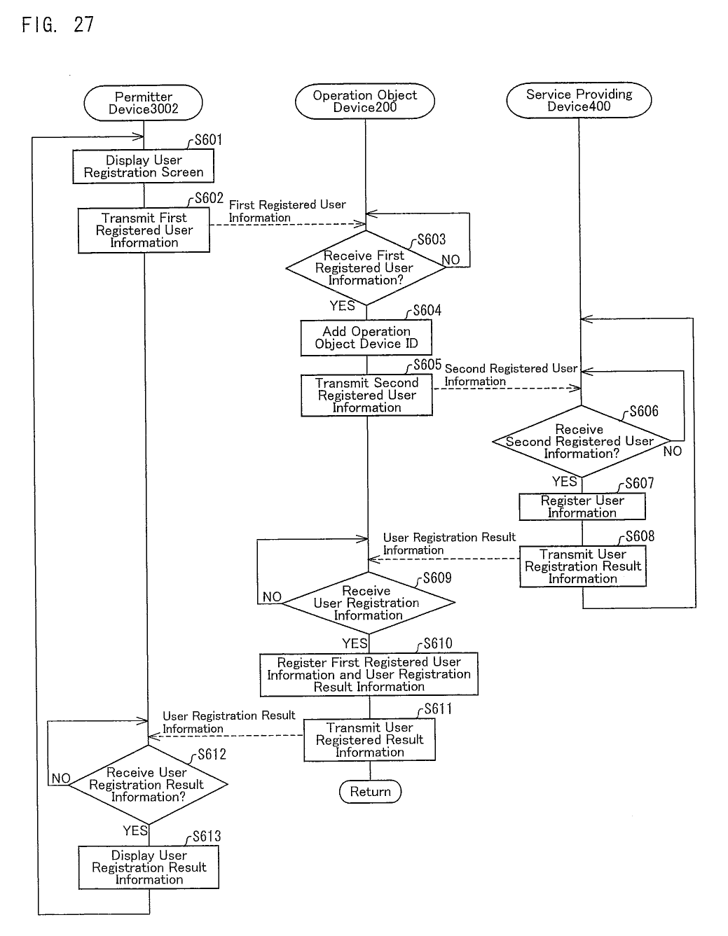

The following description explains a procedure in the user registration process, with reference to FIG. 27. FIG. 27 is a flow chart showing a procedure of the user registration process.

When the operator operates the “user registration” key on the remote control application after the remote control application is activated, the user registration processing section 23 of the permitter device 3002 causes a screen to be displayed, which screen accepts input of attribute information of the permitter and operator (see FIGS. 17 and 18) (step S601). Once registration of the attribute information of the permitter and operator by the permitter is accepted, the user registration processing section 23 transmits the “first registered user information” to the operation object device 200 (step S602).

When the operation object device 200 receives the first registered user information (YES in step S603), the user registration processing section 1 generates a “second registered user information” by adding the ID of the operation object device 200 to the received first registered user information (step S604), and transmits the generated second registered user information to the service providing device 400 (step S605).

In the service providing device 400, after receiving the second registered user information (YES in step S606), the user registration processing section 41 stores, in the registered user information storage section 51, attribute information of the permitter and operator that is included in the received second registered user information. Also, the user registration processing section 41 issues a set of user ID and password per permitter and operator, and stores the set of issued user ID and password in the user ID/password storage section 52 (step S607).

Thereafter, the user registration processing section 41 generates “user registration result information” based on the issued user ID and password, and transmits the generated user registration result information to the operation object device 200 (step S608).

In the operation object device 200, after receiving the user registration result information (YES in step S609), the user registration processing section 1 generates a record in the user attribute information storage section 11 based on information included in the first registered user information and received user registration result information, so as to store the registered user attribute information (step S610).

Thereafter, the user registration processing section 1 transfers the received user registration result information to the permitter device 3002 (step S611).

The user registration processing section 23 of the permitter device 3002, after receiving the user registration result information (YES in step S612), causes display of the “permitter name”, “permitter ID”, “permitter password”, “operator name”, “operator ID”, and “operator password”, each of which is included in the received user registration result information on the display section 307 (see FIG. 19) (step S613).

As described above, in the present embodiment, when an operator that has not received prior permission from a permitter attempts to view view-restricted content by using the operator device 3001, the operation object device 200 transmits to the permitter device 3002 a permission request for a case-by-case permission. After the permitter device 3002 receives the permission request, the permitter enters into the permitter device 3002 whether or not the case-by-case permission is provided. If the permitter enters into the permitter device 3002 that the case-by-case permission is provided, the permitter device 3002 transmits to the operation object device 200 a response informing that viewing permission is provided. The operation object device 200, upon receiving the response informing that permission is provided, reproduces the view-restricted content that the operator attempted to view.

Similarly, in the present embodiment, if an operator carries out an operation to obtain prior permission by using the operator device 3001, the operation object device 200 transmits to the permitter device 3002 a permission request for prior permission. Once the permitter device 3002 receives the permission request, the permitter enters into the permitter device 3002 whether or not the prior permission is provided. If the permitter enters into the permitter device 3002 that the prior permission is provided, the permitter device 3002 transmits a response to the operation object device 200 informing that the prior permission is provided. After the operation object device 200 receives the response informing that the prior permission is provided, the view-restricted content becomes available for the operator to view within a range for which prior permission is provided.

As described above, the view-restricted content becomes available to the operator, by having the operator obtain a case-by-case permission or prior permission from the permitter. In order to obtain the permission, the operator just needs to operate the operation object device 200 by using the operator device 3001 used by the operator. Moreover, when a permitter receives such a permission request, the permitter only requires entering whether or not the permission is provided, into the permitter device 3002 used by the permitter; there is no need to have the permitter directly operate the operation object device 200 by themselves.

Furthermore, the operation object device 200 and permitter device 3002 directly exchange the requests for the case-by-case permission and prior permission and responses thereto. Thus, even if at least one of the operator device 3001 and permitter device 3002 includes no telephone/web communication section 303 (i.e. cannot communicate with the communication network 500 serving as a mobile telephone network), the operator can still obtain the case-by-case permission and prior permission from the permitter.

### Second Embodiment

First Embodiment explains a procedure for obtaining viewing permission from a permitter in which (1) an operation object device 200 transmits a permission request directly to the permitter device 3002 and (2) as a response to the permission request, the permitter device 3002 transmits a permission result response directly to the operation object device 200. However, procedures that are carried out to obtain the viewing permission from the permitter are not limited to this example.

The present embodiment describes a procedure in which (1) an operation object device 200 transmits a permission request to a permitter device 3002 via an operator device 3001, and (2) as a response to the permission request, the permitter device 3002 transmits a permission result response to the operation object device 200 via the operator device 3001.

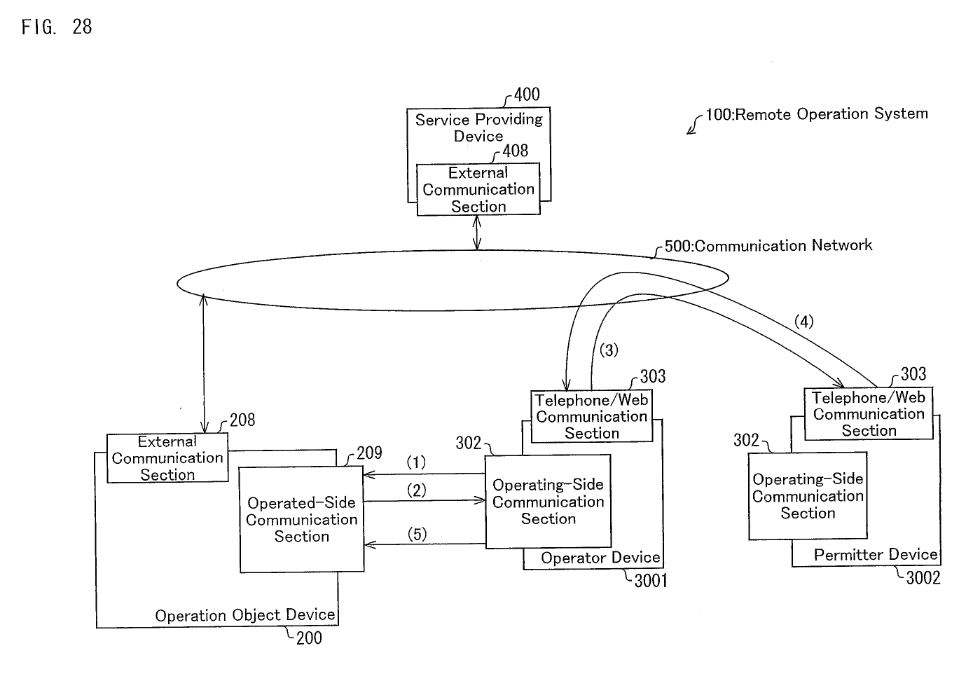

One embodiment of the present invention is described below with reference to FIGS. 28 through 30. For convenience in explanation, members that have functions identical to the members illustrated in First Embodiment are provided with identical numerical signs, and their explanations are omitted in this embodiment. Moreover, explanations for processes that are identical to those described in First Embodiment are also omitted here.

Outline of Procedure for Obtaining Viewing Permission

The following description explains, with reference to FIG. 28, an outline of a procedure for obtaining viewing permission from a permitter, in accordance with the present embodiment. FIG. 28 is a diagram schematically illustrating an outline of a procedure for obtaining viewing permission from a permitter in a remote operation system 100, in accordance with the present embodiment.

(Procedure for Obtaining Case-by-Case Permission)

First described is a procedure in which an operator obtains a case-by-case permission from a permitter. When an operator attempts to view view-restricted content by operating the operation object device 200 via the operator device 3001, a predetermined remote control command is transmitted from the operating-side communication section 302 of the operator device 3001 to the operated-side communication section 209 of the operation object device 200 (process (1) in FIG. 28). The operation object device 200 that receives the remote control command confirms whether or not the operator can freely view the view-restricted content. If it is determined that the operator cannot freely view the view-restricted content, the operation object device 200 first requests for a case-by-case permission to the operating-side communication section 302 of the operator device 3001 from the operated-side communication section 209 (process (2) in FIG. 28). The operator device 3001 that receives the request for the case-by-case permission specifies its permitter device 3002, and transmits a request for the case-by-case permission to a telephone/web communication section 303 of the specified permitter device 3002 from a telephone/web communication section 303 of the operator device 3001 (process (3) in FIG. 28).

After the permitter enters into the permitter device 3002 whether or not to permit viewing of the content in response to the request, the permitter device 3002 transmits a response to the telephone/web communication section 303 of the operator device 3001 from the telephone/web communication section 303 of the permitter device 3002 (process (4) in FIG. 28). The operator device 3001, upon receiving the response, transfers the response from the operating-side communication section 302 to the operated-side communication section 209 of the operation object device 200 (process (5) in FIG. 28). As a result of the above, as long as the permitter enters to provide the case-by-case permission, the operator is able to view the view-restricted content that the operator attempts to view.

According to the configuration, when the operator attempts to view view-restricted content via the operator device 3001, a request for a case-by-case permission is first transmitted from the operation object device 200 to the operator device 3001. Thereafter, a request for the case-by-case permission is transmitted from the operator device 3001 to the permitter device 3002. If the permitter enters into the permitter device 3002 that the case-by-case permission is provided, a response is transmitted to the operator device 3001 from the permitter device 3002 informing that the case-by-case permission is provided. Then, the response that the case-by-case permission is provided is transmitted from the operator device 3001 to the operation object device 200. As a result, the operator is able to view the view-restricted content. If the permitter enters that no case-by-case permission is provided, the permitter device 3002 transmits a response to the operation object device 200 via the operator device 3001, informing that the case-by-case permission is not provided. In such a case, the operator cannot view the view-restricted content.

(Procedure for Obtaining Prior Permission)

The following description explains a procedure in which an operator obtains prior permission from a permitter. The procedure to obtain prior permission is substantially the same as the procedure for obtaining the case-by-case permission.

First, when an operator carries out an operation in the operator device 3001 to obtain prior permission, a predetermined remote control command is transmitted to the operated-side communication section 209 of the operation object device 200 from the operating-side communication section 302 of the operator device 3001 (process (1) in FIG. 28). Then, the operation object device 200 that receives the remote control command requests for prior permission to the operating-side communication section 302 of the operator device 3001, from the operated-side communication section 209 (process (2) in FIG. 28). Thereafter, the operator device 3001 that receives the request for the prior permission specifies its permitter device 3002, and transmits the request for prior permission to the telephone/web communication section 303 of the specified permitter device 3002, from the telephone/web communication section 303 of the operator device 3001 (process (3) in FIG. 28).

After the permitter enters into the permitter device 3002 whether or not prior permission is provided in response to the request, the permitter device 3002 transmits a response to the telephone/web communication section 303 of the operator device 3001 from the telephone/web communication section 303 of the permitter device 3002 (process (4) in FIG. 28). The operator device 3001, upon receiving the response, transfers the response from the operating-side communication section 302 to the operated-side communication section 209 of the operation object device 200 (process (5) in FIG. 28). As a result of the above, as long as the permitter enters that prior permission is provided, the operator is able to view the view-restricted content within the permitted range.

According to the configuration, when an operator carries out an operation for obtaining prior permission via the operator device 3001, a request to obtain prior permission is transmitted to the permitter device 3002 from the operation object device 200. If the permitter enters into the permitter device 3002 that the prior permission is provided, the permitter device 3002 transmits to the operator device 3001 a response informing that prior permission is provided. Thereafter, the response informing that prior permission is provided is transmitted from the operator device 3001 to the operation object device 200. This thus allows the operator to view the view-restricted content within a range of the prior permission. If the permitter enters that no prior permission is provided, a response informing that no prior permission is provided is transmitted to the operation object device 200 from the permitter device 3002 via the operator device 3001. In such a case, the operator cannot obtain the prior permission.

Furthermore, according to the configuration, in order to obtain the case-by-case permission and prior permission from the permitter, the operator just needs to operate the operation object device 200 via the operator device 3001 used by the operator. Moreover, the permitter just requires entering whether or not to provide permission, into the permitter device 3002 in response to the permission request; there is no need for the permitter to directly operate the operation object device 200.

Moreover, according to the configuration, communication between the operator device 3001 and the permitter device 3002 is assumed to be carried out via the communication network 500 serving as a mobile telephone network. Thus, the requests for obtaining the case-by-case permission and prior permission and any responses thereto are communicated via a mobile telephone network. Hence, even in a case where the operator and the permitter are at locations far away from each other (for example, the operator is at home and the permitter is at an outside location), the operator can still obtain the case-by-case permission and prior permission from the permitter.

Specific Configuration of Each Apparatus

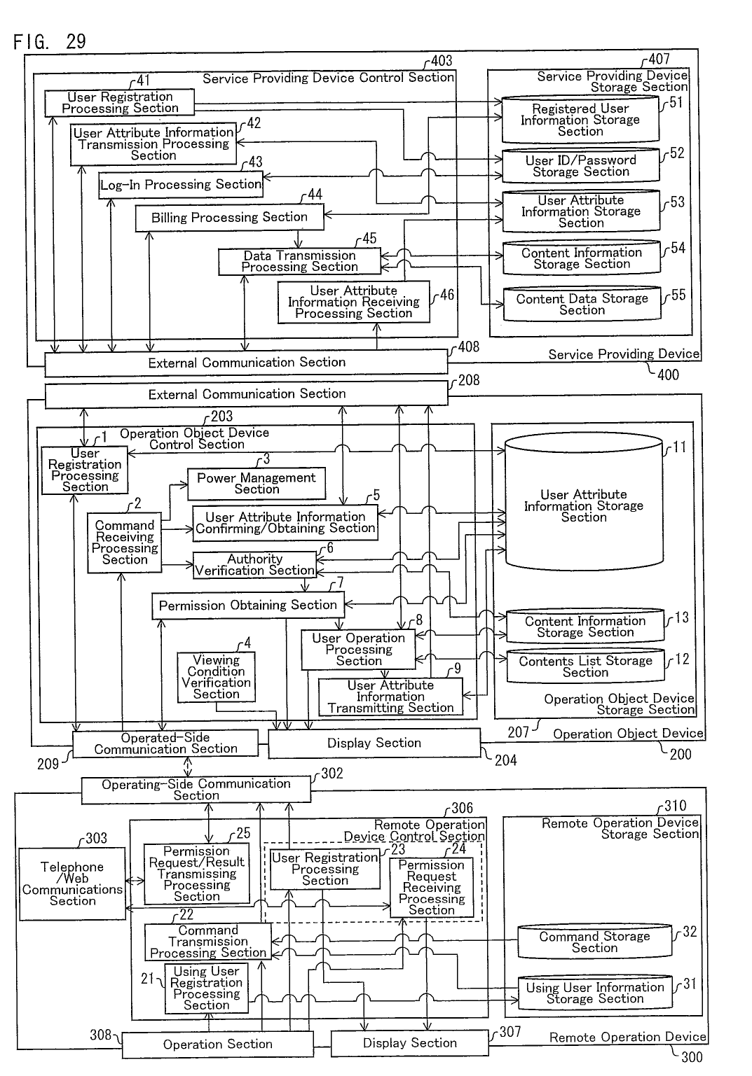

The following description more specifically explains the configuration of the operation object device 200 and the remote operation device 300 according to the present embodiment, with reference to FIG. 29. FIG. 29 is a block diagram illustrating a configuration of essential parts of the operation object device 200, the remote operation device 300, and the service providing device 400, each in accordance with the present embodiment. The service providing device 400 in accordance with the present embodiment has a configuration identical to the service providing device 400 of First Embodiment, and therefore the explanation thereof is omitted here.

(Specific Configuration of Operation Object Device)

The first description more specifically explains the configuration of the operation object device 200 of the present embodiment. As illustrated in FIG. 29, the operation object device 200 of the present embodiment includes members similar to the operation object device 200 of First Embodiment, however the permission obtaining section 7 of the present embodiment carries out a different process to the permission obtaining section 7 of First Embodiment, as described below.

If the authority verification section 6 determines that it is necessary to obtain a case-by-case permission or prior permission from the permitter, the permission obtaining section 7 of the present embodiment transmits a “permission request” to the operator device 3001 from which the remote control command is transmitted, via the operated-side communication section 209. The permission request may have a data configuration as shown in Table 10 for example, as similar to First Embodiment.

The permission obtaining section 7 of the present embodiment, after transmitting the permission request to the operator device 3001, receives a “permission result response” transmitted from the operator device 3001 as a response to the “permission request”, via the operated-side communication section 209. The permission result response may have a data configuration as shown in Table 11 for example, as similar to First Embodiment.

The process in the permission obtaining section 7 of the present embodiment after receiving the permission result response is identical to the process in the permission obtaining section 7 of First Embodiment; therefore, the description thereof is omitted in the present embodiment.

Moreover, the procedure of the processes carried out by the permission obtaining section 7 of the present embodiment (hereinafter referred to as permission obtaining process) are described later with reference to a flow chart.

(Specific Configuration of Remote Operation Device)

The following description more specifically describes the configuration of the remote operation device 300 in accordance with the present embodiment. As illustrated in FIG. 29, the remote operation device 300 of the present embodiment includes members substantially the same as the remote operation device 300 of First Embodiment, however the remote operation device control section 306 of the present embodiment further includes a permission request/result transfer processing section 25 (transfer processing means), as described below. Furthermore, the permission request receiving processing section 24 of the present embodiment carries out a process different from the permission request receiving processing section 24 of First Embodiment, as described below.

The following description explains the permission request/result transfer processing section 25. The permission request/result transfer processing section 25 operates in the remote operation device 300 that serves as the operator device 3001. The permission request/result transfer processing section 25 transmits a permission request to the permitter device 3002, which request is received from the operation object device 200 via the operating-side communication section 302. More specifically, once a permission request is received, a permitter device 3002 used by the permitter is specified. In order to do so, the permission request/result transfer processing section 25 obtains a “permitter device telephone number” in the “permitter user information” that is included in the received permission request. Thereafter, the permission request/result transfer processing section 25 transmits the received permission request to a permitter device 3002 of the obtained permitter device telephone number, via the telephone/web communication section 303 of the operator device 3001.

The permission request/result transfer processing section 25, after transmitting the permission request to the permitter device 3002, receives, via the telephone/web communication section 303, a permission result response transmitted from the permitter device 3002 as a response to the permission request. Thereafter, the permission request/result transfer processing section 25 transmits the received permission result response to the operation object device 200 via the operating-side communication section 302.

If the permission request/result transfer processing section 25 does not receive a permission result response from the permitter device 3002 in a predetermined time (for example 3 minutes), the permission request/result transfer processing section 25 generates a non-permission response, and transmits this generated non-permission response to the operation object device 200 via the operating-side communication section 302.

The non-permission response may be generated as follows: (A) if the operation detail of the permission request is “operation for viewing content”, and a detail for requesting permission is set in the first permission request detail, a permission result response in which a first permission detail is set with no value is generated; (B) if the operation detail of the permission request is “operation for viewing content” and a detail for requesting permission is set in the second permission request detail, a permission result response in which a second permission detail is set with no value is generated; and (C) if the operation detail of the permission request is “operation for obtaining prior permission”, a permission result response in which no value is set in any of the first permission detail, second permission detail, and third permission detail is generated.

Next described is the permission request receiving processing section 24 of the present embodiment. The permission request receiving processing section 24 of the permitter device 3002 receives the permission request transmitted from the operator device 3001, via the telephone/web communication section 303 of the permitter device 3002. Moreover, the permission request receiving processing section 24 of the permitter device 3002 returns a permission result response to the operator device 3001, via the telephone/web communication section 303 of the permitter device 3002. The processes carried out immediately after receiving the permission request until immediately before transmitting the permission result response is identical to those carried out at that time in the permission request receiving processing section 24 of First Embodiment, so therefore explanation thereof is omitted in the present embodiment.

Procedure in Remote Operation System 100

The procedure in the remote operation system 100 of the present embodiment is substantially identical to the procedure in the remote operation system 100 of First Embodiment, however the procedure in the permission obtaining process is different therefrom in the present embodiment, as described below. Any other procedure is identical to that described in First Embodiment, and therefore explanation thereof is omitted in the present embodiment.

(Procedure of Permission Obtaining Process)

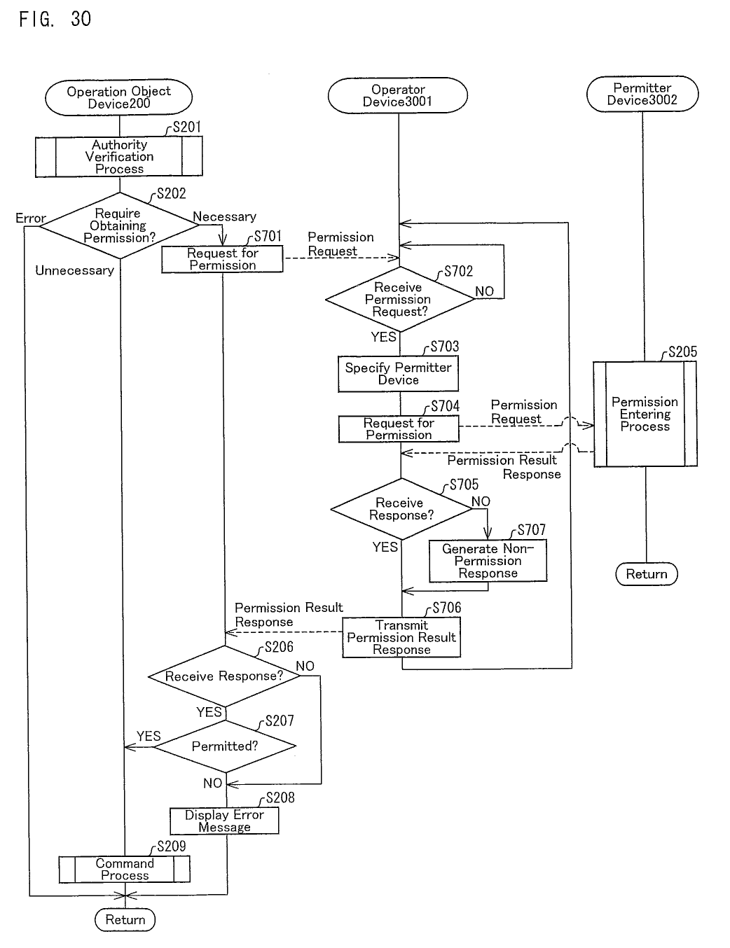

With reference to FIG. 30, the following description explains an outline of a procedure in the permission obtaining process of the present embodiment. FIG. 30 shows a flow chart of the permission obtaining process in accordance with the present embodiment. Explanations of processes that are identical to the procedure in the permission obtaining process of First Embodiment are omitted.

If the operation attempted by the operator requires obtaining of viewing permission (“necessary” in step S202), the permission obtaining section 7 of the present embodiment transmits a permission request to the operator device 3001 (step S701).

In the operator device 3001, upon receiving the permission request (YES in step S702), the permission request/result transfer processing section 25 specifies its permitter device 3002 (step S703) and transmits the received permission request to the permitter device 3002 (step S704).

The permitter device 3002, in response to the permission request, transmits a permission result response to the operator device 3001, as a result of the permission input process (step S705).

The permission request/result transfer processing section 25 of the operator device 3001, upon receiving the permission result response from the permitter device 3002 (YES in step S705), transmits the received permission result response to the operation object device 200 (step S706).

If the permission request/result transfer processing section 25 of the operator device 3001 does not receive a permission result response from the permitter device 3002 in a predetermined time (for example, 3 minutes) (NO in step S705), the permission request/result transfer processing section 25 generates a non-permission response (step S707) and transmits the generated non-permission response to the operation object device 200 (step S706).

Thereafter, the operation object device 200 receives a permission result response from the operator device 3001 (YES in step S206).

As described above, in the present embodiment, if an operator that is not provided with prior permission from a permitter attempts to view view-restricted content via the operator device 3001, the operation object device 200 first transmits to the operator device 3001 a permission request to request for a case-by-case permission. The operator device 3001 that receives the permission request then transmits the permission request to the permitter device 3002. After the permitter device 3002 receives the permission request, the permitter enters into the permitter device 3002 whether or not to provide the case-by-case permission. If the permitter enters into the permitter device 3002 that the case-by-case permission is provided, the permitter device 3002 transmits to the operator device 3001 a response informing that the viewing permission is provided. The operator device 3001 that receives the response transfers the response to the operation object device 200. The operation object device 200, after receiving the response, reproduces the view-restricted content that the operator attempts to view.

Similarly, in the present embodiment, if the operator carries out an operation for obtaining prior permission via the operator device 3001, the operation object device 200 first transmits a permission request for prior permission to the operator device 3001. The operator device 3001 that receives the permission request then transmits the permission request to the permitter device 3002. After the permitter device 3002 receives the permission request, the permitter enters into the permitter device 3002 whether or not the prior permission is provided. If the permitter enters into the permitter device 3002 that the prior permission is provided, the permitter device 3002 transmits to the operator device 3001 a response informing that the prior permission is provided. The operator device 3001 that receives the response transfers the received response to the operation object device 200. Once the operation object device 200 receives the response, the operator is able to view the view-restricted content within the permitted range.

As described above, in the present embodiment, an operator can view view-restricted content by obtaining case-by-case permission from the permitter. In this case, the operator just requires operating the operation object device 200 via the operator device 3001 used by the operator. Moreover, when a permission request is received, the permitter just needs to enter into the permitter device 3002 used by the permitter whether or not permission is provided; there is no need to have the permitter directly operate the operation object device 200. Furthermore, communication between the operator device 3001 and the permitter device 3002 is assumed to be carried out via a mobile telephone network. Thus, even in a case where the operator and the permitter are located far away (for example, the operator is at home and the permitter is at an outside location), the operator can still obtain the case-by-case permission from the permitter.

### Third Embodiment

Second Embodiment describes a procedure for obtaining viewing permission from a permitter in which: (1) the operation object device 200 transmits a permission request to the permitter device 3002 via the operator device 3001, and (2) as a response to the permission request, the permitter device 3002 transmits a permission result response to the operation object device 200 via the operator device 3001. However, the procedure for obtaining viewing permission from a permitter is not limited to this procedure.

The present embodiment describes a mode in which (1) a service providing device 400 transmits a permission request to the permitter device 3002, and (2) as a response to the permission request, the permitter device 3002 transmits a permission result response to the service providing device 400.

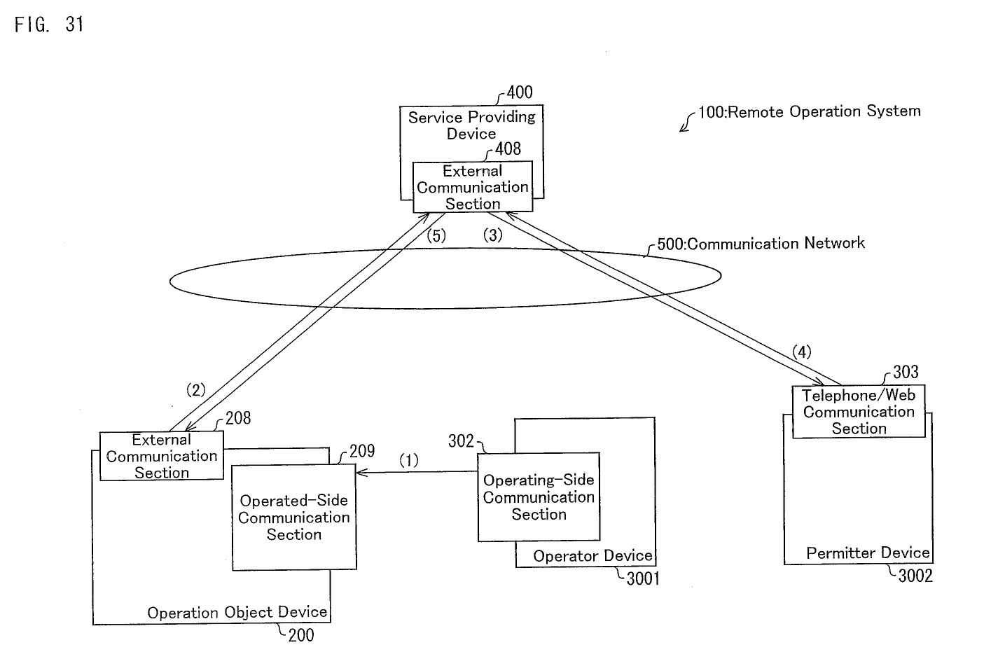

One embodiment of the present invention is described below with reference to FIGS. 31 to 33. For convenience in explanation, members that have functions identical to members shown in First and Second Embodiment are provided with identical reference signs, and their explanations are omitted. Further, processes identical to those explained in First and Second Embodiments are also omitted in explanation.

Outline of Procedure for Obtaining Viewing Permission

With reference to FIG. 31, the following description deals with an outline of a procedure in accordance with the present embodiment for obtaining viewing permission from a permitter. FIG. 31 is a diagram schematically illustrating a procedure in which an operator obtains viewing permission from a permitter, in a remote operation system 100 in accordance with the present embodiment.

(Procedure for Obtaining Case-by-Case Permission)

First described is a procedure in which an operator obtains case-by-case permission from a permitter. When an operator attempts to view view-restricted content by operating the operation object device 200 via the operator device 3001, a predetermined remote control command is transmitted from an operating-side communication section 302 of the operator device 3001 to an operated-side communication section 209 of the operation object device 200 (process (1) in FIG. 31). The operation object device 200 that receives the remote control command confirms whether or not the operator can freely view the view-restricted content. If it is determined that the operator cannot freely view the view-restricted content, the operation object device 200 first makes a request for a case-by-case permission from its external communication section 208 to an external communication section 408 of the service providing device 400 (process (2) in FIG. 31). The service providing device 400 that receives the request for the case-by-case permission specifies its permitter device 3002, and transmits a request for the case-by-case permission from the external communication section 408 of the service providing device 400 to a telephone/web communication section 303 of the specified permitter device 3002 (process (3) in FIG. 31).

After a permitter enters into the permitter device 3002 whether or not to permit viewing of the content in response to the request, the permitter device 3002 transmits a response to the external communication section 408 of the service providing device 400 from the telephone/web communication section 303 of the permitter device 3002 (process (4) in FIG. 31). The service providing device 400, after receiving the response, transfers the response from the external communication section 408 to the external communication section 208 of the operation object device 200 (procedures (5) in FIG. 31). As a result, as long as the permitter enters to provide the case-by-case permission, the operator is able to view the view-restricted content that the operator attempts to view.

According to the configuration, when an operator attempts to view view-restricted content via the operator device 3001, a request for a case-by-case permission is transmitted to the service providing device 400 from the operation object device 200. Thereafter, the request for the case-by-case permission is transmitted from the service providing device 400 to the permitter device 3002. After the permitter enters into the permitter device 3002 that the case-by-case permission is provided, a response informing that the permission is provided is transmitted to the service providing device 400 from the permitter device 3002. Thereafter, the response informing that permission is provided is transmitted from the service providing device 400 to the operation object device 200. Thus, the operator is able to view the view-restricted content. If the permitter enters that no case-by-case permission is provided, a response informing that no case-by-case permission is provided is transmitted to the operation object device 200 from the permitter device 3002, via the service providing device 400. This results in the operator not being able to view the view-restricted content.

(Procedure for Obtaining Prior Permission)

The following description explains a procedure in which an operator obtains prior permission from a permitter. The procedure for obtaining prior permission is substantially identical to the foregoing procedure for obtaining a case-by-case permission.

When an operator carries out an operation for obtaining prior permission in an operator device 3001, a predetermined remote control command is transmitted from the operating-side communication section 302 of the operator device 3001 to the operated-side communication section 209 of the operation object device 200 (process (1) in FIG. 31). The operation object device 200 that receives the remote control command first requests for prior permission from its external communication section 208 to the external communication section 408 of the service providing device 400 (process (2) in FIG. 31). The service providing device 400 that receives the request for the prior permission specifies its permitter device 3002, and transmits a request for the prior permission from the external communication section 408 of the service providing device 400 to the telephone/web communication section 303 of the specified permitter device 3002 (process (3) in FIG. 31).

After the permitter enters into the permitter device 3002 whether or not to provide prior permission in response to the request, the permitter device 3002 transmits a response to the external communication section 408 of the service providing device 400 from the telephone/web communication section 303 of the permitter device 3002 (process (4) in FIG. 31). The service providing device 400, after receiving the response, transfers the response from the external communication section 408 to the external communication section 208 of the operation object device 200 (process (5) in FIG. 31). As a result, as long as the permitter enters that the prior permission is provided, the operator is able to view the view-restricted content within the permitted range.

According to the configuration, when the operator carries out an operation for obtaining prior permission by using the operator device 3001, a request for prior permission is transmitted to the service providing device 400 from the operation object device 200. After the permitter enters into the permitter device 3002 that prior permission is provided, the permitter device 3002 transmits to the service providing device 400 a response informing that the prior permission is provided. Thereafter, the response that the prior permission is provided is transmitted from the service providing device 400 to the operation object device 200. Thus, the operator is able to view the view-restricted content within a range of the prior permission. If the permitter enters that no prior permission is provided, a response informing that no prior permission is provided is transmitted to the operation object device 200 from the permitter device 3002, via the service providing device 400. As a result, the operator cannot obtain the prior permission.

According to the configuration, in obtaining the case-by-case permission and prior permission from the permitter, the operator just needs to operate the operation object device 200 via the operator device 3001 used by the operator. Moreover, in response to the permission request, the permitter only requires entering into the permitter device 3002 used by the permitter whether or not permission is provided; there is no need for the permitter to directly operate the operation object device 200.

Furthermore, according to the configuration, communication between the service providing device 400 and permitter device 3002 is assumed to be carried out via the communication network 500 serving as the Internet and the mobile telephone network. Therefore, the requests for obtaining case-by-case permission and prior permission and responses thereto are exchanged via the Internet and the mobile telephone network. Therefore, even in a case where the operator and permitter are located far away from each other (for example, the operator is at home and the permitter is at an outside location), the operator can still obtain the case-by-case permission and prior permission from the permitter.

Moreover, according to the configuration, the service providing device 400 exchanges the requests for the case-by-case permission and prior permission and responses thereto with the permitter device 3002. Thus, the operator can still obtain the case-by-case permission and prior permission, even if the operator device 3001 includes no telephone/web communication section 303 (i.e., cannot communicate with the communication network 500 that serves as the mobile telephone network).

Specific Configuration of Each Apparatus

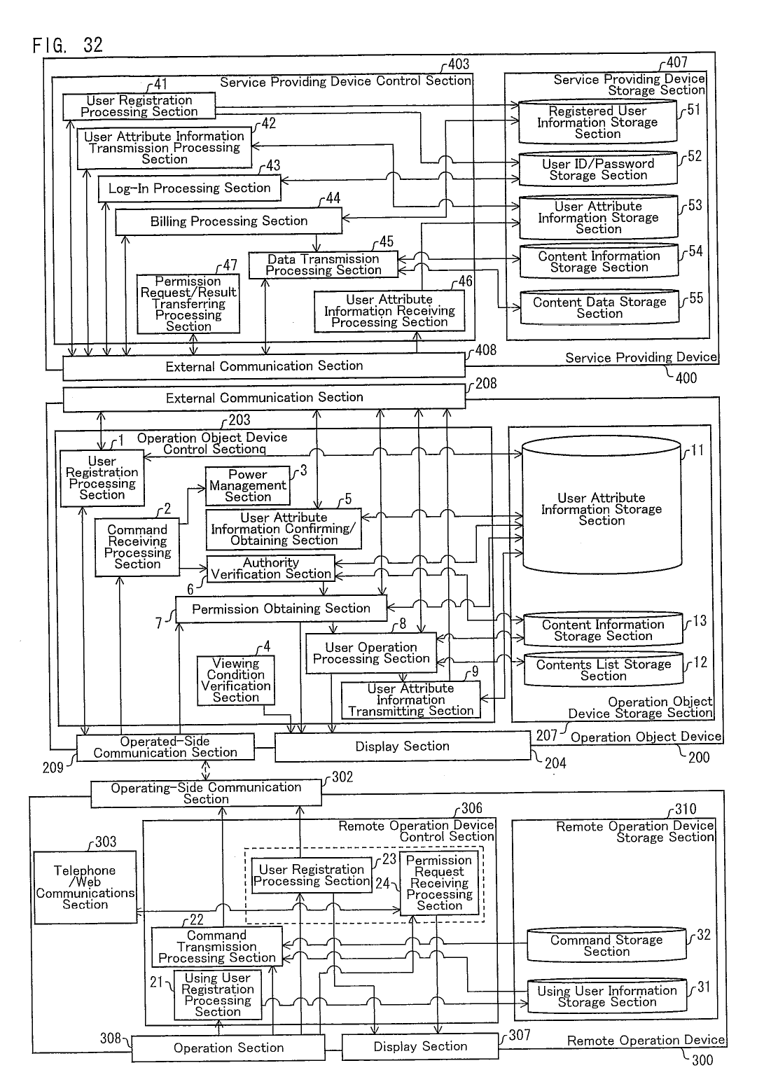

With reference to FIG. 32, the following description more specifically explains the configuration of the operation object device 200, remote operation device 300, and service providing device 400, each in accordance with the present embodiment. FIG. 32 is a block diagram illustrating essential configurations of the operation object device 200, remote operation device 300, and service providing device 400, each in accordance with the present embodiment.

(Specific Configuration of Operation Object Device)

First, the following description more specifically explains the configuration of the operation object device 200 of the present embodiment. As illustrated in FIG. 32, the operation object device 200 of the present embodiment includes members identical to the operation object device 200 of First Embodiment. However, the permission obtaining section 7 of the present embodiment carries out a process different from the permission obtaining section 7 of First Embodiment, as described below.

If the authority verification section 6 determines that there is the need to obtain a case-by-case permission or prior permission from the permitter, the permission obtaining section 7 of the present embodiment transmits a “permission request” to the service providing device 400 via the external communication section 208. The permission request may have, as with First Embodiment, a data configuration as shown in Table 10, for example.

After transmitting the permission request to the service providing device 400, the permission obtaining section 7 of the present embodiment receives, as a response to the permission request, a “permission result response” transmitted from the service providing device 400, via the external communication section 208. The permission result response may have, similarly to First Embodiment, a data configuration as shown in Table 11, for example.

Processes carried out by the permission obtaining section 7 of the present embodiment after receiving the permission result response is identical to the processes of the permission obtaining section 7 described in First Embodiment, so therefore their explanations are omitted in the present embodiment.

The procedure of the processes carried out by the permission obtaining section 7 of the present embodiment (hereinafter referred to as permission obtaining process) are described later, with reference to a flow chart.

(Specific Configuration of Remote Operation Device)

The following description deals more specifically with the configuration of the remote operation device 300 of the present embodiment. As illustrated in FIG. 32, the remote operation device 300 of the present embodiment includes members substantially identical to the remote operation device 300 of First Embodiment. However, the permission request receiving processing section 24 of the present embodiment carries out processes different from the permission request receiving processing section 24 of First Embodiment, as described below.

The following description explains the permission request receiving processing section 24 of the present embodiment. The permission request receiving processing section 24 of the permitter device 3002 receives a permission request transmitted from the service providing device 400, via the telephone/web communication section 303 of the permitter device 3002. Moreover, the permission request receiving processing section 24 of the permitter device 3002 returns a permission result response to the service providing device 400, via the telephone/web communication section 303 of the permitter device 3002. The processes immediately after receiving the permission request until immediately before transmitting the permission result response are identical to those of the permission request receiving processing section 24 of First Embodiment, and therefore explanation thereof is omitted in the present embodiment.

(Specific Configuration of Service Providing Device)

The following description more specifically explains the configuration of the service providing device 400 of the present embodiment. As illustrated in FIG. 32, the service providing device 400 of the present embodiment includes members substantially identical to the service providing device 400 of First Embodiment. However, the service providing device control section 403 of the present embodiment further includes a permission request/result transfer processing section 47 (transfer processing means), as described below.

The permission request/result transfer processing section 47 transmits a permission request to the permitter device 3002, which permission request is received from the operation object device 200 via the external communication section 408. More specifically, when a permission request is received, a permitter device 3002 used by the permitter is specified. In order to do so, the permission request/result transfer processing section 47 obtains a “permitter device telephone number” in the “permitter user information” included in the received permission request. Thereafter, the permission request/result transfer processing section 47 transmits the received permission request to the permitter device 3002 having the obtained permitter device telephone number, via the external communication section 408.

After the permission request is transmitted to the permitter device 3002, the permission request/result transfer processing section 47 receives a permission result response transmitted from the permitter device 3002 as a response to the permission request, via the external communication section 408. Thereafter, the permission request/result transfer processing section 47 transmits the received permission result response to the operation object device 200, via the external communication section 408.

If the permission request/result transfer processing section 47 receives no permission result response from the permitter device 3002 in a predetermined time (for example, minutes), the permission request/result transfer processing section 47 generates a non-permission response, and transmits the generated non-permission response to the operation object device 200, via the external communication section 408.

The non-permission response can be generated as follows: (A) if the operation detail in the permission request is “operation for viewing content”, and a detail for requesting permission is set in the first permission request detail, a permission result response in which no value is set in the first permission detail is generated; (B) if the operation detail of the permission request is “operation for viewing content”, and a detail for requesting permission is set in the second permission request detail, a permission result response in which no value is set for the second permission detail is generated; and (C) if the operation detail of the permission request is “operation for obtaining prior permission”, a permission result response in which no value is set for any of the first permission detail, second permission detail, and third permission detail, is generated.

Procedure in Remote Operation System 100

The procedure in the remote operation system 100 of the present embodiment is substantially identical to the procedure in the remote operation system 100 of First Embodiment, however the procedure of the permission obtaining process is different, as described below. Any other procedure is identical to the procedure described in First Embodiment, and therefore the explanation thereof is omitted in the present embodiment.

(Procedure in Permission Obtaining Process)

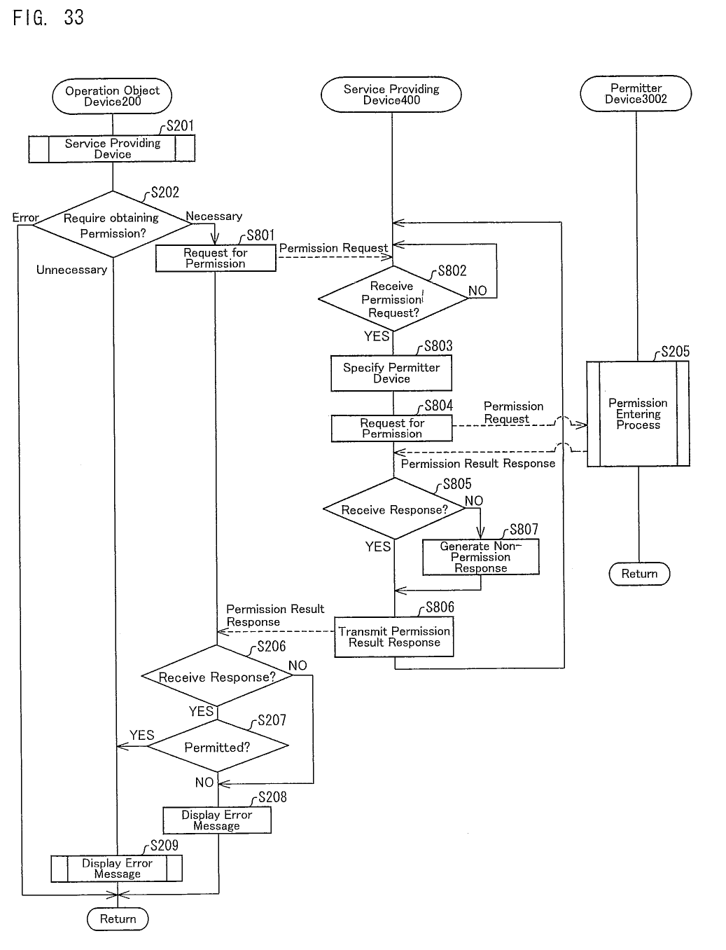

With reference to FIG. 33, the following description explains an outline of a procedure in the permission obtaining process of the present embodiment. FIG. 33 is a flow chart illustrating the procedure in the permission obtaining process of the present embodiment. Any procedures identical to the permission obtaining process described in First Embodiment are omitted in description.

In a case where an operation attempted by the operator requires obtaining of viewing permission (“necessary” in step S202), the permission obtaining section 7 of the present embodiment transmits a permission request to the service providing device 400 (step S801).

In the service providing device 400, after the permission request is received (YES in step S802), the permission request/result transfer processing section 47 specifies a permitter device 3002 (step S803), and transmits the received permission request to the permitter device 3002 (step S804).

Then, the permitter device 3002, in response to the permission request, transmits a permission result response as a result of a permission input process, to the operator device 3001 (step S205).

After the permission request/result transfer processing section 47 of the service providing device 400 receives the permission result response from the permitter device 3002 (YES in step S805), the permission request/result transfer processing section 47 then transmits the received permission result response to the operation object device 200 (step S806).

If the permission request/result transfer processing section 47 of the service providing device 400 receives no permission result response from the permitter device 3002 in a predetermined time (for example, 3 minutes) (NO in step S805), the permission request/result transfer processing section 47 generates a non-permission response (step S807), and transmits the generated non-permission response to the operation object device 200 (step S806).

Thereafter, the operation object device 200 receives a permission result response from the service providing device 400 (YES in step S206).

As described above, in the present embodiment, when an operator provided with no prior permission from a permitter attempts to view view-restricted content via the operator device 3001, the operation object device 200 first transmits a permission request for case-by-case permission, to the service providing device 400. The service providing device 400 that receives the permission request then transmits the permission request to the permitter device 3002. After the permitter device 3002 receives the permission request, the permitter enters into the permitter device 3002 whether or not to provide the case-by-case permission. If the permitter enters into the permitter device 3002 that the case-by-case permission is provided, the permitter device 3002 transmits to the service providing device 400 a response informing that the viewing permission is provided. The service providing device 400 that receives the response then transfers the response to the operation object device 200. Thereafter, the operation object device 200, upon receiving the response, reproduces the view-restricted content that the operator attempts to view.

Similarly, in the present embodiment, when the operator carries out an operation for obtaining prior permission by using the operator device 3001, the operation object device 200 first transmits a permission request for prior permission, to the service providing device 400. The service providing device 400 that receives the permission request then transmits the permission request to the permitter device 3002. After the permitter device 3002 receives the permission request, the permitter enters into the permitter device 3002 whether or not to provide the prior permission. If the permitter enters into the permitter device 3002 that the prior permission is provided, the permitter device 3002 transmits a response to the service providing device 400 informing that the prior permission is provided. The service providing device 400 that receives the response then transfers the response to the operation object device 200. Once the operation object device 200 receives the response, the operator can view the view-restricted content within the permitted range.

As described above, in the present embodiment, an operator becomes possible to view view-restricted content by obtaining a case-by-case permission from a permitter. At this time, the operator just needs to operate the operation object device 200 via the operator device 3001 used by the operator. Moreover, when a permission request is received, the permitter just requires entering whether or not to provide the permission, into the permitter device 3002 used by the permitter; there is no need to have the permitter directly operate the operation object device 200.

Moreover, communication between the service providing device 400 and the permitter device 3002 is assumed to be carried out via a communication network 500 serving as the Internet and the mobile telephone network. Accordingly, requests for case-by-case permission and prior permission and responses thereto, are exchanged via the Internet and the mobile telephone network. Thus, even if the operator and the permitter are positioned far away from each other (for example, the operator is at home and the permitter is at an outside location), the operator can still obtain the case-by-case permission and prior permission from the permitter.

Furthermore, since the service providing device 400 and the permitter device 3002 exchange the requests for the case-by-case permission and prior permission and the responses thereto, even if the operator device 3001 has no telephone/web communication section 303 (i.e., cannot communicate with the communication network 500 serving as the mobile telephone network), the operator can still obtain the case-by-case permission and prior permission from the permitter.

Modification

A well known mechanism for preventing a user such as an underage person from freely viewing view-restricted content is a mechanism using an integrated chip called a V-Chip. In this mechanism, when a television receiver receives a predetermined signal transmitted together with airwaves, which predetermined signal regards ranking of a program, the V-Chip which is incorporated in the television receiver controls display of the video in accordance with the predetermined signal (for example, does not display the video). The present invention is also applicable in such a viewing restriction that uses the V-Chip.

More specifically, if the operator is provided with the case-by-case permission from the permitter, the mechanism may be made so that no video display control by the V-Chip is carried out even if the operation object device 200 that serves as the television receiver receives the predetermined signal. Similarly, if the operator has received prior permission from the permitter, the mechanism may be made so that no video display control by the V-Chip is carried out even if the operation object device 200 that serves as the television receiver receives the predetermined signal.

(Additional Matters)

Finally, the blocks of the remote operation device 300, operation object device 200, and service providing device 400, particularly the remote operation device control section 306, operation object device control section 203, and service providing device control section 403, may be realized by way of hardware or software as executed by a CPU as follows:

The remote operation device 300, operation object device 200, and service providing device 400 each include a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the remote operation device 300, operation object device 200, and service providing device 400, a computer-readable storage medium containing program code (executable program, intermediate code program, or source program) for the remote operation device 300, operation object device 200, and service providing device 400, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a Floppy® disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The remote operation device 300, operation object device 200, and service providing device 400 may be arranged to be connectable to a communication network so that the program code may be delivered over the communication network. The communication network is not limited in any particular manner, and may be, for example, the Internet, an intranet, extranet, LAN, ISDN, VAN, CATV communication network, virtual dedicated network (virtual private network), telephone line network, mobile communication network, or satellite communication network. The transfer medium which makes up the communication network is not limited in any particular manner, and may be, for example, wired line, such as IEEE 1394, USB, electric power line, cable TV line, telephone line, or ADSL line; or wireless, such as infrared radiation (IrDA, remote control), Bluetooth (Registered Trademark), IEEE 802.11 wireless, HDR, mobile telephone network, satellite line, or terrestrial digital network. The present invention encompasses a carrier wave or data signal transmission in which the program code is embodied electronically.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

As described above, an operation object device in accordance with the present invention is an operation object device operating in accordance with a signal transmitted from an operation device, the operation object device being restricted in operation depending on an operator of the operation device, the operation object device including: permission request transmitting means for transmitting to a permission input device a request for permission to allow the operator to carry out the operation thus restricted, the permission input device being used by a permitter that provides the permission; and permission signal receiving means for receiving, as a response to the request, a permission signal transmitted from the permission input device, the operation object device operating in accordance with the operation thus restricted, in a case where the permission signal received by the permission signal receiving means indicates that permission is provided for carrying out the operation thus restricted.

Moreover, a method in accordance with the present invention for controlling an operation object device which operates in accordance with a signal transmitted from an operation device, the operation object device being restricted in operation depending on an operator of the operation device, is a method including the steps of: (a) transmitting to a permission input device a request for permission to allow the operator to carry out an operation thus restricted, the permission input device being used by a permitter that provides the permission; (b) receiving, as a response to the request, a permission signal transmitted from the permission input device; and (c) carrying out operation in accordance with the operation thus restricted, in a case where the permission signal received in step (b) indicates that permission is provided for carrying out the operation thus restricted.

Thus, the operator that uses the operation device, in carrying out the operation thus restricted to the operation object device, can obtain a permission signal from the permission input device by exchanging the requests for permission and responses thereto between the operation object device and the permission input device.

Hence, the operator can carry out the operation thus restricted by obtaining permission from the permitter.

Furthermore, the operator can obtain the permission from the permitter just by operating the operation object device via the operation device used by the operator. This improves convenience for the operator.

No direct exchange is carried out between the operation device and the permission input device. Thus, even if the operation device is not capable of directly communicating with the permission input device, the operator can still obtain permission from the permitter.

Furthermore, in the configuration, the operation object device in accordance with the present invention may be configured in such a manner that the operation thus restricted is to instruct the operation object device to reproduce view-restricted content on the operation object device.

According to the configuration, the operation thus restricted is an operation to instruct to the operation object device to reproduce the view-restricted content, which operation is carried out by the operator.

This allows the operator to request for permission to the permitter, for instructing reproduction of the view-restricted content on the operation object device.

Hence, even if the operator is restricted in instructing the reproduction of view-restricted content on the operation object device, the operator can instruct to reproduce the view-restricted content on the operation object device by obtaining permission from the permitter.

Furthermore, in the configuration, the operation object device in accordance with the present invention may be configured in such a manner that the request transmitted by the permission request transmitting means includes information requesting for permission to reproduce the view-restricted content on the operation object device.

According to the configuration, the request that includes information requesting for permission to reproduce the view-restricted content on the operation object device is transmissible to the permission input device thus used by the permitter.

Thus, it is possible to request the permitter for permission to reproduce the view-restricted content on the operation object device.

As a result, even if the operator is restricted in giving instructions to reproduce the view-restricted content on the operation object device, the operator can instruct reproduction of the view-restricted content on the operation object device by obtaining permission from the permitter to reproduce the view-restricted content on the operation object device.

Furthermore, in the configuration, the operation object device in accordance with the present invention may be configured in such a manner that in a case where the view-restricted content is charged for, the permission signal includes permission for purchasing the content.

According to the configuration, the operation object device receives the permission signal transmitted from the permission input device as a response to the request, which permission signal includes permission for purchasing content.

Thus, the operator, in instructing reproduction of view-restricted content on the operation object device in the case where the view-restricted content is charged for, can obtain from the permitter (i) permission for reproducing the view-restricted content on the operation object device and also (ii) permission for purchasing the content.

Therefore, in a case where the view-restricted content is charged for, the operator can instruct reproduction of the content on the operation object device without having to carry out a purchasing operation of the content.

Furthermore, in the configuration, the operation object device in accordance with the present invention may be configured in such a manner that the request transmitted by the permission request transmitting means includes information requesting to set a reproducing time limit of the view-restricted content on the operation object device.

According to the configuration, the operation object device transmits, to the permission input device used by the permitter, the request including the information requesting to set a reproducing time limit of the view-restricted content on the operation object device.

This allows the operator to request the permitter to set a reproducing time limit of the view-restricted content on the operation object device.

As a result, even if the operator is restricted in instructing to reproduce the view-restricted content on the operation object device, if the permitter sets a reproducing time limit as a result of the operator requesting the permitter to set the reproducing time limit, the operator can instruct to reproduce the view-restricted content on the operation object device within the reproducing time limit. That is to say, as long as the reproduction is carried out within the reproducing time limit, the operator can instruct reproduction of the view-restricted content on the operation object device without asking for permission to the permitter.

Furthermore, in the configuration, the operation object device in accordance with the present invention may be configured in such a manner that the request transmitted by the permission request transmitting means includes information requesting to set a maximum reproduction time length of the view-restricted content on the operation object device.

According to the configuration, the operation object device transmits, to the permission input device used by the permitter, the request which includes information requesting to set a maximum reproduction time length of the view-restricted content on the operation object device.

This allows the operator to request the permitter to set a maximum reproduction time length of the view-restricted content on the operation object device.

As a result, even if the operator is restricted in instructing to reproduce the view-restricted content on the operation object device, if the permitter sets the maximum reproduction time length as a result of the operator asking the permitter to set the maximum reproduction time length, the operator can instruct to reproduce the view-restricted content on the operation object device within the maximum reproduction time length. That is to say, as long as the total amount of time the content is reproduced is within the maximum reproduction time length, the operator can instruct reproduction of the view-restricted content on the operation object device without asking for permission to the permitter.

Furthermore, in the configuration, the operation object device in accordance with the present invention may be configured in such a manner that in a case where the view-restricted content is charged for, the request transmitted by the permission request transmitting means includes information requesting to set a monetary purchasing limit of the content.

According to the configuration, in a case where the view-restricted content is charged for, the operation object device transmits, to the permission input device used by the permitter, the request which includes information requesting to set a monetary purchasing limit of the content.

This allows the operator to request the permitter to set a monetary purchasing limit of the content.

As a result, even if the view-restricted content is charged for, as long as the permitter sets a monetary purchasing limit as a result of the operator asking the permitter to set the monetary purchasing limit, the operator can purchase the view-restricted content within the monetary purchasing limit. That is to say, the operator can purchase the view-restricted content without having to ask the permitter for permission, as long as the purchase is within the monetary purchasing limit.

Furthermore, in the configuration, the operation object device in accordance with the present invention further includes: a storage section for storing (i) a communication address of the permission input device and (ii) identification information of the operator, the communication address and identification information being stored in the storage section so as to correspond to each other, when the operator carries out the operation thus restricted, the permission request transmitting means transmitting, to the permission input device of the communication address that is stored in the storage section so as to correspond to the identification information of the operator, a request for the permission to allow the operator to carry out the operation thus restricted.

According to the configuration, when the operator carries out the operation thus restricted, the operation object device transmits a request for the permission to the permission input device having a communication address corresponding to the operator, by referring to information stored in the storage section so that a communication address of the permission input device corresponds to identification information of the operator.

This allows the operator to transmit a request for the permission to a permitter using the permission input device made corresponding to the operation object device in advance.

Therefore, as long as the communication address of the permission input device is stored in the storage section so as to appropriately correspond to the identification information of the operator also stored in the storage section, the operator (for example, an underage person) can request for the permission to an appropriate permitter (for example, guardian of the underage person) that corresponds to the operator.

Furthermore, in the configuration, the operation object device in accordance with the present invention further includes: user attribute information storage means for obtaining information from an external apparatus so as to store the obtained information in the storage section, the information being identification information of the operator corresponding to a communication address of a respective permission input device.

According to the configuration, information is obtainable from an external apparatus, which information is identification information of the operator corresponding to a communication address of the permission input device, so as to be stored in the storage section.

This allows the operation object device to transmit the request for permission to the permission input device, by referring to the information which is the identification information of the operator corresponding to the communication address of the permission input device.

Therefore, any operation object device that is operated by the operator via the operation device can transmit request for permission, by referring to a communication address of the permission input device obtained from an external apparatus. This allows requesting for permission to an appropriate permitter, even in a case where an operation object device (for example, a television receiver at an outside location) different from the operation object device (for example, a television receiver at home) usually operated by the operator is operated by the operation device, by referring to information obtained from the external apparatus, which information is identification information of the operator corresponding to the communication address of the permission input device.

A permission input device in accordance with the present invention includes: permission request receiving means for receiving the request being transmitted from the operation object device; permission entering means for accepting an input of permission from the permitter in response to the request; and permission signal transmitting means for transmitting to the operation object device the permission signal in accordance with the input.

According to the configuration, the permission input device receives the request transmitted from the operation object device. Further, the permission input device accepts input by the permitter of permission in response to the request. Thereafter, the permission input device transmits to the operation object device the permission signal in accordance with the input.

This allows the permission input device to transmit a permitting result of the permitter to the operation object device in response to the request transmitted from the operation object device.

Hence, it is possible to cause the operator to carry out the operation thus restricted on the operation object device in accordance with the permission result from the permitter.

Furthermore, the permitter can enter the permission just by operating the permission input device used by the permitter (i.e., there is no need to directly operate the operation object device or operation device). This allows improvement in convenience for the permitter.

Furthermore, no direct exchange is carried out between the permission input device and the operation device, so even if the permission input device and the operation device cannot directly communicate with each other, the permitter can still provide permission to the operator.

A remote operation system in accordance with the present invention includes: the operation object device; the permission input device; and an operation device for transmitting an operation signal to the operation object device.

According to the configuration, the remote operation system includes the operation object device, the permission input device, and an operation device for transmitting an operation signal to the operation object device. Thus, the operation object device transmits to the permission input device a request for permission to allow an operator of the operation device to carry out an operation thus restricted on the operation object device, then the permission input device transmits, as a permission signal, a result of accepting input of permission from the permitter in response to the request to the operation object device, and further the operation object device, in the case where the permission signal shows that the operation is permitted, carries out the operation with respect to the operation thus restricted.

This allows the operator to obtain permission from the permitter that uses the permission input device, in a case where the operator carries out a restricted operation on the operation object device via the operation device.

Therefore, the operator can carry out the operation thus restricted, by obtaining permission from the permitter.

An operation object device in accordance with the present invention is an operation object device operating in accordance with a signal transmitted from an operation device, the operation object device being restricted in operation depending on an operator of the operation device, the operation object device including: permission request transmitting means for transmitting, to a permission input device via the operation device, a request for permission to allow the operator to carry out the operation thus restricted, the permission input device being used by a permitter that provides the permission; and permission signal receiving means for receiving, via the operation device, a permission signal transmitted from the permission input device as a response to the request, the operation object device operating in accordance with the operation thus restricted, in a case where the permission signal received by the permission signal receiving means indicates that permission is provided for carrying out the operation thus restricted.

Moreover, a method in accordance with the present invention for controlling an operation object device which operates in accordance with a signal transmitted from an operation device, the operation object device being restricted in operation depending on an operator of the operation device, is a method including the steps of: (a) transmitting, to a permission input device via the operation device, a request for permission to allow the operator to carry out an operation thus restricted, the permission input device being used by a permitter that provides the permission; (b) receiving, via the operation device, a permission signal transmitted from the permission input device as a response to the request; and (c) carrying out operation in accordance with the operation thus restricted, in a case where the permission signal received in step (b) indicates that permission is provided for carrying out the operation thus restricted.

Thus, the operator that uses the operation device, in carrying out the operation thus restricted to the operation object device, can obtain a permission signal from the permission input device by exchanging the requests for permission and responses thereto between the operation object device and the permission input device, via the operation device.

Hence, the operator can carry out the operation thus restricted by obtaining permission from the permitter.

Furthermore, the operator can obtain the permission from the permitter just by operating the operation object device via the operation device used by the operator. This improves convenience for the operator.

No direct exchange is carried out between the operation object device and the permission input device, but communication is carried out between the operation device and the permission input device. Thus, even if the operation object device is not capable of directly communicating with the permission input device (for example, a case where the operator attempts to operate the operation object device at home while the permitter is at an outside location), the operator can still obtain permission from the permitter.

Furthermore, in the configuration, the operation object device in accordance with the present invention may be configured in such a manner that the operation thus restricted is to instruct the operation object device to reproduce view-restricted content on the operation object device.

According to the configuration, the operation thus restricted is an operation to instruct to the operation object device to reproduce the view-restricted content, which operation is carried out by the operator.

This allows the operator to request for permission to the permitter, for instructing reproduction of the view-restricted content on the operation object device.

Hence, even if the operator is restricted in instructing the reproduction of view-restricted content on the operation object device, the operator can instruct to reproduce the view-restricted content on the operation object device by obtaining permission from the permitter.

In the configuration, the operation object device in accordance with the present invention may be configured in such a manner that the request transmitted by the permission request transmitting means includes information requesting for permission to reproduce the view-restricted content on the operation object device.

According to the configuration, the request that includes information requesting for permission to reproduce the view-restricted content on the operation object device is transmissible to the permission input device thus used by the permitter.

Thus, it is possible to request the permitter for permission to reproduce the view-restricted content on the operation object device.

As a result, even if the operator is restricted in giving instructions to reproduce the view-restricted content on the operation object device, the operator can instruct reproduction of the view-restricted content on the operation object device by obtaining permission from the permitter to reproduce the view-restricted content on the operation object device.

Furthermore, in the configuration, the operation object device in accordance with the present invention may be configured in such a manner that in a case where the view-restricted content is charged for, the permission signal includes permission for purchasing the content.

According to the configuration, the operation object device receives the permission signal transmitted from the permission input device as a response to the request, which permission signal includes permission for purchasing content.

Thus, the operator, in instructing reproduction of view-restricted content on the operation object device in the case where the view-restricted content is charged for, can obtain from the permitter (i) permission for reproducing the view-restricted content on the operation object device and also (ii) permission for purchasing the content.

Therefore, in a case where the view-restricted content is charged for, the operator can instruct reproduction of the content on the operation object device without having to carry out a purchasing operation of the content.

Furthermore, in the configuration, the operation object device in accordance with the present invention may be configured in such a manner that the request transmitted by the permission request transmitting means includes information requesting to set a reproducing time limit of the view-restricted content on the operation object device.

According to the configuration, the operation object device transmits, to the permission input device used by the permitter, the request including the information requesting to set a reproducing time limit of the view-restricted content on the operation object device.

This allows the operator to request the permitter to set a reproducing time limit of the view-restricted content on the operation object device.

As a result, even if the operator is restricted in instructing to reproduce the view-restricted content on the operation object device, if the permitter sets a reproducing time limit as a result of the operator requesting the permitter to set the reproducing time limit, the operator can instruct to reproduce the view-restricted content on the operation object device within the reproducing time limit. That is to say, as long as the reproduction is carried out within the reproducing time limit, the operator can instruct reproduction of the view-restricted content on the operation object device without asking for permission to the permitter.

Furthermore, in the configuration, the operation object device in accordance with the present invention may be configured in such a manner that the request transmitted by the permission request transmitting means includes requesting to set a maximum reproduction time length of the view-restricted content on the operation object device.

According to the configuration, the operation object device transmits, to the permission input device used by the permitter, the request which includes information requesting to set a maximum reproduction time length of the view-restricted content on the operation object device.

This allows the operator to request the permitter to set a maximum reproduction time length of the view-restricted content on the operation object device.

As a result, even if the operator is restricted in instructing to reproduce the view-restricted content on the operation object device, if the permitter sets the maximum reproduction time length as a result of the operator asking the permitter to set the maximum reproduction time length, the operator can instruct to reproduce the view-restricted content on the operation object device within the maximum reproduction time length. That is to say, as long as the total amount of time the content is reproduced is within the maximum reproduction time length, the operator can instruct reproduction of the view-restricted content on the operation object device without asking for permission to the permitter.

Furthermore, in the configuration, the operation object device in accordance with the present invention may be configured in such a manner that in a case where the view-restricted content is charged for, the request transmitted by the permission request transmitting means includes information requesting to set a monetary purchasing limit of the content.

According to the configuration, in a case where the view-restricted content is charged for, the operation object device transmits, to the permission input device used by the permitter, the request which includes information requesting to set a monetary purchasing limit of the content.

This allows the operator to request the permitter to set a monetary purchasing limit of the content.

As a result, even if the view-restricted content is charged for, as long as the permitter sets a monetary purchasing limit as a result of the operator asking the permitter to set the monetary purchasing limit, the operator can purchase the view-restricted content within the monetary purchasing limit. That is to say, the operator can purchase the view-restricted content without having to ask the permitter for permission, as long as the purchase is within the monetary purchasing limit.

Furthermore, in the configuration, the operation object device in accordance with the present invention further includes: a storage section for storing (i) a communication address of the permission input device and (ii) identification information of the operator, the communication address and identification information being stored in the storage section so as to correspond to each other, when the operator carries out the operation thus restricted, the permission request transmitting means transmitting, to the permission input device of the communication address that is stored in the storage section so as to correspond to the identification information of the operator, a request for permission to allow the operator to carry out the operation thus restricted.

According to the configuration, when the operator carries out the operation thus restricted, the operation object device transmits a request for the permission to the permission input device having a communication address corresponding to the operator, by referring to information stored in the storage section so that a communication address of the permission input device corresponds to identification information of the operator.

This allows the operator to transmit a request for the permission to a permitter using the permission input device made corresponding to the operation object device in advance.

Therefore, as long as the communication address of the permission input device is stored in the storage section so as to appropriately correspond to the identification information of the operator also stored in the storage section, the operator (for example, an underage person) can request for the permission to an appropriate permitter (for example, guardian of the underage person) that corresponds to the operator.

Furthermore, in the configuration, the operation object device in accordance with the present invention further includes: user attribute information storage means for obtaining information from an external apparatus so as to store the obtained information in the storage section, the information being identification information of the operator corresponding to a communication address of a respective permission input device.

According to the configuration, information is obtainable from an external apparatus, which information is identification information of the operator corresponding to a communication address of the permission input device, so as to be stored in the storage section.

This allows the operation object device to transmit the request for permission to the permission input device, by referring to the information which is the identification information of the operator corresponding to the communication address of the permission input device.

Therefore, any operation object device that is operated by the operator via the operation device can transmit a request for permission, by referring to a communication address of the permission input device obtained from an external apparatus. This allows requesting for permission to an appropriate permitter, even in a case where an operation object device (for example, a television receiver at an outside location) different from the operation object device (for example, a television receiver at home) usually operated by the operator is operated by the operation device, by referring to information obtained from the external apparatus, which information is identification information of the operator corresponding to the communication address of the permission input device.

A permission input device in accordance with the present invention includes: permission request receiving means for receiving the request being transmitted from the operation object device, via the operation device; permission entering means for accepting an input of permission from the permitter in response to the request; and permission signal transmitting means for transmitting, to the operation object device via the operation device, the permission signal in accordance with the input.

According to the configuration, the permission input device receives the request that is transmitted from the operation object device, via the operation device. Further, the permission input device accepts input by the permitter of permission in response to the request. Thereafter, the permission input device transmits to the operation object device the permission signal in accordance with the input, via the operation device.

This allows the permission input device to transmit a permitting result of the permitter to the operation object device in response to the request transmitted from the operation object device.

Hence, it is possible to cause the operator to carry out the operation thus restricted on the operation object device in accordance with the permission result from the permitter.

Furthermore, the permitter can enter the permission just by operating the permission input device used by the permitter (i.e., there is no need to directly operate the operation object device or operation device). This allows improvement in convenience for the permitter.

No direct exchange is carried out between the operation object device and the permission input device, but communication is carried out between the operation device and the permission input device. Thus, even if the operation object device is not capable of directly communicating with the permission input device (for example, a case where the operator attempts to operate the operation object device at home while the permitter is at an outside location), the operator can still obtain permission from the permitter.

An operation device in accordance with the present invention is an operation device for transmitting a signal to the operating target apparatus, the operation device including: transfer processing means for (i) transmitting the request transmitted from the operation object device to the permission input device, and (ii) transmitting the permission signal transmitted from the permission input device to the operation object device.

According to the configuration, the operation device transmits the request transmitted from the operation object device to the permission input device. Moreover, the operation device transmits the permission signal transmitted from the permission input device to the operation object device.

Therefore, the operation device relays the exchange between the operation object device and the permission input device.

As a result, even if the operation object device is not capable of directly communicating with the permission input device (for example, a case where the operator attempts to operate the operation object device at home while the permitter is at an outside location), the operator can still obtain permission from the permitter.

Furthermore, a remote operation system in accordance with the present invention includes: the operation object device; the permission input device; and an operation device for transmitting an operation signal to the operation object device.

According to the configuration, the remote operation system includes the operation object device, the permission input device, and the operation device that relays the operation object device and the permission input device. Thus, (i) a request for permission to allow an operator of the operation device to carry out a restricted operation on the operation object device is transmitted to the permission input device from the operation object device via the operation device; (ii) the permission input device transmits a result accepted from the permitter of an input of the permission in response to the request, as a permission signal, to the operation object device via the operation device; and (iii) if the permission signal indicates that the operation is permitted, the operation object device carries out operation in accordance with the operation thus restricted.

This allows the operator to obtain permission from the permitter that uses the permission input device, in a case where the operator carries out a restricted operation on the operation object device via the operation device.

Therefore, the operator can carry out the operation thus restricted, by obtaining permission from the permitter.

Moreover, an operation object device in accordance with the present invention is an operation object device that presents data in accordance with a signal transmitted from an operation device, the data being obtained from an operation object data providing device, the operation object device being restricted in operation depending on an operator of the operation device, the operation object device including: permission request transmitting means for transmitting, to a permission input device via the operation object data providing device, a request for permission to allow the operator to carry out an operation thus restricted, the permission input device being used by a permitter that provides the permission; and permission signal receiving means for receiving, via the operation object data providing device, a permission signal transmitted from the permission input device as a response to the request, the operation object device operating in accordance with the operation thus restricted in a case where the permission signal received by the permission signal receiving means indicates that permission is provided for carrying out the operation thus restricted.

Moreover, a method in accordance with the present invention for controlling the operation object device which presents data in accordance with a signal transmitted from an operation device, the data being obtained from an operation object data providing device, the operation object device being restricted in operation depending on an operator of the operation device, is a method including the steps of: (a) transmitting, to a permission input device via the operation object data providing device, a request for permission to allow the operator to carry out the operation thus restricted, the permission input device being used by a permitter that provides the permission; (b) receiving, via the operation object data providing device, a permission signal transmitted from the permission input device as a response to the request; and (c) carrying out operation in accordance with the operation thus restricted, in a case where the permission signal received in step (b) indicates that permission is provided for carrying out the operation thus restricted.

Thus, the operator that uses the operation device, in carrying out the operation thus restricted to the operation object device, can obtain a permission signal from the permission input device by exchanging the requests for permission and responses thereto between the operation object device and the permission input device, via the operation object data providing device.

Hence, the operator can carry out the operation thus restricted by obtaining permission from the permitter.

Furthermore, the operator can obtain the permission from the permitter just by operating the operation object device via the operation device used by the operator. This improves convenience for the operator.

No direct exchange is carried out between the operation device and the permission input device. Thus, even if the operation device is not capable of directly communicating with the permission input device, the operator can still obtain permission from the permitter.

Further, no direct exchange is made between the operation object device and the permission input device, but communication is carried out between the operation object data providing device and the permission input device. Thus, even if the operation object device is not capable of directly communicating with the permission input device (for example, in a case where the operator attempts to operate the operation object device at home while the permitter is at an outside location), the operator can still obtain permission from the permitter.

Furthermore, in the configuration, the operation object device in accordance with the present invention may be configured in such a manner that the operation thus restricted is to instruct the operation object device to reproduce view-restricted content on the operation object device.

According to the configuration, the operation thus restricted is an operation to instruct to the operation object device to reproduce the view-restricted content, which operation is carried out by the operator.

This allows the operator to request for permission to the permitter, for instructing reproduction of the view-restricted content on the operation object device.

Hence, even if the operator is restricted in instructing the reproduction of view-restricted content on the operation object device, the operator can instruct to reproduce the view-restricted content on the operation object device by obtaining permission from the permitter.

Furthermore, in the configuration, the operation object device in accordance with the present invention may be configured in such a manner that the request transmitted by the permission request transmitting means includes information requesting for permission to reproduce the view-restricted content on the operation object device.

According to the configuration, the request that includes information requesting for permission to reproduce the view-restricted content on the operation object device is transmissible to the permission input device thus used by the permitter.

Thus, it is possible to request the permitter for permission to reproduce the view-restricted content on the operation object device.

As a result, even if the operator is restricted in giving instructions to reproduce the view-restricted content on the operation object device, the operator can instruct reproduction of the view-restricted content on the operation object device by obtaining permission from the permitter to reproduce the view-restricted content on the operation object device.

Furthermore, in the configuration, the operation object device of the present invention may be configured in such a manner that in a case where the view-restricted content is charged for, the permission signal includes permission for purchasing the content

According to the configuration, the operation object device receives the permission signal transmitted from the permission input device as a response to the request, which permission signal includes permission for purchasing content.

Thus, the operator, in instructing reproduction of view-restricted content on the operation object device in the case where the view-restricted content is charged for, can obtain from the permitter (i) permission for reproducing the view-restricted content on the operation object device and also (ii) permission for purchasing the content.

Therefore, in a case where the view-restricted content is charged for, the operator can instruct reproduction of the content on the operation object device without having to carry out a purchasing operation of the content.

Furthermore, in the configuration, the operation object device in accordance with the present invention may be configured in such a manner that the request transmitted by the permission request transmitting means includes information requesting to set a reproducing time limit of the view-restricted content on the operation object device.

According to the configuration, the operation object device transmits, to the permission input device used by the permitter, the request including the information requesting to set a reproducing time limit of the view-restricted content on the operation object device.

This allows the operator to request the permitter to set a reproducing time limit of the view-restricted content on the operation object device.

As a result, even if the operator is restricted in instructing to reproduce the view-restricted content on the operation object device, if the permitter sets a reproducing time limit as a result of the operator requesting the permitter to set the reproducing time limit, the operator can instruct to reproduce the view-restricted content on the operation object device within the reproducing time limit. That is to say, as long as the reproduction is carried out within the reproducing time limit, the operator can instruct reproduction of the view-restricted content on the operation object device without asking for permission to the permitter.

Furthermore, in the configuration, the operation object device in accordance with the present invention may be configured in such a manner that the request transmitted by the permission request transmitting means includes information requesting to set a maximum reproduction time length of the view-restricted content on the operation object device.

According to the configuration, the operation object device transmits, to the permission input device used by the permitter, the request which includes information requesting to set a maximum reproduction time length of the view-restricted content on the operation object device.

This allows the operator to request the permitter to set a maximum reproduction time length of the view-restricted content on the operation object device.

As a result, even if the operator is restricted in instructing to reproduce the view-restricted content on the operation object device, if the permitter sets the maximum reproduction time length as a result of the operator asking the permitter to set the maximum reproduction time length, the operator can instruct to reproduce the view-restricted content on the operation object device within the maximum reproduction time length. That is to say, as long as the total amount of time the content is reproduced is within the maximum reproduction time length, the operator can instruct reproduction of the view-restricted content on the operation object device without asking for permission to the permitter.

Furthermore, in the configuration, the operation object device in accordance with the present invention may be configured in such a manner that in a case where the view-restricted content is charged for, the request transmitted by the permission request transmitting means includes information requesting to set a monetary purchasing limit of the content.

According to the configuration, in a case where the view-restricted content is charged for, the operation object device transmits, to the permission input device used by the permitter, the request which includes information requesting to set a monetary purchasing limit of the content.

This allows the operator to request the permitter to set a monetary purchasing limit of the content.

As a result, even if the view-restricted content is charged for, as long as the permitter sets a monetary purchasing limit as a result of the operator asking the permitter to set the monetary purchasing limit, the operator can purchase the view-restricted content within the monetary purchasing limit. That is to say, the operator can purchase the view-restricted content without having to ask the permitter for permission, as long as the purchase is within the monetary purchasing limit.

Furthermore, in the configuration, the operation object device in accordance with the present invention further includes: a storage section for storing (i) a communication address of the permission input device and (ii) identification information of the operator, the communication address and identification information being stored in the storage section so as to correspond to each other, when the operator carries out the operation thus restricted, the permission request transmitting means transmitting, to the permission input device of the communication address that is stored in the storage section so as to correspond to the identification information of the operator, a request for the permission to allow the operator to carry out the operation thus restricted.

According to the configuration, when the operator carries out the operation thus restricted, the operation object device transmits a request for the permission to the permission input device having a communication address corresponding to the operator, by referring to information stored in the storage section so that a communication address of the permission input device corresponds to identification information of the operator.

This allows the operator to transmit a request for the permission to the permitter using the permission input device made corresponding to the operation object device in advance.

Therefore, as long as the communication address of the permission input device is stored in the storage section so as to appropriately correspond to the identification information of the operator also stored in the storage section, the operator (for example, an underage person) can request for the permission to an appropriate permitter (for example, guardian of the underage person) that corresponds to the operator.

Furthermore, in the configuration, the operation object device in accordance with the present invention further includes: user attribute information storage means for obtaining information from an external apparatus so as to store the obtained information in the storage section, the information being identification information of the operator corresponding to a communication address of a respective permission input device.

According to the configuration, information is obtainable from an external apparatus, which information is identification information of the operator corresponding to a communication address of the permission input device, so as to be stored in the storage section.

This allows the operation object device to transmit the request for permission to the permission input device, by referring to the information which is the identification information of the operator corresponding to the communication address of the permission input device.

Therefore, any operation object device that is operated by the operator via the operation device can transmit a request for permission, by referring to a communication address of the permission input device obtained from an external apparatus. This allows requesting for permission to an appropriate permitter, even in a case where an operation object device (for example, a television receiver at an outside location) different from the operation object device (for example, a television receiver at home) usually operated by the operator is operated by the operation device, by referring to information obtained from the external apparatus, which information is identification information of the operator corresponding to the communication address of the permission input device.

A permission input device in accordance with the present invention includes: permission request receiving means for receiving, via the operation object data providing device, the request being transmitted from the operation object device; permission entering means for accepting an input of permission from the permitter in response to the request; and permission signal transmitting means for transmitting, to the operation object device via the operation object data providing device, the permission signal in accordance with the input.

According to the configuration, the permission input device receives the request that is transmitted from the operation object device, via the operation object data providing device. Further, the permission input device accepts input by the permitter of permission in response to the request. Thereafter, the permission input device transmits to the operation object device the permission signal in accordance with the input, via the operation object data providing device.

This allows the permission input device to transmit a permitting result of the permitter to the operation object device in response to the request transmitted from the operation object device.

Hence, it is possible to cause the operator to carry out the operation thus restricted on the operation object device in accordance with the permission result from the permitter.

Furthermore, the permitter can enter the permission just by operating the permission input device used by the permitter (i.e., there is no need to directly operate the operation object device or operation device). This allows improvement in convenience for the permitter.

Furthermore, no direct exchange is carried out between the permission input device and the operation device, so even if the permission input device and the operation device cannot directly communicate with each other, the permitter can still provide permission to the operator.

Further, no direct exchange is made between the operation object device and the permission input device, but communication is carried out between the operation object data providing device and the permission input device. Thus, even if the operation object device is not capable of directly communicating with the permission input device (for example, in a case where the operator attempts to operate the operation object device at home while the permitter is at an outside location), the operator can still obtain permission from the permitter.

Furthermore, an operation object data providing device in accordance with the present invention is an operation object data providing device for transmitting data to be operated, to the operation object device, the operation object data providing device including: transfer processing means for (i) transmitting the request transmitted from the operation object device to the permission input device, and (ii) transmitting the permission signal transmitted from the permission input device to the operation object device.

According to the configuration, the operation object data providing device transmits the request transmitted from the operation object device to the permission input device.

Moreover, the operation object data providing device transmits the permission signal transmitted from the permission input device to the operation object device.

Therefore, the operation object data providing device relays the exchange between the operation object device and the permission input device.

As a result, even if the operation object device is not capable of directly communicating with the permission input device (for example, a case where the operator attempts to operate the operation object device at home while the permitter is at an outside location), the operator can still obtain permission from the permitter.

A remote operation system in accordance with the present invention includes: the operation object device; the permission input device; the operation object data providing device; and an operation device for transmitting an operation signal to the operation object device.

According to the configuration, the remote operation system includes the operation object device, the permission input device, the operation object data providing device, and an operation device for transmitting an operation signal to the operation object device. Thus, (i) a request for permission to allow an operator of the operation device to carry out a restricted operation on the operation object device is transmitted to the permission input device from the operation object device via the operation object data providing device; (ii) the permission input device transmits a result accepted from the permitter of an input of the permission in response to the request, as a permission signal, to the operation object device via the operation object data providing device; and (iii) if the permission signal indicates that the operation is permitted, the operation object device carries out operation in accordance with the operation thus restricted.

This allows the operator to obtain permission from the permitter that uses the permission input device, in a case where the operator carries out a restricted operation on the operation object device via the operation device.

Therefore, the operator can carry out the operation thus restricted, by obtaining permission from the permitter.

The operation object device, permission input device, operation device, and operation object data providing device may be realized by a computer. In this case, a control program that causes the computer to function as each of means of the operation object device, permission input device, operation device, and operation object data providing device so as to realize the operation object device, permission input device, operation device, and operation object data providing device on a computer, and a computer-readable storage medium in which the control program is stored, are also within the scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to apparatuses that can restrict operations of a user. Particularly, the present invention is suitable for: an operation object device such as a television receiver, recording/reproducing apparatus, and personal computer; a remote operation device that enables a user to remotely operate the operation object device; and a service providing device that can transmit content to the operation object device based on instructions of a user that uses the remote operation device. Each of the apparatuses has a mechanism in which an unauthorized user cannot view view-restricted content.

### REFERENCE SIGNS LIST

5 user attribute information confirming/obtaining section (user attribute information storage means)
6 authority verification section
7 permission obtaining section (permission request transmitting means, permission signal receiving means)
8 user operation processing section
9 user attribute information transmitting section
11 user attribute information storage section (storage section)
24 permission request receiving processing section (permission request receiving means, permission entering means, permission signal transmitting means)
25 permission request/result transfer processing section (transfer processing means)
42 user attribute information transmission processing section
46 user attribute information receiving processing section
47 permission request/result transfer processing section (transfer processing means)
53 user attribute information storage means
100 remote operation system
200 operation object device
209 operated-side communication section
300 remote operation device (operation device, permission input device)
3001 operator device (operation device)
3002 permitter device (permission input device)
302 operating-side communication section
303 telephone/web communication section
400 service providing device
500 communication network

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. An operation object device that presents data in accordance with a signal transmitted from an operation device, the data being obtained from an operation object data providing device, the operation object device being restricted in operation depending on an operator of the operation device,
said operation object device comprising:
permission request transmitting means for transmitting, to a permission input device via the operation object data providing device, a request for permission to allow the operator to carry out an operation thus restricted, the permission input device being used by a permitter that provides the permission; and
permission signal receiving means for receiving, via the operation object data providing device, a permission signal transmitted from the permission input device as a response to the request,
the operation object device operating in accordance with the operation thus restricted in a case where the permission signal received by the permission signal receiving means indicates that permission is provided for carrying out the operation thus restricted.

31. The operation object device according to claim 30, wherein:
the operation thus restricted is to instruct the operation object device to reproduce view-restricted content on the operation object device

32. The operation object device according to claim 31, wherein:
the request transmitted by the permission request transmitting means includes information requesting for permission to reproduce the view-restricted content on the operation object device.

33. The operation object device according to claim 32, wherein:
in a case where the view-restricted content is charged for, the permission signal includes permission for purchasing the content.

34. The operation object device according to claim 31, wherein:
the request transmitted by the permission request transmitting means includes information requesting to set a reproducing time limit of the view-restricted content on the operation object device.

35. The operation object device according to claim 31, wherein:
the request transmitted by the permission request transmitting means includes information requesting to set a maximum reproduction time length of the view-restricted content on the operation object device.

36. The operation object device according to claim 31, wherein:
in a case where the view-restricted content is charged for, the request transmitted by the permission request transmitting means includes information requesting to set a monetary purchasing limit of the content.

37. The operation object device according to claim 30, further comprising:
a storage section for storing (i) a communication address of the permission input device and (ii) identification information of the operator, the communication address and identification information being stored in the storage section so as to correspond to each other,
when the operator carries out the operation thus restricted, the permission request transmitting means transmitting, to the permission input device of the communication address that is stored in the storage section so as to correspond to the identification information of the operator, a request for the permission to allow the operator to carry out the operation thus restricted.

38. The operation object device according to claim 37, further comprising:
user attribute information storage means for obtaining information from an external apparatus so as to store the obtained information in the storage section, the information being identification information of the operator corresponding to a communication address of a respective permission input device.

39. A permission input device comprising:
permission request receiving means for receiving, via the operation object data providing device, the request being transmitted from an operation object device recited in claim 30;
permission entering means for accepting an input of permission from the permitter in response to the request; and
permission signal transmitting means for transmitting, to the operation object device via the operation object data providing device, the permission signal in accordance with the input.

40. An operation object data providing device for transmitting data to be operated, to an operation object device recited in claim 30,
said operation object data providing device comprising:
transfer processing means for (i) transmitting the request transmitted from the operation object device to a permission input device, and (ii) transmitting the permission signal transmitted from the permission input device to the operation object device.

41. A remote operation system comprising:
an operation object device recited in claim 30;
a permission input device;
an operation object data providing device; and
an operation device for transmitting an operation signal to the operation object device.

42. A method for controlling an operation object device which presents data in accordance with a signal transmitted from an operation device, the data being obtained from an operation object data providing device, the operation object device being restricted in operation depending on an operator of the operation device,
said method comprising the steps of:
(a) transmitting, to a permission input device via the operation object data providing device, a request for permission to allow the operator to carry out an operation thus restricted, the permission input device being used by a permitter that provides the permission;
(b) receiving, via the operation object data providing device, a permission signal transmitted from the permission input device as a response to the request; and
(c) carrying out operation in accordance with the operation thus restricted, in a case where the permission signal received in step (b) indicates that permission is provided for carrying out the operation thus restricted.

43. A control program for causing a computer to function as each of means of an operation object device recited in claim 30, each of means of a permission input device, or each of means of an operation object data providing device.

44. A computer-readable storage medium in which a control program recited in claim 43 is stored.
